(19) United States
(12) Patent Application Publication
(10) Pub. No.: US 2026/0267458 A1
(43) Pub. Date: Sep. 10, 2026

(54) ATTENTION-DRIVEN TASK SUGGESTION WITH ADAPTIVE PRESENTATION

(71) Applicant: NVIDIA Corporation, Santa Clara, CA (US)

(72) Inventors: Julien Francois Jomier, Chapel Hill, NC (US); Mahdi Azizian, San Jose, CA (US); Nigel Scott Nelson, San Francisco, CA (US)

(21) Appl. No.: 19/559,839

(22) Filed: Mar. 6, 2026

Related U.S. Application Data
(60) Provisional application No. 63/768,603, filed on Mar. 7, 2025.

(51) Int. Cl. G06F 3/04815; G06F 3/01; G06F 3/0484; G06F 9/451; G06F 40/30; G06F 40/40; G06T 7/70; G06T 19/00; G06V 20/20

(52) U.S. Cl. CPC G06F 3/04815; G06F 3/013; G06F 3/0484; G06F 9/453; G06F 40/30; G06F 40/40; G06T 7/70; G06T 19/006; G06V 20/20; G06T 2210/21

(57) ABSTRACT

Disclosed are apparatuses, systems, and techniques that implement attention-driven task suggestion with adaptive presentation using vision-language models. The system may receive image data representing a visual scene and an attention signal indicating a location within the visual scene, process the image data and the attention signal using a vision-language model to identify an object corresponding to the location, and generate task identifiers representing tasks associated with the object. The system may cause presentation of the task identifiers, and responsive to a selection of a task identifier, transmit a command to a device control interface associated with the object to execute a task.

### RELATED APPLICATIONS

This non-provisional application claims priority to U.S. Patent Application No. 63/768,603, filed Mar. 7, 2025, entitled “TASK SUGGESTION SYSTEM USING VISION LANGUAGE MODEL,” which is incorporated herein by reference in its entirety for all purposes.

### TECHNICAL FIELD

At least one embodiment pertains to facilitating efficient human-computer interaction for users with motor impairments through attention-driven task generation and adaptive presentation using vision-language models. For example, at least one embodiment pertains to automatic generation of contextually-appropriate task identifiers based on visual scene understanding and attention signals for assistive technology applications.

### BACKGROUND

Assistive technology systems enable users with motor impairments to interact with computing devices and smart environments through alternative input modalities such as eye tracking, brain-computer interfaces, and head orientation tracking. Smart home ecosystems integrate controllable devices including lighting, climate control, entertainment systems, and appliances through device control interfaces and application programming interfaces. Vision-language models process visual and textual information using multimodal neural network architectures to generate semantic descriptions of visual scenes. Contextual ranking systems prioritize options based on temporal data, environmental sensor data, user history data, and other contextual factors.

### BRIEF DESCRIPTION OF DRAWINGS

The present systems and methods for attention-driven task suggestion with adaptive presentation are described in detail below with reference to the attached drawing figures, wherein:

FIG. 1 is a block diagram of an example system for attention-driven task generation using vision-language models and attention signals for assistive technology applications, according to at least one embodiment;

FIG. 2 illustrates an example process for encoding attention signals into image data through visual marker overlay for vision-language model processing, according to at least one embodiment;

FIG. 3 illustrates an example process for ranking task identifiers based on contextual information including temporal data, environmental sensor data, current device state, and user history patterns, according to at least one embodiment;

FIG. 4 illustrates an example process for event-driven task presentation with urgency-based routing that balances immediate notification for high-urgency events with deferred presentation for low-urgency events, according to at least one embodiment;

FIG. 5 illustrates an example process for input-adaptive presentation that adjusts task identifier count and interaction methods based on user input modality capabilities including binary input, scalar input, and eye tracking mechanisms, according to at least one embodiment;

FIG. 6A illustrates an example architecture for depth-matched augmented reality rendering showing spatial position determination and visual element generation, according to at least one embodiment;

FIG. 6B illustrates an example architecture for depth-matched augmented reality rendering showing visual element positioning and stereoscopic rendering at object focal distances, according to at least one embodiment;

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for a computing pipeline, according to at least one embodiment;

FIG. 10 is a system diagram for an example system for training, adapting, instantiating, and deploying machine learning models in a computing pipeline, according to at least one embodiment;

FIG. 11A is a block diagram of an example generative language model system suitable for use in implementing at least some embodiments of the present disclosure;

FIG. 11B is a block diagram of an example generative language model that includes a transformer encoder-decoder suitable for use in implementing at least some embodiments of the present disclosure;

FIG. 11C is a block diagram of an example generative language model that includes a decoder-only transformer architecture suitable for use in implementing at least some embodiments of the present disclosure;

FIG. 12 is a block diagram of an example computing device suitable for use in implementing some embodiments of the present disclosure;

FIG. 13 is a block diagram of an example data center suitable for use in implementing some embodiments of the present disclosure; and

FIGS. 14A-14M show a flow diagram of an example method for attention-driven task generation and adaptive presentation using vision-language models, according to at least one embodiment.

### DETAILED DESCRIPTION

Assistive technology systems for users with severe motor impairments face fundamental challenges in enabling efficient interaction with computing devices and smart environments. Users with tetraplegia, amyotrophic lateral sclerosis, or similar conditions retain cognitive function but have severely limited physical capabilities, typically restricted to eye movement, minimal head movement, or residual muscle control sufficient for brain-computer interface signal generation. These users require computer interfaces that minimize interaction complexity while maximizing functional capability across diverse tasks and environments.

Conventional assistive interfaces implement predetermined control schemes with fixed user interface elements such as hierarchical menus, button arrays, and navigation trees. A user controlling a ceiling fan through a conventional smart home interface may need to navigate from a home screen to a device management application, locate the fan within a device list, access fan-specific controls, and select a desired setting through multiple sequential interactions. For users with brain-computer interfaces providing only scalar control (magnitude adjustment in a single dimension) or binary control (yes/no selections), each navigation step imposes significant cognitive load and time cost. A four-step navigation sequence requiring 3-5 seconds per step consumes 12-20 seconds for a single device control action. This interaction model reflects a fixed, hierarchical interface architecture that does not dynamically optimize command selection or navigation paths based on detected input dimensionality constraints. As a result, the system executes redundant state transitions and rendering operations that increase interaction latency and processing overhead in low-bandwidth assistive control environments.

Conventional systems lack contextual awareness of user intent, environmental conditions, device states, and temporal patterns. When a user directs attention toward a thermostat, conventional interfaces present identical control options regardless of whether outdoor temperature is 35° F. or 95° F., whether the user historically prefers 68° F. or 74° F., or whether current time is 6:00 AM or 11:00 PM. The absence of context-aware state reduction mechanisms results in presentation of full control sets regardless of environmental parameters, increasing interaction cycles under low-bandwidth input constraints. A thermostat interface presenting ten temperature settings, three mode options, and four fan speed selections requires the user to consider seventeen choices when contextual factors would typically indicate one or two relevant actions.

Task specification in conventional systems requires explicit user commands through predetermined interaction sequences. Users cannot indicate desired outcomes by directing attention toward objects; instead, they may need to translate intentions into navigation paths through interface hierarchies. A user wanting to create optimal conditions for watching television may need to separately navigate to lighting controls, window covering controls, and television controls, executing three independent interaction sequences when the desired outcome (dimmed lights, closed curtains, television powered on) represents a composite task that could be executed through coordinated device state transitions.

Conventional interfaces fail to adapt presentation and interaction methods to user input capabilities. A system designed for two-dimensional cursor control presents identical interfaces to users with binary input mechanisms, scalar input mechanisms, or gaze-based input mechanisms, forcing users with limited input capabilities to employ interaction methods designed for higher-dimensional control. A user with binary input capability (single yes/no signal generation) confronting a twelve-option menu may need to employ inefficient sequential scanning or hierarchical navigation rather than optimized binary search partitioning that would reduce interaction count from twelve sequential evaluations to four binary decisions. Conventional interface rendering engines do not dynamically reconfigure interaction models based on detected input dimensionality constraints.

Environmental events requiring user attention occur asynchronously with user focus. A smoke detector activation, doorbell ring, or pet distress vocalization may occur while a user focuses attention on email composition, meal preparation, or video content consumption. Conventional systems either interrupt current activities with immediate notifications (disrupting focus and potentially causing errors in ongoing tasks) or queue notifications for later review (potentially delaying time-critical responses). Conventional systems lack an event arbitration mechanism capable of dynamically prioritizing asynchronous signals based on inferred urgency and current interaction state.

Conventional systems cannot leverage visual understanding to identify controllable objects in unstructured environments. Object detection systems can identify that a visible object is a ceiling fan, but cannot determine that the ceiling fan is controllable through a smart home interface, what control actions are available (power toggle, speed adjustment, oscillation control, timer setting), or what current state the fan occupies (powered on at medium speed). Conventional systems do not integrate perception outputs with device-control metadata to generate actionable control graphs in real time. Users may need to maintain mental models of which visible objects have associated control interfaces and how to access those interfaces through navigation hierarchies.

The scalability limitations of conventional approaches may become significant as smart home ecosystems expand. A home environment with fifty controllable devices (lights, fans, thermostats, locks, cameras, appliances, entertainment systems) creates interface hierarchies with hundreds of navigation paths. Users may need to memorize device locations within interface structures and execute increasingly complex navigation sequences as device counts increase. The exponential growth of interface state combinations results in navigation graph expansion that is not dynamically pruned based on context or user capability constraints.

Conventional systems lack adaptive ranking or task-prioritization models that update control graph ordering based on historical interaction data and environmental context. A user who consistently sets a bedroom fan to high speed when outdoor temperature exceeds 80° F. receives identical task presentations regardless of how many times this pattern repeats. The system cannot identify that “set fan to high speed” may need to be prioritized over “turn fan off” or “set fan to low speed” when temperature and historical data indicate strong user preference. Each interaction requires the same cognitive evaluation and selection effort as the first interaction, with no efficiency gains from repeated similar choices.

Aspects of the present disclosure provide attention-driven task suggestion systems that address the above and other deficiencies through vision-language model processing of visual scenes combined with attention signal encoding. The system can receive image data representing a visual scene and an attention signal indicating a location within the visual scene, generate one or more task identifiers representing tasks associated with an object at the location using a vision-language model, and cause presentation of the one or more task identifiers for user selection. Each task identifier can include a representation of a task, such as a textual description, icon, or label that describes an actionable operation. When a user selects a task identifier, the system may execute the corresponding task by transmitting commands to device control interfaces. The system reduces predetermined navigation hierarchies by generating task identifiers derived from visual scene analysis and contextual signal processing.

In some embodiments, the system may modify image data to include a visual marker at a location indicated by an attention signal before providing the modified image as input to a vision-language model. The visual marker can include a colored dot, crosshairs, highlighting, or bounding box overlay that encodes attention information directly into image data. The vision-language model can process the modified image to identify which object the user is attending to and generate task identifiers for tasks specific to that object. The visual marker encoding approach enables attention signal integration and, in some embodiments, may be used with a vision-language model that has been fine-tuned to recognize marker-to-object associations, without requiring architectural modification of the underlying multimodal encoder-decoder structure.

In some embodiments, the system may derive attention signals from eye tracking data including gaze coordinates corresponding to locations within visual scenes. Eye tracking systems integrated into head-mounted displays, standalone cameras, or assistive device interfaces can generate gaze coordinate streams at 60-120 Hz update rates. The system can convert gaze coordinates from eye tracking coordinate systems to image coordinate systems, enabling precise identification of attended objects within captured visual scenes.

In some embodiments, the system may obtain contextual information including temporal data, environmental sensor data, or user history data, and rank one or more tasks based on the contextual information. Temporal data can include current time of day, day of week, or season. Environmental sensor data can include temperature measurements, humidity measurements, light level measurements, or audio level measurements. User history data can include records of previous task selections, task selection frequencies, task selection timing patterns, or task completion outcomes. The system can assign priority scores to task identifiers based on weighted combinations of contextual factors, ordering task identifiers according to computed priority scores derived from contextual weighting factors.

In some embodiments, contextual information may include a current time of day, a current state of an object obtained from a device control interface, user preference data derived from historical interactions with the object, or environmental condition data obtained from one or more sensors. The system can rank task identifiers by weighting each task identifier based on each component of contextual information. A weighting scheme can assign 40% weight to contextual relevance (how well current environmental conditions match conditions where a task is typically appropriate), 35% weight to user history (how frequently the user has selected the task under similar conditions), 15% weight to urgency (how time-sensitive or safety-critical the task is), and 10% weight to interaction efficiency (how many steps the task requires for completion).

In some embodiments, the system may detect an event condition from environmental sensor data indicating a state change, determine an urgency score of the event condition based on contextual information, cause presentation of one or more task identifiers representing event-related tasks associated with the event condition without an attention signal when the urgency score exceeds a predetermined threshold, and defer presentation of the one or more task identifiers until receiving an attention signal directed to a relevant object when the urgency score is below the predetermined threshold. Event conditions can include smoke detector activations (high urgency), doorbell activations (medium urgency), or pet vocalizations (low to medium urgency). Urgency determination can consider time of day (doorbell at 3:00 AM has higher urgency than doorbell at 3:00 PM), user activity state (interruption during sleep has higher cost than interruption during television viewing), and event persistence (continuous alarm has higher urgency than single brief alert).

In some embodiments, the system may determine a current focus region corresponding to a location indicated by an attention signal and position a visual notification for one or more task identifiers representing event-related tasks outside the current focus region to avoid disrupting ongoing user activity. The current focus region can include a circular or rectangular area centered on the attention signal location with radius or dimensions determined by typical object sizes and visual attention spans. Visual notifications positioned outside the current focus region appear in peripheral vision, allowing users to maintain focus on current tasks while remaining aware of events requiring potential attention.

In some embodiments, the system may process image data using a vision-language model to identify an object at a location, provide an object identifier and contextual information to a language model, and receive one or more task identifiers from the language model based on the object identifier and the contextual information. The two-stage architecture separates visual scene understanding (vision-language model responsibility) from task generation and application programming interface mapping (language model responsibility). The vision-language model can generate semantic descriptions such as “ceiling fan, currently powered on, speed setting appears to be medium based on blade rotation rate” without requiring knowledge of smart home control protocols. The language model can receive the semantic description, query device control interfaces to obtain precise state information and available control actions, and generate task identifiers with executable task specifications including specific application programming interface endpoints and parameters.

In some embodiments, the system may receive a selection of a task identifier from one or more task identifiers, cause execution of the task corresponding to the task identifier by transmitting a command to a device control interface associated with an object, and cause presentation of confirmation information indicating successful execution of the task. Device control interfaces can include smart home platforms or direct device application programming interfaces. Commands can specify device identifiers, action types, and parameters in formats required by specific device control interfaces. Confirmation information can include visual indicators (checkmarks, color changes, animation sequences), auditory indicators (success tones, voice confirmations), or haptic indicators (vibration patterns) depending on user preferences and available output modalities.

In some embodiments, the system may store interaction data including selection and contextual information for each presentation of one or more task identifiers, identify a pattern in the interaction data indicating user preference for a particular task type under specific contextual conditions, and increase a priority of task identifiers representing tasks matching the particular task type when the specific contextual conditions are present in subsequent task identifier generation. Interaction data records can include timestamps, identified objects, presented task identifier lists, selected task identifiers, contextual information at time of interaction, and task execution outcomes. Pattern identification can employ frequency analysis (counting how often specific task identifiers are selected under specific conditions), temporal analysis (identifying time-of-day or day-of-week patterns), or sequential analysis (identifying task identifier sequences that frequently occur together). Priority increases can be proportional to pattern confidence levels, with strongly-established patterns (high frequency, high consistency) receiving larger priority boosts than weakly-established patterns.

In some embodiments, the system may identify a plurality of devices in a visual scene using a vision-language model, determine a functional relationship between an object and at least one device of the plurality of devices based on additional capabilities using semantic understanding, and generate at least one task identifier representing a task including coordinated control of the object and the at least one device based on the functional relationship. Functional relationships can be determined based on structured representations of additional capabilities. Additional capabilities may include complementary capabilities (e.g., television viewing is enhanced by dimmed lighting), prerequisite capabilities (e.g., operating a projector requires closed window coverings to reduce ambient light), environmental interaction capabilities (e.g., luminance output affecting display contrast), or state-transition dependencies between devices (e.g., turning on ventilation before activating cooking appliances). In some embodiments, additional capabilities may be determined by retrieving device capability descriptors from device control interfaces and constructing capability vectors for each device, the capability vectors encoding supported operations, state variables, environmental effect attributes, and dependency indicators. The system may compare capability vectors across devices and construct a device capability graph representing relationships inferred from overlapping or interacting capability attributes, thereby enabling structured determination of functional relationships without reliance on static rule mappings. In some embodiments, the language model may be provided with structured prompts that include identified device types, their capabilities, and current states, and may be requested to identify relationships between the devices. For example, the language model may be prompted with templates such as “Given devices [device list] with capabilities [capability list], identify which devices have complementary, prerequisite, or sequential relationships for the task of [user intent].” In some embodiments, relationship identification may use chain-of-thought reasoning where the model explains its reasoning about device interactions before outputting the identified relationships. In some embodiments, the system may maintain a relationship ontology or knowledge graph that the language model references when determining functional relationships, where the ontology encodes known device interaction patterns and the language model queries or augments the ontology based on the current visual scene and user context.

In some embodiments, the system may receive a selection of a task identifier representing a task including coordinated control, generate a sequence of control commands for an object and at least one device, determine an execution order of the sequence of control commands based on dependencies between states of a plurality of devices, and transmit the sequence of control commands according to the execution order. Dependencies can include prerequisite dependencies (device A may need to reach state X before device B can transition to state Y), timing dependencies (device A may need to complete state transition before device B begins state transition to avoid conflicts), or optimization dependencies (executing commands in a specific order minimizes total completion time or energy consumption). Execution order determination can employ dependency graph analysis, constraint satisfaction solving, or heuristic ordering rules.

In some embodiments, the system may determine an input capability of a user input modality, select a subset of one or more task identifiers based on the input capability, and cause presentation of the subset of the one or more task identifiers via an interface adapted to the user input modality. Input capability determination can assess control dimensionality (binary, scalar, two-dimensional, three-dimensional), control bandwidth (bits per second of information transfer), control latency (delay between user intent and system detection), and control reliability (error rate or signal-to-noise ratio). Subset selection can limit task identifier count, simplify task identifier descriptions, or group related task identifiers based on input capability constraints. Interface adaptation can modify visual presentation (larger targets for lower-precision input, simplified layouts for lower-bandwidth input), interaction timing (longer dwell times for higher-latency input), or interaction methods (binary partitioning for binary input, magnitude adjustment for scalar input).

In some embodiments, rather than actively detecting the physical control dimensionality of a currently connected hardware input device, the system may adapt presentation and interaction methods based on a stored user interaction profile. A user interaction profile can include a software-defined configuration file or operating system toggle (e.g., an ‘Accessibility Mode’ setting) that imposes predefined graphical interaction constraints independently of the physical capabilities of the connected hardware. For example, an able-bodied user employing a fully capable two-dimensional input device (such as a standard computer mouse or touchscreen) may selectively activate a user interaction profile that artificially constrains the system to a binary ocular dwell-time execution mode. In such instances, the user interaction profile may specify a maximum threshold of concurrently selectable visual elements (e.g., limiting the interface to a maximum of two options at any given time). The presentation module 118 can retrieve this stored user interaction profile and filter a superset of candidate tasks generated by the vision-language model into a structurally limited task hierarchy configured to satisfy the predefined graphical interaction constraint. This allows the system to seamlessly implement recursive binary search tree traversals or gaze-based interaction paradigms as a software-enforced abstraction layer, regardless of underlying hardware capabilities.

In some embodiments, the system may determine a control dimensionality of a user input modality and limit a number of task identifiers in a subset of one or more task identifiers based on the control dimensionality. The number of task identifiers decreases as the control dimensionality decreases. Control dimensionality quantifies how many independent parameters a user can control simultaneously. Binary input provides zero-dimensional control (single yes/no decision), monotonic scalar input provides 0.5-dimensional control (magnitude adjustment in one direction only), one-dimensional input provides bidirectional control along a single axis, and two-dimensional input provides control in a plane. Task identifier count limits can follow an inverse relationship with control dimensionality: binary input may be limited to 4-8 task identifiers enabling 2-3 levels of binary partitioning, scalar input may be limited to 3-5 task identifiers enabling sequential selection, one-dimensional input may be limited to 5-10 task identifiers enabling list navigation, and two-dimensional input may support 10-20 task identifiers enabling grid layouts.

In some embodiments, when a user input modality includes a binary input mechanism, the system may partition a subset of one or more task identifiers into a first group and a second group, cause presentation of an indication of the first group and the second group, receive a binary selection indicating either the first group or the second group, and cause presentation of individual task identifiers within a selected group indicated by the binary selection for final task identifier selection. Binary partitioning implements a binary search tree traversal where each binary decision eliminates half of remaining options. For N task identifiers, binary partitioning requires ceiling(log₂(N)) binary decisions to reach a specific task identifier. Partitioning strategies can employ balanced partitioning (equal-sized groups at each level) or weighted partitioning (higher-priority task identifiers placed in groups requiring fewer decisions).

In some embodiments, when a user input modality includes eye tracking, the system may cause presentation of visual indicators for each task identifiers in a subset, track dwell time of gazes on each visual indicator, and select a task identifier from the subset when the dwell time of a gaze on a visual indicator for the task identifiers exceeds a dwell threshold. Visual indicators can include buttons, icons, text labels, or graphical elements with distinct visual boundaries. Dwell time tracking measures continuous gaze duration within a visual indicator's boundary region, resetting when gaze moves outside the boundary. Dwell thresholds can range from 0.5 seconds (fast interaction, higher accidental selection risk) to 3.0 seconds (slow interaction, lower accidental selection risk), with typical values of 1.0-2.0 seconds balancing speed and accuracy. The system can provide visual feedback during dwell time accumulation through progress indicators (filling circles, expanding rings, color transitions) that show users how much additional dwell time is required for selection.

In some embodiments, the system may determine a three-dimensional spatial position of an object, generate one or more visual elements representing a subset of one or more task identifiers with each visual element positioned relative to the three-dimensional spatial position of the object, and cause rendering of the one or more visual elements in an augmented reality display at a depth matching the object. Three-dimensional spatial position determination can employ depth sensors (time-of-flight cameras, structured light sensors, stereo cameras), simultaneous localization and mapping algorithms, or object detection with depth estimation. Visual element positioning can place task indicators adjacent to objects (offset by 10-30 centimeters in horizontal or vertical directions), overlaid on objects (semi-transparent overlays), or connected to objects (lines or arrows linking indicators to objects). Depth-matched rendering ensures that visual elements appear at the same focal distance as physical objects, reducing vergence-accommodation conflict and creating seamless integration between physical and virtual content.

In some embodiments, the system may track interaction state information including user attention focus and task presentation timing, cause an interface to fade presentation of a subset of one or more tasks when a duration of user inactivity exceeds a predetermined timeout threshold, and restore presentation of the subset without regenerating the one or more tasks in response to receiving a subsequent attention signal or input signal before complete removal of the one or more tasks. Timeout thresholds can range from 3 seconds (aggressive cleanup, frequent regeneration) to 30 seconds (persistent display, infrequent regeneration), with typical values of 5-15 seconds balancing interface clutter reduction with regeneration overhead. Fading can employ gradual opacity reduction over 1-3 seconds, providing visual continuity and allowing users to notice and prevent removal if desired. Restoration without regeneration avoids computational cost and latency of re-running vision-language model inference and language model task generation, enabling immediate task list reappearance when users return attention to previously-attended objects.

For example, a user with tetraplegia employing a brain-computer interface may direct gaze toward a ceiling fan in a living room at 2:30 PM on a day when outdoor temperature is 89° F. The system can capture image data from a head-mounted camera, receive eye tracking data indicating gaze coordinates corresponding to the ceiling fan location, modify the image data to include a red circular marker at the gaze coordinates, and provide the modified image to a vision-language model. The vision-language model can process the modified image and generate an object description: “ceiling fan with four wooden blades, currently rotating at moderate speed, mounted on white ceiling approximately 2.5 meters from camera.” The system can provide the object description and contextual information (time: 2:30 PM, outdoor temperature: 89° F., indoor temperature: 78° F., user history: has selected “increase fan speed to high” 15 times when outdoor temperature exceeded 85° F. in past 30 days, has selected “turn fan off” 0 times when outdoor temperature exceeded 80° F.) to a language model. The language model can query a device control interface to determine that the ceiling fan is registered as “living_room_fan” with current state “power: on, speed: medium” and available actions “set_speed(low|medium|high)”, “power_off( )”, and “set_timer(minutes)”. The language model can generate tasks: “Increase speed to high” (priority score: 0.92 based on 40% contextual relevance for cooling on hot day, 35% user history showing strong preference, 15% low urgency, 10% high efficiency), “Turn off fan” (priority score: 0.15), “Set to low speed” (priority score: 0.18), “Set 30-minute timer” (priority score: 0.25). The system can determine that the user input modality has 0.5-dimensional control capability and limit the task subset to 3 tasks based on the control dimensionality. The system can select the top 3 tasks: “Increase speed to high”, “Set 30-minute timer”, “Turn off fan”. The system can determine the three-dimensional spatial position of the ceiling fan as (x: 1.2 m, y: 0.3 m, z: 2.5 m) relative to the camera and generate visual elements (rectangular buttons with text labels and icons) positioned 20 centimeters to the right of the fan's spatial position. The system can cause rendering of the visual elements in an augmented reality display at depth 2.5 meters, creating the appearance that the buttons float in space next to the physical fan. The user can generate a brain-computer interface signal with magnitude increasing over 2.1 seconds while attending to the “Increase speed to high” button. The system can track the magnitude signal, determine that the magnitude exceeds a selection threshold corresponding to the “Increase speed to high” button position in a one-dimensional selection space, and receive the selection. The system can transmit a command “living_room_fan.set_speed(high)” to the device control interface. The device control interface can execute the command, and the ceiling fan can increase blade rotation speed. The system can cause presentation of confirmation information by changing the “Increase speed to high” button color from blue to green, displaying a checkmark icon for 2 seconds, and then fading the task presentation over 3 seconds. The system can store interaction data: timestamp: 2024-08-25 14:30:17, object: living_room_fan, presented_tasks: [“Increase speed to high”, “Set 30-minute timer”, “Turn off fan”], selected_task: “Increase speed to high”, context: {outdoor_temp: 89, indoor_temp: 78, time_of_day: “afternoon”}, execution_outcome: “success”. The total interaction time from gaze direction to task execution is 4.8 seconds (1.2 seconds for vision-language model processing, 0.8 seconds for language model task generation, 0.7 seconds for visual element rendering, 2.1 seconds for user selection via brain-computer interface signal generation). A conventional interface would require the user to navigate from a home screen to a smart home application (3.5 seconds), locate the living room fan in a device list (4.2 seconds), access fan controls (2.8 seconds), and select speed setting (3.1 seconds), totaling 13.6 seconds and requiring 4 separate selection actions compared to the single gaze-and-select action enabled by the disclosed system, reducing required interaction cycles relative to hierarchical navigation-based control.

In another example demonstrating proactive event-driven task presentation, a user may be directing attention toward a computer display showing an email composition interface at 9:03 AM when a microphone integrated into the system detects audio matching a dog barking pattern with 87% confidence, with the barking persisting continuously for 28 seconds. The system can detect the event condition (dog barking) from environmental sensor data, retrieve contextual including time-of-day and historical interaction records (e.g., parameters indicating that the user typically feeds the dog at 9:00 AM ±15 minutes based on 45 recorded feeding interactions over the past 60 days, and that current time (9:03 AM) falls within the typical feeding window), and calculate an urgency score based on weighted contextual factors. The system can compare the urgency score to a predetermined threshold to determine whether event-related tasks may need to be presented immediately or deferred. In this example, the system may compute an urgency score of 0.62 on a 0-1 scale and compare it to a predetermined interruption threshold of 0.75. Because the urgency score does not exceed the threshold, the system defers presentation of event-related task identifiers until receipt of an attention signal corresponding to a relevant object. When the user shifts gaze toward a pet feeding area, the system determines that the attention signal corresponds to a relevant object and generates task identifiers ranked according to contextual priority scores. The system may determine a current focus region corresponding to the attention location and position event-related task notifications outside the focus region to minimize interference with ongoing interaction state. Upon user selection of a task identifier via gaze dwell, the system transmits a command to a device control interface and updates interaction state records. By employing urgency score computations and threshold-based event arbitration, the system coordinates asynchronous environmental events with attention-driven interaction without requiring immediate global interruption or manual navigation to device interfaces.

In another example demonstrating multi-device coordinated control, a user may direct attention toward a television at 7:45 PM in a living room where ambient light level, window covering state, and device power states are detectable through sensor data and device interfaces. The system can capture image data, receive an attention signal indicating the television location, and provide modified image data to a vision-language model. The vision-language model can identify a plurality of devices in the visual scene (e.g., television (powered off), window coverings (motorized blinds, currently open), ceiling lights (powered on, high brightness), and table lamps (powered on, medium brightness), and generate semantic representations of device types and states. Based on semantic representations and contextual parameters, the system can determine functional relationships between devices and generate a task identifier representing coordinated control across multiple devices. Upon selection of the task identifier, the system can generate a sequence of control commands (e.g., “living_room_blinds.close( )”, “ceiling_lights.set_brightness(15)”, “table_lamps.set_brightness(20)”, “living_room_tv.power_on( )”), and construct a dependency graph representing prerequisite and timing constraints among device state transitions. The system can determine an execution order by analyzing dependency edges within the graph to ensure that state transitions occur in a sequence satisfying prerequisite, timing, and optimization constraints. The system can transmit the sequence of control commands according to the execution order (e.g., send blind closing command at t=0, send light dimming commands at t=0.5 (allowing blinds to begin closing), send television power-on command at t=2.0 (allowing lights to complete dimming)) such that device operations occur in coordinated fashion without requiring separate interaction sequences. By performing dependency graph analysis and ordered command execution, the system reduces redundant navigation state transitions and ensures consistent multi-device state synchronization relative to independent device control operations.

Advantages of the disclosed techniques include reduction of hierarchical navigation state transitions through direct generation of task identifiers derived from visual scene analysis and attention signal encoding, thereby minimizing multi-step menu traversal and associated interface state changes. The system reduces required interaction cycles by generating limited, context-ranked task identifier subsets rather than presenting complete option sets, thereby decreasing interface rendering complexity under constrained input bandwidth conditions. Adaptive interface generation based on detected input modality characteristics enables dynamic adjustment of task identifier counts, partitioning strategies, and interaction methods in accordance with measured control dimensionality and control bandwidth. Contextual ranking and priority scoring mechanisms reduce redundant task generation and reorder task identifier lists based on computed contextual relevance rather than static menu hierarchies. Event-driven arbitration using urgency score computation and threshold comparison enables asynchronous environmental signals to be coordinated with current interaction state without unconditional global interruption or manual navigation to device control interfaces. Vision-language model processing enables identification of controllable objects and generation of task identifiers without reliance on predetermined object-to-control mappings, thereby reducing configuration requirements in dynamically changing device environments. Multi-device functional relationship determination and dependency graph analysis enable generation and ordered execution of coordinated control command sequences, reducing independent device control operations and ensuring state synchronization across devices. Depth-matched augmented reality rendering positions task identifier indicators relative to three-dimensional object coordinates, reducing cross-display attention shifts and minimizing visual search operations. Timeout-based interface state management enables task identifier restoration without regeneration of vision-language model or language model inference when attention signals reappear within a threshold interval, reducing computational overhead. The modular architecture supports integration with diverse vision-language models, device control interfaces, and input modalities without modification to core task generation and arbitration logic.

The binary partitioning interaction method implements a binary search tree traversal strategy that reduces selection depth from linear O(N) evaluation to logarithmic O(log₂(N)) decision complexity for N task identifiers under binary input modalities. The dwell-time-based selection mechanism tracks continuous gaze duration within defined visual indicator boundary regions and triggers selection upon exceeding configurable temporal thresholds, enabling deterministic gaze-based input interpretation. Depth-matched augmented reality rendering computes three-dimensional spatial positions of physical objects and renders task identifier indicators at corresponding depths to maintain spatial alignment between virtual interface elements and physical objects. The timeout-based interface state management maintains task identifier presentation state within a bounded temporal window and restores task identifier sets without re-executing vision-language model inference when attention signals return before complete removal, thereby avoiding redundant computational processing. Contextual ranking models update task identifier priority values based on stored interaction data and environmental parameters, enabling dynamic reordering of task identifier sets without structural modification of interface hierarchies. The above-mentioned techniques provide scalable task generation, device coordination, and interaction adaptation across environments containing varying numbers of controllable devices while maintaining bounded interaction complexity and computational resource utilization.

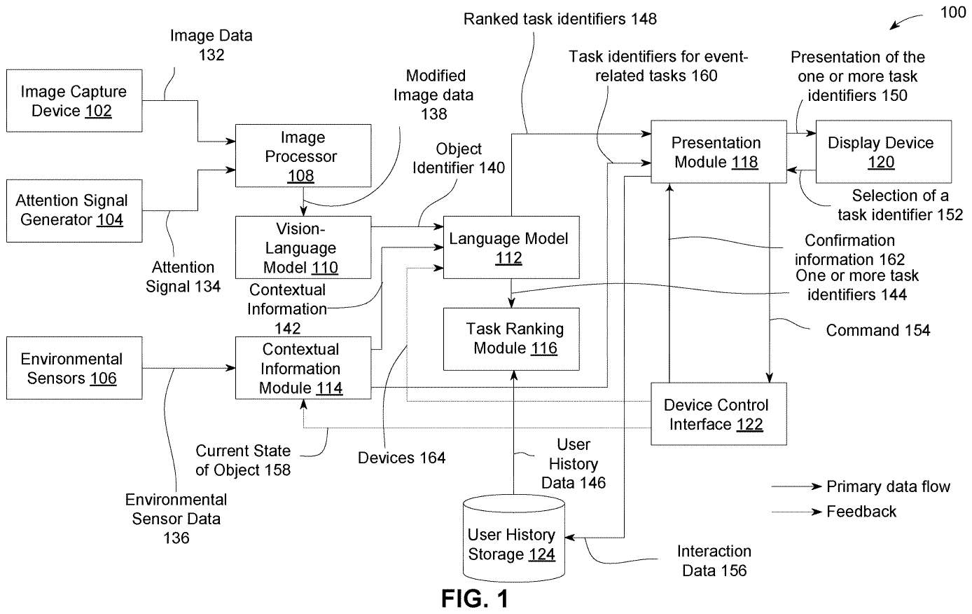

FIG. 1 illustrates a system 100 for attention-driven task generation using vision-language models, according to at least one embodiment. The system 100 can include image capture device 102, attention signal generator 104, environmental sensors 106, image processor 108, vision-language model 110, language model 112, contextual information module 114, task ranking module 116, presentation module 118, display device 120, device control interface 122, and user history storage 124. The system 100 can address the technical problem of enabling efficient interaction for users with severe motor impairments by eliminating predetermined navigation hierarchies and generating contextually-appropriate task identifiers directly from visual scene understanding and attention indication. The system 100 can overcome limitations of conventional assistive interfaces that require multi-step navigation sequences, lack contextual awareness, fail to adapt to user input capabilities, and cannot leverage visual understanding to identify controllable objects in unstructured environments.

Image capture device 102 can capture image data representing a visual scene. Image capture device 102 can include a camera integrated into a head-mounted display, a standalone camera, or an imaging sensor in an assistive device. Image capture device 102 can capture visual scenes containing multiple physical objects such as ceiling fans, light switches, thermostats, appliances, entertainment systems, or climate control devices. Image capture device 102 can operate continuously or at periodic intervals to provide current visual information about the user's environment. Image capture device 102 can transmit image data 132 to image processor 108. In some embodiments, image capture device 102 may capture RGB image data at resolutions ranging from 640×480 pixels to 1920×1080 pixels or higher, with frame rates of 15-60 frames per second depending on processing requirements and power constraints.

Attention signal generator 104 can generate an attention signal indicating a location within the visual scene. Attention signal generator 104 can derive the attention signal from eye tracking data including gaze coordinates, brain-computer interface signals indicating user focus, head orientation tracking, or manual input devices. Attention signal generator 104 can provide attention signals at update rates of 60-120 Hz for eye tracking systems or lower rates for brain-computer interfaces providing 0.5-dimensional control. Attention signal generator 104 can convert raw sensor data into standardized coordinate formats compatible with image processor 108. Attention signal generator 104 can transmit attention signal 134 to image processor 108. In some embodiments, attention signal generator 104 may include infrared cameras that monitor eye position and gaze direction, processing algorithms that calculate gaze vectors in three-dimensional space, and calibration procedures that map gaze vectors to two-dimensional image coordinates.

Environmental sensors 106 can capture environmental sensor data from the surrounding environment. Environmental sensors 106 can include temperature sensors, humidity sensors, light level sensors, audio sensors, motion sensors, air quality sensors, or occupancy sensors. Environmental sensors 106 can provide contextual information about environmental conditions such as outdoor temperature, indoor temperature, ambient light levels, or audio patterns indicating events like dog barking or smoke detector activation. Environmental sensors 106 can sample sensor data at rates appropriate for each sensor type, ranging from continuous sampling for audio sensors to periodic sampling every 1-60 seconds for temperature sensors. Environmental sensors 106 can transmit environmental sensor data 136 to contextual information module 114.

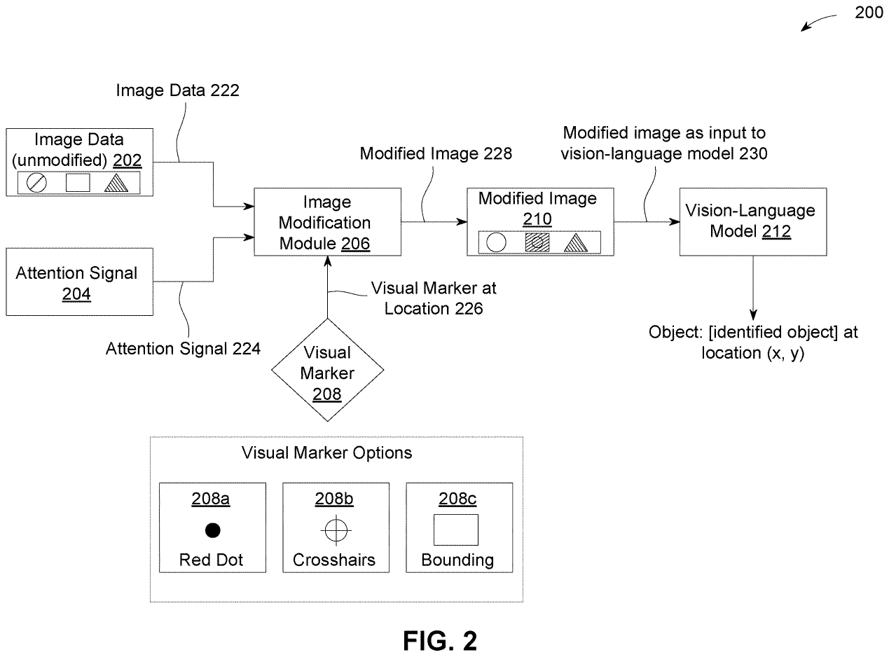

Image processor 108 can receive image data 132 from image capture device 102 and attention signal 134 from attention signal generator 104. Image processor 108 can modify the image data to include a visual marker at the location indicated by the attention signal. Image processor 108 can apply visual markers including colored dots, crosshairs, highlighting, or bounding box overlays that encode attention information directly into the image data. Image processor 108 can perform the modification by overlaying graphical elements onto the image at coordinates specified by attention signal 134, using image manipulation operations such as pixel value modification, alpha blending for semi-transparent markers, or geometric shape rendering. Image processor 108 can transmit modified image data 138 to vision-language model 110. The detailed operation of image processor 108 is illustrated in FIG. 2. In some embodiments, image processor 108 may select marker type, size, and color based on scene characteristics such as background color, object density, or lighting conditions to ensure marker visibility.

Vision-language model 110 can receive modified image data 138 from image processor 108. Vision-language model 110 can process the modified image data to identify an object at the location indicated by the attention signal. Vision-language model 110 can include a multimodal neural network that processes both visual and textual information, such as models based on transformer architectures with vision encoders and language decoders. Vision-language model 110 can apply convolutional neural network layers or vision transformer layers to extract visual features from the modified image, can identify the visual marker within the image, can determine which object in the scene corresponds to the marker location, and can generate a semantic description of the identified object. Vision-language model 110 can recognize objects such as ceiling fans, light switches, thermostats, or other devices based on visual features including shape, color, texture, and spatial context. Vision-language model 110 can generate semantic descriptions of identified objects including object type, current state based on visual appearance (such as fan blade rotation indicating power status), and spatial location. Vision-language model 110 can transmit object identifier 140 to language model 112. In some embodiments, vision-language model 110 may employ models such as GPT-4 with vision capabilities, Claude with vision capabilities, LLaVA (Large Language and Vision Assistant), or similar multimodal architectures that combine vision encoders (such as CLIP vision transformers) with large language models.

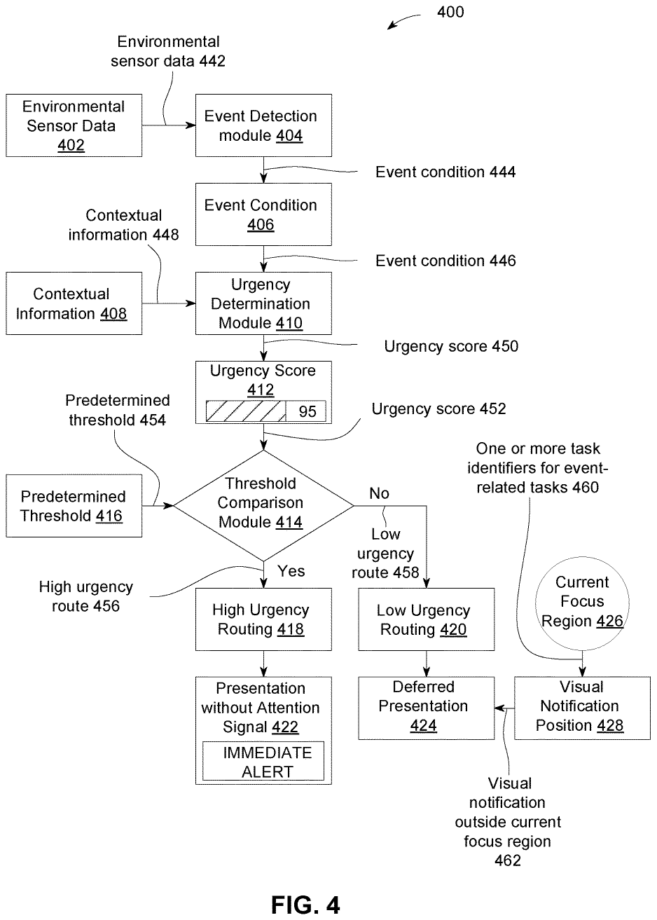

Contextual information module 114 can receive environmental sensor data 136 from environmental sensors 106 and current state of the object 158 from device control interface 122. Contextual information module 114 can obtain temporal data indicating current time of day, day of week, or season from system clocks or network time protocols. Contextual information module 114 can aggregate multiple types of contextual information including temporal data, environmental sensor data, and device state information into structured data formats suitable for language model processing. Contextual information module 114 can perform data normalization, unit conversion, and formatting operations to create consistent contextual representations. Contextual information module 114 can transmit contextual information 142 to language model 112. In some embodiments, contextual information module 114 may detect an event condition from environmental sensor data 136 indicating a state change such as smoke detector activation, doorbell activation, or pet vocalizations by applying audio pattern recognition, threshold detection, or anomaly detection algorithms. In some embodiments, contextual information module 114 may determine an urgency score of the event condition based on the contextual information by considering time of day, user activity state, and event persistence, calculating an urgency score using weighted combinations of these factors. In some embodiments, contextual information module 114 may transmit one or more task identifiers for event-related tasks 160 to presentation module 118 when the urgency score exceeds a predetermined threshold ranging from 0.6 to 0.8, with typical values of 0.75. The detailed operation of contextual information module 114 for event-driven task presentation is illustrated in FIG. 4.

Language model 112 can receive object identifier 140 from vision-language model 110, contextual information 142 from contextual information module 114, and plurality of devices 164 from device control interface 122. Language model 112 can generate one or more task identifiers representing tasks associated with the object based on the object identifier and the contextual information. Language model 112 can include a large language model such as GPT-4, Claude, LLaMA, or similar transformer-based architectures with billions of parameters trained on diverse text corpora. Language model 112 can process the object identifier to understand what object the user is attending to, can process the contextual information to understand current environmental conditions and user context, can query the plurality of devices 164 to determine what control actions are available for the identified object, and can generate natural language task descriptions that specify actionable operations. Language model 112 can determine what actions are performable with the identified object given the current context by reasoning about device capabilities, environmental conditions, and user preferences using the language model's semantic understanding and reasoning capabilities. Language model 112 can employ prompting strategies that provide the object identifier, contextual information, and available device capabilities as input context, then request the language model to generate a list of relevant task identifiers with priority scores. Language model 112 can transmit one or more task identifiers 144 to task ranking module 116. In some embodiments, language model 112 may identify a plurality of devices in the visual scene using object identifier 140 received from vision-language model 110, which may describe multiple objects visible in the scene. In some embodiments, language model 112 may determine a functional relationship between the object and at least one device of the plurality of devices based on additional capabilities, including complementary capabilities, by analyzing semantic representations and structured device capability descriptors associated with the plurality of devices. In some embodiments, language model 112 may generate at least one task identifier representing a task including coordinated control of the object and the at least one device based on the functional relationship, such as a “movie mode” task identifier that coordinates television power-on, light dimming, and window covering closure. In some embodiments, language model 112 may compare device capability vectors retrieved from device control interface 122 to identify overlapping environmental influence domains, dependency relationships between state variables, or reinforcing operational effects, and may generate coordinated task identifiers based on relationships represented in a device capability graph.

User history storage 124 can store interaction data including selection information and contextual information for each presentation of task identifiers. User history storage 124 can maintain records including timestamps, identified objects, presented task identifier lists, selected task identifiers, contextual information at time of interaction, and task execution outcomes in structured database formats such as relational databases, document databases, or time-series databases. User history storage 124 can analyze the stored interaction data to identify patterns indicating user preferences under specific contextual conditions through frequency analysis (counting how often specific task identifiers are selected under specific conditions), temporal analysis (identifying time-of-day or day-of-week patterns), or sequential analysis (identifying task identifier sequences that frequently occur together). User history storage 124 can apply statistical methods, machine learning algorithms, or rule-based pattern matching to extract patterns from historical data. User history storage 124 can transmit user history data 146 to task ranking module 116, where user history data 146 can include identified patterns, frequency counts, confidence scores, and user preference information.

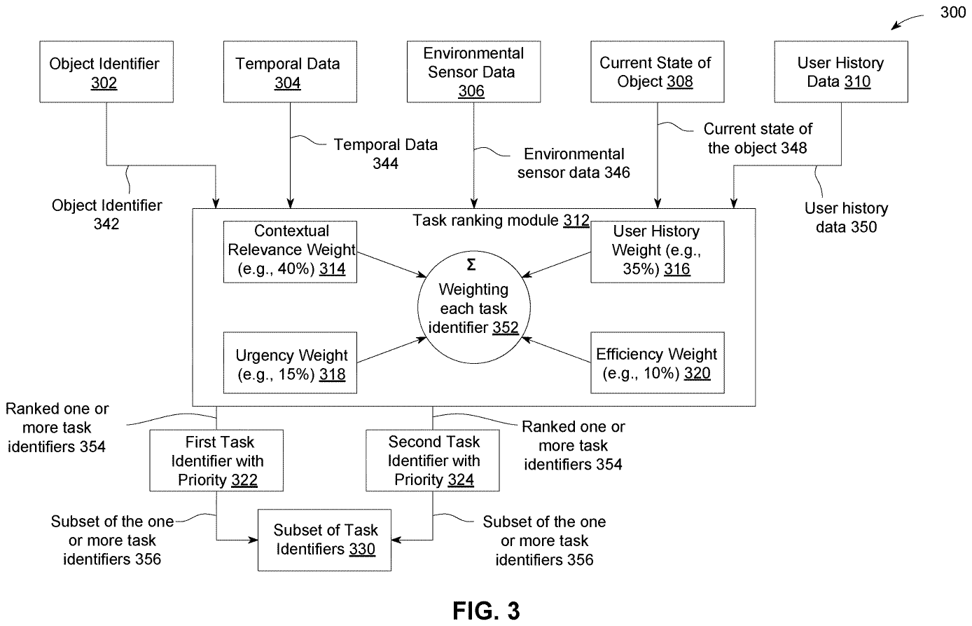

Task ranking module 116 can receive one or more task identifiers 144 from language model 112 and user history data 146 from user history storage 124. Task ranking module 116 can rank the one or more task identifiers based on the contextual information and the user history data by assigning priority scores to each task identifier. Task ranking module 116 can apply weighting factors including 40% weight to contextual relevance, 35% weight to user history patterns, 15% weight to urgency scores, and 10% weight to interaction efficiency. Task ranking module 116 can calculate a priority score for each task identifier using the formula: priority score=(0.40×contextual relevance score)+(0.35×user history score)+(0.15×urgency score)+(0.10×efficiency score), where each component score ranges from 0.0 to 1.0. Task ranking module 116 can determine contextual relevance score by comparing current environmental conditions to conditions where the task is typically appropriate, user history score by calculating frequency of task identifier selection under similar conditions, urgency score by assessing time-sensitivity and safety-criticality, and efficiency score by counting interaction steps required. Task ranking module 116 can sort task identifiers by priority score in descending order. Task ranking module 116 can transmit ranked one or more task identifiers 148 to presentation module 118. The detailed operation of task ranking module 116 is illustrated in FIG. 3.

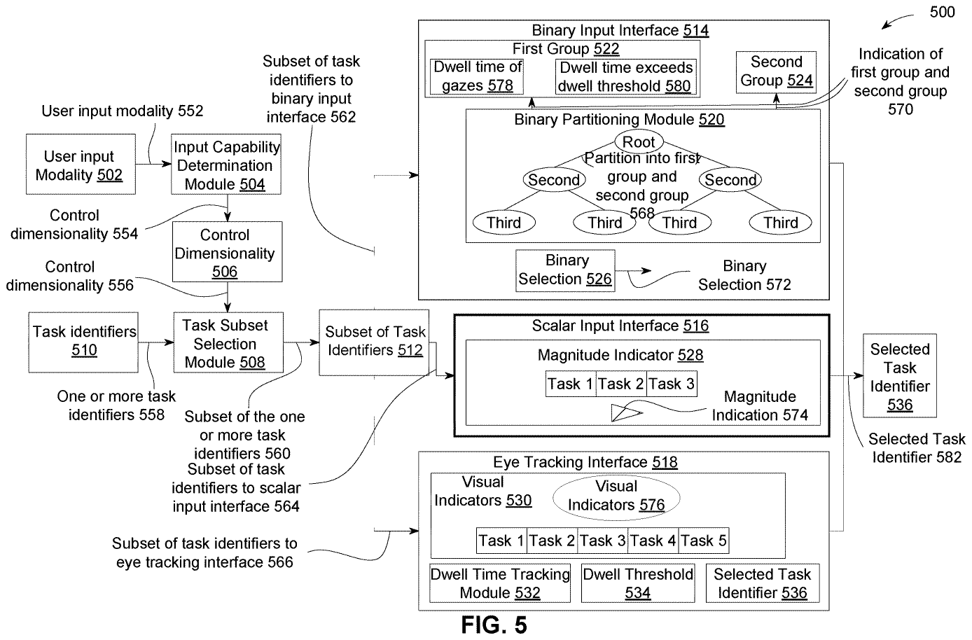

Presentation module 118 can receive ranked one or more task identifiers 148 from task ranking module 116 and one or more task identifiers for event-related tasks 160 from contextual information module 114. Presentation module 118 can determine an input capability of a user input modality by assessing control dimensionality (binary, scalar, two-dimensional, three-dimensional), control bandwidth (bits per second of information transfer), control latency (delay between user intent and system detection), and control reliability (error rate or signal-to-noise ratio). Presentation module 118 can select a subset of the one or more task identifiers based on the input capability by limiting task identifier count, simplifying task identifier descriptions, or grouping related task identifiers based on input capability constraints. Presentation module 118 can generate presentation data adapted to the user input modality by modifying visual presentation (larger targets for lower-precision input, simplified layouts for lower-bandwidth input), interaction timing (longer dwell times for higher-latency input), or interaction methods (binary partitioning for binary input, magnitude adjustment for scalar input). Presentation module 118 can transmit presentation of the one or more task identifiers 150 to display device 120. The detailed operation of presentation module 118 for input-adaptive presentation is illustrated in FIG. 5. In some embodiments, presentation module 118 may track interaction state information including user attention focus and task identifier presentation timing by monitoring which object the user is currently attending to via attention signal 134 and recording when task identifiers were presented. In some embodiments, presentation module 118 may measure a duration of user inactivity by determining elapsed time since a last attention signal or input signal was received. In some embodiments, presentation module 118 may cause display device 120 to fade the presentation of the subset of the one or more task identifiers when the duration of user inactivity exceeds a predetermined timeout threshold ranging from 5 to 15 seconds by gradually reducing opacity over 1-3 seconds. In some embodiments, presentation module 118 may restore the presentation of the subset of the one or more task identifiers without regenerating the task identifiers in response to receiving a subsequent attention signal or input signal before complete removal of the task identifiers by immediately increasing opacity of previously-generated task identifiers, avoiding computational cost and latency of re-running vision-language model 110 and language model 112.

Display device 120 can receive presentation of the one or more task identifiers 150 from presentation module 118. Display device 120 can present the one or more task identifiers to a user for selection through visual displays, auditory outputs, or haptic feedback depending on available output modalities. Display device 120 can include head-mounted displays, smart glasses, computer monitors, tablet displays, or smartphone displays. Display device 120 can render visual elements such as buttons, icons, text labels, or graphical indicators representing each task identifier in the subset. Display device 120 can receive user input selecting a task identifier from the presented task identifiers through eye tracking, brain-computer interface signals, voice commands, touch input, or gesture recognition. Display device 120 can detect user input by monitoring input devices, tracking gaze dwell times on visual indicators, measuring brain signal patterns, processing voice commands through speech recognition, detecting touch events on touchscreens, or analyzing gesture patterns through cameras or motion sensors. Display device 120 can transmit selection of a task identifier 152 to presentation module 118 when user input indicates selection of a specific task identifier. Display device 120 can receive confirmation information 162 from presentation module 118 indicating successful task execution and can present the confirmation information through visual indicators (checkmarks, color changes, animation sequences), auditory indicators (success tones, voice confirmations), or haptic indicators (vibration patterns).

Device control interface 122 can receive command 154 from presentation module 118. Device control interface 122 can include smart home platforms such as Home Assistant, Apple HomeKit, Google Home, Amazon Alexa, Samsung SmartThings, or direct device application programming interfaces. Device control interface 122 can translate commands into device-specific protocols and formats required by different device manufacturers and communication standards. Device control interface 122 can communicate with controllable devices through wireless protocols such as Wi-Fi, Zigbee, Z-Wave, Bluetooth, or Thread, or through wired protocols such as Ethernet or serial connections. Device control interface 122 can execute the task corresponding to the selected task identifier by transmitting control commands to the appropriate device, monitoring execution status, and handling errors or timeouts. Device control interface 122 can transmit confirmation information 162 to presentation module 118 indicating successful execution, execution failure, or partial execution with error details. Device control interface 122 can transmit current state of the object 158 to contextual information module 114 by querying device state through device APIs and providing current power status, setting values, operational modes, or error conditions. Device control interface 122 can transmit plurality of devices 164 to language model 112 by providing a list of available devices, their capabilities, current states, and supported control actions.

User history storage 124 can receive interaction data 156 from presentation module 118. Interaction data 156 can include timestamp of interaction, object identifier of attended object, list of presented task identifiers with priority scores, selected task identifier, contextual information at time of interaction (temporal data, environmental sensor data, device states), and task execution outcome (success, failure, error details). User history storage 124 can store interaction data 156 in structured formats with indexed fields enabling efficient querying and pattern analysis. User history storage 124 can identify patterns in the interaction data by analyzing sequences of interactions, correlating task identifier selections with contextual conditions, calculating selection frequencies for specific task identifiers under specific conditions, and detecting temporal patterns such as time-of-day preferences or day-of-week patterns. User history storage 124 can calculate confidence scores for identified patterns based on sample size, consistency of behavior, and recency of observations. User history storage 124 can transmit user history data 146 to task ranking module 116, where user history data 146 can include identified patterns with confidence scores, frequency counts for task identifier selections under various contextual conditions, and user preference profiles.

FIG. 2 illustrates a process 200 for encoding attention signals into image data for vision-language model processing, according to at least one embodiment. The image processor 108 from FIG. 1 can perform the process 200. The process 200 can enable vision-language models to identify objects of user attention without requiring vision-language models specifically trained for attention signal processing.

Image data 202 represents an unmodified image captured by image capture device 102 from FIG. 1. Image data 202 can include a visual scene containing multiple physical objects such as a ceiling fan, light switch, and thermostat in a room environment. Image data 202 can be formatted as RGB pixel arrays with dimensions corresponding to camera resolution. Image data 202 can transmit image data 222 to image modification module 206.

Attention signal 204 represents attention coordinates indicating a location within the visual scene where a user is directing attention. Attention signal 204 can include gaze coordinates in (x, y) format derived from eye tracking data, where x represents horizontal position and y represents vertical position within the image coordinate system. Attention signal 204 can be generated by attention signal generator 104 from FIG. 1. Attention signal 204 can transmit attention signal 224 to image modification module 206.

Image modification module 206 can receive image data 222 from image data 202 and attention signal 224 from attention signal 204. Image modification module 206 can modify the image data to include a visual marker at the location indicated by the attention signal. Image modification module 206 can apply visual marker 208 at the coordinates specified by attention signal 224. Image modification module 206 can perform the modification by overlaying graphical elements onto the image at the attention coordinates using image manipulation operations. Image modification module 206 can generate modified image 210 that includes visual marker 208 at the attention location. Image modification module 206 can transmit modified image 228 to modified image 210.

Visual marker 208 can include a colored dot, crosshairs, highlighting, or bounding box overlay that encodes attention information directly into image data. Visual marker 208 can be applied at the location specified by attention signal 224 via connection 226. In some embodiments, visual marker 208 may include a red dot with radius of 5-15 pixels positioned at the gaze coordinates. In some embodiments, visual marker 208 may include crosshairs with line thickness of 2-5 pixels and length of 20-40 pixels centered on the attention location. In some embodiments, visual marker 208 may include a bounding box with line thickness of 2-5 pixels surrounding the attended object with padding of 5-10 pixels. In some embodiments, visual marker 208 may include highlighting with semi-transparent color overlay (alpha value 0.3-0.5) covering the attended object region.

Modified image 210 can include the same visual scene as image data 202 but with visual marker 208 added at the attention location. Modified image 210 can be formatted in the same image format as image data 202 to maintain compatibility with vision-language model processing. Modified image 210 can transmit the modified image as input to vision-language model 230 to vision-language model 212.

Vision-language model 212 can receive modified image as input to vision-language model 230 from modified image 210. Vision-language model 212 can correspond to vision-language model 110 from FIG. 1. Vision-language model 212 can process the modified image to identify which object in the scene corresponds to the visual marker location. Vision-language model 212 can extract visual features from the modified image, can detect the visual marker within the image, can determine spatial relationships between the visual marker and objects in the scene, and can generate a semantic description of the object at the marker location. Vision-language model 212 can output object identification information such as “Object: ceiling fan at location (640, 480)” or “Object: light switch at location (320, 600)”. Vision-language model 212 can transmit the object identifier to language model 112 in FIG. 1 for task identifier generation.

The process 200 can enable attention signal integration without requiring vision-language models specifically trained for attention signal processing by encoding attention information directly into image data through visual markers. In some embodiments, the vision-language model may be fine-tuned using a training dataset comprising images annotated with synthetic or captured attention markers positioned over target objects. The training dataset may include images with visual marker overlays (e.g., colored dot, crosshair, bounding box), ground-truth labels identifying the object corresponding to the marker location, and/or multi-object scenes to train disambiguation at marker boundaries. Fine-tuning may include, for example: updating cross-attention weights between vision encoder outputs and marker regions, introducing marker-aware positional embeddings, training a marker segmentation head to identify the attention-indicated region, and/or reinforcement learning optimizing object identification accuracy at marker location. The fine-tuned model may thus learn marker-to-object association rather than relying on generic object detection.

FIG. 3 illustrates a process 300 for ranking task identifiers based on contextual information, according to at least one embodiment. The task ranking module 116 from FIG. 1 can perform the process 300. Using the process 300, the task ranking module 116 can assign priority scores to task identifiers based on weighted combinations of contextual factors, ensuring that task identifiers most likely to match user intent appear first in presented task identifier lists.

Object identifier 302 represents the identified object that the user is attending to. Object identifier 302 can include object type information such as “Ceiling Fan” along with object-specific details such as device identifier, location, and current state. Object identifier 302 can be generated by vision-language model 110 from FIG. 1. Object identifier 302 can transmit object identifier 342 to task ranking module 312.

Temporal data 304 represents time-related contextual information. Temporal data 304 can include current time of day (such as “2:30 PM”), current date (such as “August 25”), day of week (such as “Tuesday”), season (such as “Summer”), or time zone information. Temporal data 304 can be obtained by contextual information module 114 from FIG. 1 from system clocks or network time protocols. Temporal data 304 can transmit temporal data 344 to task ranking module 312.

Environmental sensor data 306 represents environmental conditions measured by sensors. Environmental sensor data 306 can include outdoor temperature (such as “89° F.”), indoor temperature (such as “78° F.”), humidity levels, light levels, audio levels, air quality measurements, or occupancy status. Environmental sensor data 306 can be captured by environmental sensors 106 from FIG. 1. Environmental sensor data 306 can transmit environmental sensor data 346 to task ranking module 312.

Current state of the object 308 represents the current operational state of the attended object. Current state of the object 308 can include power status (on/off), setting values (such as “Speed: Medium” for a fan), operational modes (such as “Cooling” for a thermostat), or error conditions. Current state of the object 308 can be obtained by contextual information module 114 from device control interface 122 in FIG. 1. Current state of the object 308 can transmit current state of the object 348 to task ranking module 312.

User history data 310 represents historical interaction patterns and user preferences. User history data 310 can include records of previous task identifier selections under specific contextual conditions, such as “High speed selected 15/15 times when temperature>85° F.”. User history data 310 can include frequency counts, temporal patterns, sequential patterns, and confidence scores for identified preferences. User history data 310 can be generated by user history storage 124 from FIG. 1. User history data 310 can transmit user history data 350 to task ranking module 312.

Task ranking module 312 can receive object identifier 342 from object identifier 302, temporal data 344 from temporal data 304, environmental sensor data 346 from environmental sensor data 306, current state of the object 348 from current state of the object 308, and user history data 350 from user history data 310. Task ranking module 312 can correspond to task ranking module 116 from FIG. 1. Task ranking module 312 can apply weighting factors to calculate priority scores for task identifiers. Task ranking module 312 can include contextual relevance weight 314 (40%), user history weight 316 (35%), urgency weight 318 (15%), and efficiency weight 320 (10%). Task ranking module 312 can calculate priority scores using the formula: priority score=(0.40×contextual relevance score)+(0.35×user history score)+(0.15×urgency score)+(0.10×efficiency score). Task ranking module 312 can weight each task identifier 352 as an internal process. Task ranking module 312 can transmit ranked one or more task identifiers 354 to task identifiers 322 and 324.

Contextual relevance weight 314 represents the weighting factor applied to contextual relevance scores. For example, contextual relevance weight 314 may assign 40% weight to how well current environmental conditions match conditions where a task is typically appropriate. Contextual relevance weight 314 can be applied within task ranking module 312 during the weighting process.

User history weight 316 represents the weighting factor applied to user history scores. For example, user history weight 316 may assign 35% weight to how frequently the user has selected the task identifier under similar conditions. User history weight 316 can be applied within task ranking module 312 during the weighting process.

Urgency weight 318 represents the weighting factor applied to urgency scores. For example, urgency weight 318 may assign 15% weight to how time-sensitive or safety-critical the task is. Urgency weight 318 can be applied within task ranking module 312 during the weighting process.

Efficiency weight 320 represents the weighting factor applied to efficiency scores. For example, efficiency weight 320 may assign 10% weight to how many interaction steps the task requires for completion. Efficiency weight 320 can be applied within task ranking module 312 during the weighting process.

First task identifier with priority 322 represents the highest-priority task identifier after ranking. First task identifier with priority 322 can include a task identifier label such as “Increase to high speed” and a priority score such as 0.92. First task identifier with priority 322 can receive ranked task identifier data from task ranking module 312 via connection 354.

Second task identifier with priority 324 represents the second-highest-priority task identifier after ranking. Second task identifier with priority 324 can include a task identifier label such as “Set 30-min timer” and a priority score such as 0.25. Second task identifier with priority 324 can receive ranked task identifier data from task ranking module 312 via connection 354.

Third task identifier with priority (not shown) represents the third-highest-priority task identifier after ranking. Third task identifier with priority may include a task identifier label such as “Turn off” and a priority score such as 0.15. Third task identifier with priority can receive ranked task identifier data from task ranking module 312 via connection 354.

Fourth task identifier with priority (not shown) represents the fourth-highest-priority task identifier after ranking. Fourth task identifier with priority may include a task identifier label such as “Decrease to low speed” and a priority score such as 0.12. Fourth task identifier with priority can receive ranked task identifier data from task ranking module 312 via connection 354.

Subset of the one or more task identifiers 330 represents the top-ranked task identifiers selected for presentation to the user. Subset of the one or more task identifiers 330 may include the top 3-5 task identifiers based on priority scores. Subset of the one or more task identifiers 330 can include task identifier labels such as “Increase to high speed,” “Set 30-min timer,” and “Turn off”. Subset of the one or more task identifiers 330 can receive task identifiers from first task identifier with priority 322, second task identifier with priority 324, and third task identifier with priority (not shown). Subset of the one or more task identifiers 330 can transmit subset of the one or more task identifiers 356 to presentation module 118 in FIG. 1.

The process 300 can enable intelligent task identifier prioritization that adapts to user context and preferences. For example, when a user directs attention toward a ceiling fan at 2:30 PM on a hot day (outdoor temperature 89° F., indoor temperature 78° F.) with the fan currently running at medium speed, and user history indicates the user has selected “Increase to high speed” 15 out of 15 times when temperature exceeded 85° F., the process 300 can assign a priority score of 0.92 to “Increase to high speed” (high contextual relevance due to hot temperature, high user history score due to consistent past behavior, moderate urgency, high efficiency). The process 300 can assign lower priority scores to less contextually-appropriate task identifiers such as “Turn off” (0.15) or “Decrease to low speed” (0.12), ensuring that the most relevant task identifier appears first in the presented list.

FIG. 4 illustrates a process 400 for event-driven task identifier presentation based on urgency assessment, according to at least one embodiment. The contextual information module 114 from FIG. 1 can perform the process 400 for proactive event handling. Using the process 400, the contextual information module 114 can balance urgency assessment with focus preservation by immediately presenting high-urgency event-related task identifiers while deferring low-urgency event-related task identifiers until user attention naturally shifts.

Environmental sensor data 402 represents sensor measurements indicating environmental events. Environmental sensor data 402 can include audio patterns from microphones (such as dog barking, smoke detector alarms, doorbell rings), motion detection from motion sensors, temperature changes from temperature sensors, or other environmental state changes. Environmental sensor data 402 can be captured by environmental sensors 106 from FIG. 1. Environmental sensor data 402 can transmit environmental sensor data 442 to event detection module 404.

Event detection module 404 can receive environmental sensor data 442 from environmental sensor data 402. Event detection module 404 can detect an event condition indicating a state change by applying pattern recognition algorithms, threshold detection, or anomaly detection to the sensor data. Event detection module 404 can identify specific event types such as smoke detector activation, doorbell activation, pet vocalization, or appliance malfunction. Event detection module 404 can extract event characteristics such as event type, event duration, event intensity, and event persistence. Event detection module 404 can generate event condition 406 representing the detected event. Event detection module 404 can transmit event condition 444 to event condition 406 and can transmit event condition 446 to urgency determination module 410.

Event condition 406 represents a detected environmental event requiring potential user attention. Event condition 406 can include event type (such as “dog barking”), event characteristics (such as duration of 29 seconds, intensity level, pattern consistency), and timestamp of detection. Event condition 406 can receive event condition 444 from event detection module 404.

Contextual information 408 represents contextual factors relevant to urgency assessment. Contextual information 408 can include current time of day, user activity state (such as actively working, sleeping, watching television), event persistence (continuous vs. brief), historical event patterns, and user preferences for interruption thresholds. Contextual information 408 can be obtained by contextual information module 114 from FIG. 1. Contextual information 408 can transmit contextual information 448 to urgency determination module 410.

Urgency determination module 410 can receive event condition 446 from event detection module 404 and contextual information 448 from contextual information 408. Urgency determination module 410 can determine an urgency score of the event condition based on the contextual information. Urgency determination module 410 can calculate an urgency score ranging from 0.0 (no urgency) to 1.0 (maximum urgency) using weighted combinations of factors including event type severity, time of day appropriateness, user activity disruption cost, and event persistence. Urgency determination module 410 can apply urgency calculation rules such as: smoke detector activation receives urgency score 0.95 (high safety criticality), doorbell at 3:00 AM receives urgency score 0.80 (unusual timing suggests importance), doorbell at 3:00 PM receives urgency score 0.50 (normal timing), dog barking for 29 seconds at 9:03 AM receives urgency score 0.62 (moderate urgency, aligns with typical feeding time). Urgency determination module 410 can generate urgency score 412 representing the calculated urgency score. Urgency determination module 410 can transmit urgency score 450 to urgency score 412 and can transmit urgency score 452 to threshold comparison module 414.

Urgency score 412 represents the calculated urgency score for the detected event. Urgency score 412 can include a numerical score ranging from 0.0 to 1.0, such as 0.62 for a dog barking event. Urgency score 412 can receive urgency score 450 from urgency determination module 410.

Threshold comparison module 414 can receive urgency score 452 from urgency determination module 410 and predetermined threshold 454 from predetermined threshold 416. Threshold comparison module 414 can compare the urgency score to the predetermined threshold to determine whether immediate presentation or deferred presentation is appropriate. Threshold comparison module 414 can route event-related task identifiers to high urgency routing 418 when the urgency score exceeds the predetermined threshold. Threshold comparison module 414 can route event-related task identifiers to low urgency routing 420 when the urgency score is below the predetermined threshold. Threshold comparison module 414 can transmit high urgency route 456 to high urgency routing 418 and can transmit low urgency route 458 to low urgency routing 420.

Predetermined threshold 416 represents the threshold value used to distinguish high-urgency events from low-urgency events. Predetermined threshold 416 can range from 0.6 to 0.8, with typical values of 0.75. Predetermined threshold 416 can be configured based on user preferences, application requirements, or adaptive learning from user responses to interruptions. Predetermined threshold 416 can transmit predetermined threshold 454 to threshold comparison module 414.

High urgency routing 418 can receive high urgency route 456 from threshold comparison module 414. High urgency routing 418 can route high-urgency events for immediate presentation without waiting for an attention signal. High urgency routing 418 can generate one or more task identifiers for event-related tasks associated with the high-urgency event. High urgency routing 418 can transmit one or more task identifiers for event-related tasks 460 to presentation without attention signal 422.

Low urgency routing 420 can receive low urgency route 458 from threshold comparison module 414. Low urgency routing 420 can route low-urgency events for deferred presentation until receiving an attention signal directed to a relevant object. Low urgency routing 420 can store event information and associated task identifiers for later presentation. Low urgency routing 420 can monitor for attention signals directed to objects relevant to the event. Low urgency routing 420 can transmit deferred event information to deferred presentation 424.

Presentation without attention signal 422 can receive one or more task identifiers for event-related tasks 460 from high urgency routing 418. Presentation without attention signal 422 can cause immediate presentation of event-related task identifiers without waiting for user attention to shift. Presentation without attention signal 422 can generate visual notifications, auditory alerts, or haptic feedback to immediately inform the user of the high-urgency event. Presentation without attention signal 422 can display event-related task identifiers such as “Call fire department,” “Activate sprinklers,” or “Evacuate” for a smoke detector activation event. Presentation without attention signal 422 can transmit presentation data to presentation module 118 in FIG. 1.

Deferred presentation 424 can receive deferred event information from low urgency routing 420. Deferred presentation 424 can defer presentation of event-related task identifiers until receiving an attention signal directed to a relevant object. Deferred presentation 424 can monitor attention signals from attention signal generator 104 in FIG. 1. Deferred presentation 424 can determine when user attention shifts to an object relevant to the deferred event. Deferred presentation 424 can cause presentation of event-related task identifiers when the attention signal indicates user attention has shifted to the relevant object. Deferred presentation 424 can determine current focus region 426 corresponding to the location indicated by the attention signal. Deferred presentation 424 can position visual notification 428 for the event-related task identifiers outside the current focus region to avoid disrupting ongoing user activity.

Current focus region 426 represents the area of the visual scene where the user is currently directing attention. Current focus region 426 can include a circular or rectangular area centered on the attention signal location with radius or dimensions determined by typical object sizes and visual attention spans. Current focus region 426 can have a radius of 20-40 centimeters for objects at typical viewing distances of 1-3 meters. Current focus region 426 can be calculated by deferred presentation 424 based on the attention signal coordinates and object distance information.

Visual notification position 428 represents the location where event-related task identifier notifications are positioned to avoid disrupting current focus. Visual notification position 428 can be positioned outside current focus region 426 in peripheral vision areas. Visual notification position 428 can be positioned 30-50 centimeters away from the current focus region center. Visual notification position 428 can be positioned above, below, or to the side of the current focus region depending on available space and scene layout. Visual notification position 428 can enable users to maintain focus on current tasks while remaining aware of events requiring potential attention.

The process 400 can enable intelligent interruption management that balances immediate response to critical events with preservation of user focus for non-critical events. For example, when a smoke detector activates (urgency score 0.95, exceeds threshold 0.75), the process 400 can immediately present task identifiers such as “Call fire department” or “Activate sprinklers” without waiting for user attention to shift, ensuring rapid response to safety-critical situations. When a dog barks for food (urgency score 0.62, below threshold 0.75), the process 400 can defer presentation until the user naturally shifts attention toward the pet feeding area, avoiding disruption of ongoing activities such as email composition while ensuring timely response to the animal welfare concern.

FIG. 5 illustrates a process 500 for adapting task identifier presentation to user input capabilities, according to at least one embodiment. The presentation module 118 from FIG. 1 can perform the process 500. The process 500 can adjust task identifier count, interaction methods, and interface layouts based on user input modality characteristics, enabling users with severely limited input capabilities to achieve efficient task identifier selection.

User input modality 502 represents the input mechanism available to the user for task identifier selection. User input modality 502 can include binary input mechanisms (single yes/no signal generation providing zero-dimensional control), monotonic scalar input mechanisms (magnitude adjustment in one direction providing 0.5-dimensional control), bidirectional one-dimensional input mechanisms (magnitude adjustment along a single axis providing 1D control), eye tracking (gaze-based selection with dwell time detection), two-dimensional cursor control (mouse, touchpad, joystick), or three-dimensional spatial input (hand tracking, motion controllers). User input modality 502 can be determined by presentation module 118 from FIG. 1 based on available input devices and user capabilities. User input modality 502 can transmit user input modality 552 to input capability determination module 504.

Input capability determination module 504 can receive user input modality 552 from user input modality 502. Input capability determination module 504 can determine an input capability of the user input modality by assessing multiple dimensions of input performance. Input capability determination module 504 can assess control dimensionality (number of independent parameters the user can control simultaneously), control bandwidth (bits per second of information transfer), control latency (delay between user intent and system detection), and control reliability (error rate or signal-to-noise ratio). Input capability determination module 504 can generate control dimensionality 506 representing the assessed input capability. Input capability determination module 504 can transmit control dimensionality 554 to control dimensionality 506 and can transmit control dimensionality 556 to task subset selection module 508.

Control dimensionality 506 represents the number of independent parameters the user can control simultaneously. Control dimensionality 506 can include binary (0D—single yes/no selection), monotonic scalar (0.5D—magnitude adjustment in one direction only), one-dimensional (1D—bidirectional magnitude adjustment along a single axis), two-dimensional (2D—independent control of two parameters such as x and y position), or three-dimensional (3D—independent control of three parameters such as x, y, and z position). Control dimensionality 506 can receive control dimensionality 554 from input capability determination module 504.

Task subset selection module 508 can receive control dimensionality 556 from input capability determination module 504 and one or more task identifiers 558 from one or more task identifiers 510. Task subset selection module 508 can select a subset of the one or more task identifiers based on the input capability. Task subset selection module 508 can limit the number of task identifiers in the subset based on control dimensionality, where the number of task identifiers decreases as control dimensionality decreases. Task subset selection module 508 can apply task identifier count limits such as: binary input limited to 2-4 task identifiers (enabling 1-2 levels of binary partitioning), scalar input limited to 3-5 task identifiers (enabling magnitude-based selection), eye tracking limited to 4-8 task identifiers (balancing selection speed with accuracy), two-dimensional input limited to 8-12 task identifiers (enabling grid layouts), three-dimensional input limited to 12-20 task identifiers (enabling spatial arrangements). Task subset selection module 508 can simplify task identifier descriptions by using shorter text labels, removing detailed explanations, or using icons instead of text. Task subset selection module 508 can group related task identifiers to reduce apparent complexity. Task subset selection module 508 can transmit subset of the one or more task identifiers 560 to subset of the one or more task identifiers 512.

One or more task identifiers 510 represents the complete set of task identifiers generated by language model 112 and ranked by task ranking module 116 from FIG. 1. One or more task identifiers 510 can include 5-20 task identifiers with associated priority scores. One or more task identifiers 510 can include task identifier labels such as “Task identifier 1,” “Task identifier 2,” “Task identifier 3,” “Task identifier 4,” “Task identifier 5,” “Task identifier 6,” “Task identifier 7,” and additional task identifiers. One or more task identifiers 510 can transmit one or more task identifiers 558 to task subset selection module 508.

Subset of the one or more task identifiers 512 represents the filtered set of task identifiers selected for presentation based on input capability constraints. Subset of the one or more task identifiers 512 can include 2-8 task identifiers depending on control dimensionality. Subset of the one or more task identifiers 512 can include task identifier labels such as “Task identifier 1,” “Task identifier 2,” “Task identifier 3,” “Task identifier 4,” “Task identifier 5” for a scalar input modality. Subset of the one or more task identifiers 512 can receive subset of the one or more task identifiers 560 from task subset selection module 508. Subset of the one or more task identifiers 512 can transmit subset of task identifiers to binary input interface 562 to binary input interface 514, can transmit subset of task identifiers to scalar input interface 564 to scalar input interface 516, and can transmit subset of task identifiers to eye tracking interface 566 to eye tracking interface 518.

Binary input interface 514 can receive subset of task identifiers to binary input interface 562 from subset of the one or more task identifiers 512. Binary input interface 514 can cause presentation of the subset of the one or more task identifiers via an interface adapted to binary input mechanisms. Binary input interface 514 can include binary partitioning module 520 that recursively divides the subset into groups. Binary input interface 514 can partition the subset of the one or more task identifiers into first group 522 and second group 524. Binary input interface 514 can cause presentation of an indication of first group 522 and second group 524 through visual labels, auditory descriptions, or haptic patterns. Binary input interface 514 can receive binary selection 526 indicating either first group 522 or second group 524. Binary input interface 514 can cause presentation of individual task identifiers within the selected group for final task identifier selection. Binary input interface 514 can repeat the partitioning process recursively until a single task identifier is selected. Binary input interface 514 can transmit selected task identifier 582 to selected task identifier 536 when a task identifier is selected.

Binary partitioning module 520 can operate within binary input interface 514. Binary partitioning module 520 can partition the subset of the one or more task identifiers into a first group and a second group by dividing the task identifier set approximately in half. Binary partitioning module 520 can apply balanced partitioning to minimize the number of binary decisions required. Binary partitioning module 520 can require ceiling(log₂(N)) binary decisions to select one task identifier from N total task identifiers.

First group 522 represents the first partition of task identifiers in the binary partitioning process. First group 522 can include approximately half of the task identifiers in the current set. First group 522 can include task identifier labels such as “Task identifiers 1-3” for a set of 5 task identifiers. First group 522 can receive partition data via connection 568 from binary partitioning module 520.

Second group 524 represents the second partition of task identifiers in the binary partitioning process. Second group 524 can include approximately half of the task identifiers in the current set. Second group 524 can include task identifier labels such as “Task identifiers 4-5” for a set of 5 task identifiers. Second group 524 can receive partition data via connection 568 from binary partitioning module 520.

Binary selection 526 represents the user's binary choice between first group 522 and second group 524. Binary selection 526 can be generated by the user through a brain-computer interface signal, a single-button press, or other binary input mechanism. Binary selection 526 can indicate either “Group 1” or “Group 2”. Binary selection 526 can transmit binary selection 572 to binary input interface 514 for processing.

Scalar input interface 516 can receive subset of task identifiers to scalar input interface 564 from subset of the one or more task identifiers 512. Scalar input interface 516 can cause presentation of the subset of the one or more task identifiers via an interface adapted to scalar input mechanisms. Scalar input interface 516 can display magnitude indicator 528 showing the current magnitude level of the scalar input signal. Scalar input interface 516 can map the one-dimensional magnitude value to task identifier selection by dividing the magnitude range into segments corresponding to each task identifier in the subset. Scalar input interface 516 can select the task identifier corresponding to the magnitude level when the user stops increasing the magnitude or when the magnitude reaches a selection threshold. Scalar input interface 516 can transmit selected task identifier 582 to selected task identifier 536 when a task identifier is selected.

Magnitude indicator 528 can operate within scalar input interface 516. Magnitude indicator 528 can display the current magnitude level of the scalar input signal generated by the user. Magnitude indicator 528 can include a horizontal or vertical bar that fills progressively as the magnitude increases. Magnitude indicator 528 can be divided into segments corresponding to each task identifier in the subset, with visual boundaries between segments. Magnitude indicator 528 can provide visual feedback showing which task identifier will be selected at the current magnitude level. Magnitude indicator 528 can display magnitude indication 574 to show the current state.

Eye tracking interface 518 can receive subset of task identifiers to eye tracking interface 566 from subset of the one or more task identifiers 512. Eye tracking interface 518 can cause presentation of the subset of the one or more task identifiers via an interface adapted to eye tracking input mechanisms. Eye tracking interface 518 can cause presentation of visual indicators 530 for each task identifier in the subset. Eye tracking interface 518 can track dwell time of gazes on each visual indicator through dwell time tracking module 532. Eye tracking interface 518 can select a task identifier from the subset when the dwell time of a gaze on a visual indicator for the task identifier exceeds dwell threshold 534. Eye tracking interface 518 can transmit selected task identifier 582 to selected task identifier 536 when a task identifier is selected.

Visual indicators 530 can operate within eye tracking interface 518. Visual indicators 530 can include buttons, icons, text labels, or graphical elements with distinct visual boundaries for each task identifier in the subset. Visual indicators 530 can be arranged in layouts optimized for eye tracking such as circular arrangements, grid layouts, or linear arrangements with adequate spacing between indicators. Visual indicators 530 can include task identifier labels such as “Task identifier 1,” “Task identifier 2,” “Task identifier 3,” “Task identifier 4,” “Task identifier 5”. Visual indicators 530 can display visual indicators 576 to the user.

Dwell time tracking module 532 can operate within eye tracking interface 518. Dwell time tracking module 532 can track dwell time of gazes on each visual indicator by monitoring which visual indicator the user's gaze is focused on and measuring continuous gaze duration within that visual indicator's boundary region. Dwell time tracking module 532 can reset the dwell time measurement when gaze moves outside the boundary of a visual indicator. Dwell time tracking module 532 can continuously monitor dwell time of gazes 578 during user interaction. Dwell time tracking module 532 can compare the measured dwell time to dwell threshold 534. Dwell time tracking module 532 can determine dwell time exceeds dwell threshold 534 when the dwell time reaches or exceeds the threshold value.

Dwell threshold 534 can operate within eye tracking interface 518. Dwell threshold 534 can include a threshold value ranging from 0.5 seconds to 3.0 seconds, with typical values of 1.0 to 2.0 seconds. Dwell threshold 534 can balance selection speed (lower thresholds enable faster selection) with accuracy (higher thresholds reduce accidental selections). Dwell threshold 534 can be configured based on user preferences, input reliability, or adaptive learning from user performance. Dwell threshold 534 can provide the threshold value for comparison via connection 580.

Selected task identifier 536 represents the task identifier chosen by the user through the adapted interface. Selected task identifier 536 can receive selected task identifier 582 from binary input interface 514, scalar input interface 516, or eye tracking interface 518 depending on which interface is active based on user input modality 502. Selected task identifier 536 can include the task identifier label such as “Task identifier 2” and associated task information. Selected task identifier 536 can be transmitted to presentation module 118 in FIG. 1 for execution via device control interface 122.

The process 500 can enable users with severely limited input capabilities to achieve efficient task identifier selection through input-adaptive presentation. For example, a user with binary input capability can select from 5 task identifiers through 3 binary decisions using the binary partitioning approach (first decision: “Task identifiers 1-3” vs “Task identifiers 4-5”, second decision: “Task identifier 1” vs “Task identifiers 2-3”, third decision: “Task identifier 2” vs “Task identifier 3”), requiring 3 binary selections instead of 5 sequential evaluations. A user with scalar input capability can select from 5 task identifiers by generating a scalar signal with magnitude increasing until the magnitude indicator shows the desired task identifier segment, then holding the magnitude level for 0.5 seconds to confirm selection. A user with eye tracking capability can select from 5 task identifiers by directing gaze to the desired visual indicator and maintaining gaze for 1.5 seconds until the dwell threshold is exceeded, with visual feedback showing dwell time progress through a filling circle or expanding ring around the indicator.

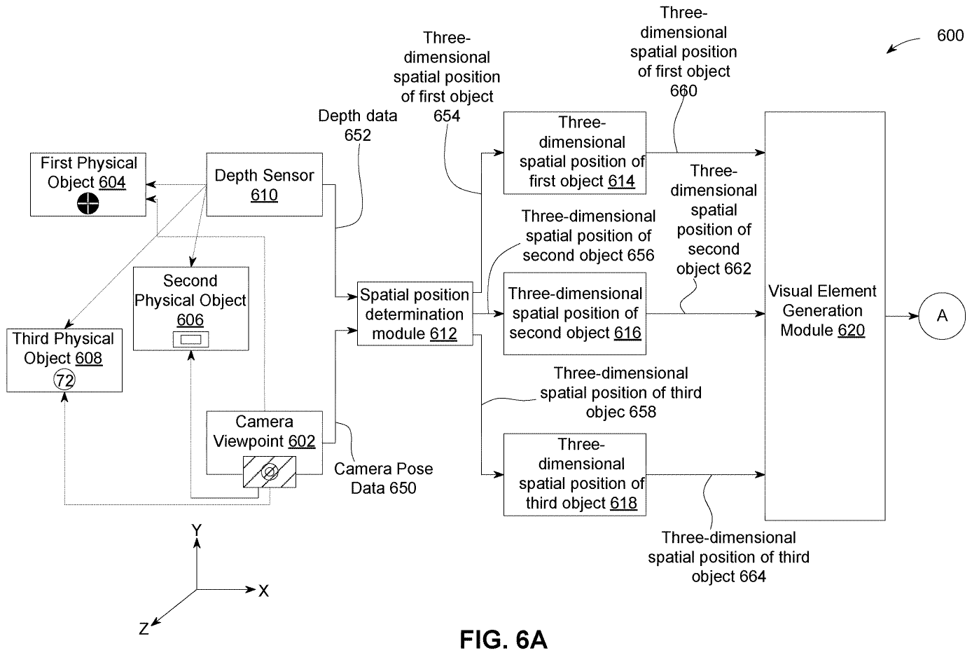

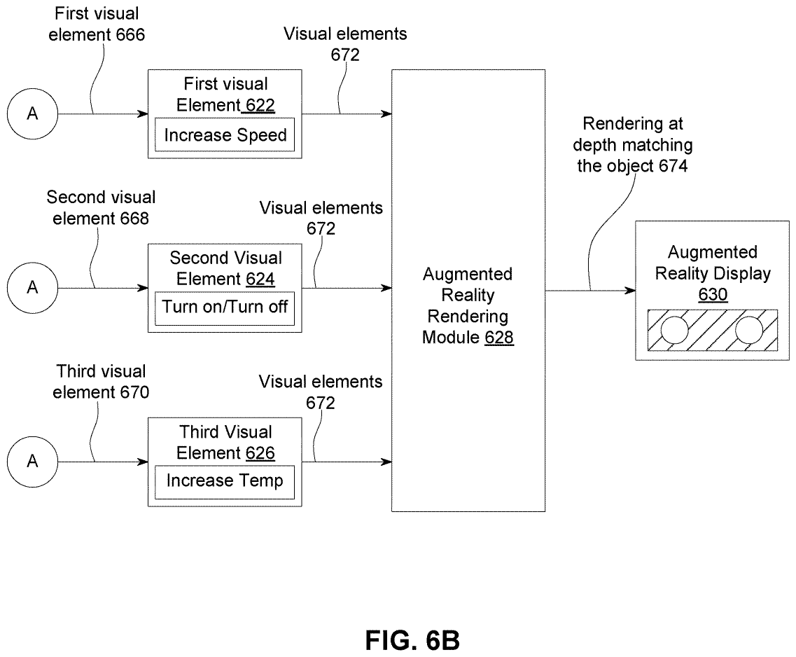

FIGS. 6A and 6B illustrate a process 600 for depth-matched augmented reality rendering of task identifier indicators, according to at least one embodiment. The display device 120 from FIG. 1 can perform the process 600. The display device 120 may include augmented reality display capabilities. The display device 120 can position task identifier indicators adjacent to physical objects at matching depths, creating seamless integration between physical objects and virtual task identifier indicators.

Camera viewpoint 602 can include a position and orientation of a camera or head-mounted display capturing a visual scene. Camera viewpoint 602 can correspond to image capture device 102 from FIG. 1 when image capture device 102 includes depth sensing capabilities. Camera viewpoint 602 can serve as the origin point for three-dimensional spatial measurements. Camera viewpoint 602 can define a field of view within which physical objects are visible. Camera viewpoint 602 can provide a reference frame for determining spatial positions of objects in the scene using a coordinate system where the camera position is the origin, the z-axis extends forward along the camera's viewing direction, the x-axis extends horizontally to the right, and the y-axis extends vertically upward. Camera viewpoint 602 can transmit camera pose data 650 to spatial position determination module 612, where camera pose data 650 can include position coordinates and orientation angles that define the reference frame for spatial position calculations.

First physical object 604 represents a physical object in the visual scene such as a ceiling fan. First physical object 604 can be positioned at a depth of 2.5 meters from camera viewpoint 602. First physical object 604 can be visible within the field of view of camera viewpoint 602. First physical object 604 can be identified by vision-language model 110 from FIG. 1 as an object of user attention.

Second physical object 606 represents a physical object in the visual scene such as a light switch. Second physical object 606 can be positioned at a depth of 3.0 meters from camera viewpoint 602. Second physical object 606 can be visible within the field of view of camera viewpoint 602.

Third physical object 608 represents a physical object in the visual scene such as a thermostat. Third physical object 608 can be positioned at a depth of 2.8 meters from camera viewpoint 602. Third physical object 608 can be visible within the field of view of camera viewpoint 602.

Depth sensor 610 can capture depth information for objects in the visual scene. Depth sensor 610 can include a structured light sensor (projecting known patterns and measuring pattern distortion to calculate depth), a stereo camera system (using disparity between two camera views to triangulate depth), or a LiDAR sensor (using laser scanning to measure distances). Depth sensor 610 can measure distances from camera viewpoint 602 to physical objects in the scene. Depth sensor 610 can generate depth measurements for first physical object 604, second physical object 606, and third physical object 608 by emitting signals, detecting reflections, and calculating distances based on signal travel time or pattern analysis. Depth sensor 610 can transmit depth data 652 to spatial position determination module 612.

Spatial position determination module 612 can receive camera pose data 650 from camera viewpoint 602 and depth data 652 from depth sensor 610. Spatial position determination module 612 can determine three-dimensional spatial positions of physical objects in the scene. Spatial position determination module 612 can use camera pose data 650 to establish the coordinate system origin and orientation. Spatial position determination module 612 can calculate (x, y, z) coordinates for each object relative to camera viewpoint 602, where x represents horizontal position, y represents vertical position, and z represents depth. Spatial position determination module 612 can combine depth measurements with object detection data (from vision-language model 110 in FIG. 1) to determine precise spatial positions by associating depth values with detected object bounding boxes. Spatial position determination module 612 can perform coordinate transformations to convert depth sensor measurements into the camera coordinate system using the camera pose data 650 as the transformation reference. Spatial position determination module 612 can transmit three-dimensional spatial position of first object 654 to three-dimensional spatial position of first object 614, three-dimensional spatial position of second object 656 to three-dimensional spatial position of second object 616, and three-dimensional spatial position of third object 658 to three-dimensional spatial position of third object 618. In some embodiments, spatial position determination module 612 may employ simultaneous localization and mapping algorithms to track object positions as camera viewpoint 602 moves, maintaining consistent spatial positions across camera motion. In some embodiments, spatial position determination module 612 may update three-dimensional spatial positions continuously as the user moves through the environment, recalculating positions at frame rates of 15-60 Hz. In some embodiments, spatial position determination module 612 may maintain persistent spatial positions for known objects even when they temporarily leave the field of view by storing last-known positions and updating them when objects reappear.

Three-dimensional spatial position of first object 614 can receive three-dimensional spatial position of first object 654 from spatial position determination module 612. Three-dimensional spatial position of first object 614 can include coordinate data indicating the position of first physical object 604 such as (x: 1.2 m, y: 0.3 m, z: 2.5m), where x=1.2 m indicates the object is 1.2 meters to the right of camera viewpoint 602, y=0.3 m indicates the object is 0.3 meters above camera viewpoint 602, and z=2.5 m indicates the object is 2.5 meters forward from camera viewpoint 602. Three-dimensional spatial position of first object 614 can transmit three-dimensional spatial position of first object 660 to visual element generation module 620.

Three-dimensional spatial position of second object 616 can receive three-dimensional spatial position of second object 656 from spatial position determination module 612. Three-dimensional spatial position of second object 616 can include coordinate data indicating the position of second physical object 606 such as (x: 2.0 m, y: 0.0 m, z: 3.0 m). Three-dimensional spatial position of second object 616 can transmit three-dimensional spatial position of second object 662 to visual element generation module 620.

Three-dimensional spatial position of third object 618 can receive three-dimensional spatial position of third object 658 from spatial position determination module 612. Three-dimensional spatial position of third object 618 can include coordinate data indicating the position of third physical object 608 such as (x: 1.5 m, y: −0.2 m, z: 2.8 m). Three-dimensional spatial position of third object 618 can transmit three-dimensional spatial position of third object 664 to visual element generation module 620.

Visual element generation module 620 can receive three-dimensional spatial position of first object 660 from three-dimensional spatial position of first object 614, three-dimensional spatial position of second object 662 from three-dimensional spatial position of second object 616, and three-dimensional spatial position of third object 664 from three-dimensional spatial position of third object 618. Visual element generation module 620 can generate one or more visual elements representing a subset of one or more task identifiers, wherein each visual element is positioned relative to the three-dimensional spatial position of a corresponding object. Visual element generation module 620 can calculate positions for visual elements by applying offsets to the object positions using vector addition: visual element position=object position+offset vector. Visual element generation module 620 can apply horizontal offsets of 10-30 centimeters to position visual elements adjacent to physical objects without occluding the objects, selecting offset magnitudes based on object size and scene density. Visual element generation module 620 can apply vertical offsets when horizontal space is limited or when multiple visual elements overlap, using collision detection algorithms to identify potential overlaps.

Referring to FIG. 6B, visual element generation module 620 can transmit first visual element 666 to first visual element 622, second visual element 668 to second visual element 624, and third visual element 670 to third visual element 626. In some embodiments, visual element generation module 620 may adjust offset distances based on scene density by analyzing the number of objects within a spatial region and increasing offsets when object density is high to prevent visual clutter. In some embodiments, visual element generation module 620 may increase offsets when multiple objects are close together to prevent visual element overlap, using spatial clustering algorithms to identify dense object groups. In some embodiments, visual element generation module 620 may decrease offsets when objects are isolated to minimize the distance between objects and their associated task identifier indicators, improving visual association. In some embodiments, visual element generation module 620 may adjust offset directions based on available space in the scene by analyzing free space around objects and selecting offset directions that maximize distance from other objects and visual elements.

First visual element 622 can receive first visual element 666 from visual element generation module 620. First visual element 622 can include a visual representation of task identifiers associated with first physical object 604. First visual element 622 can correspond to presentation of the one or more task identifiers 150 transmitted from presentation module 118 to display device 120 in FIG. 1 for first physical object 604. First visual element 622 can include task identifier buttons, icons, or text labels such as “Increase speed,” “Turn off,” or “Set timer” for a ceiling fan. First visual element 622 can be positioned at coordinates offset from first physical object 604 such as 20 centimeters to the right, calculated as (x: 1.2 m+0.2 m, y: 0.3 m, z: 2.5 m)=(x: 1.4 m, y: 0.3 m, z: 2.5 m). First visual element 622 can be positioned at the same depth as first physical object 604 at 2.5 meters from camera viewpoint 602, ensuring depth matching. First visual element 622 can transmit visual elements 672 to augmented reality rendering module 628.

Second visual element 624 can receive second visual element 668 from visual element generation module 620. Second visual element 624 can include a visual representation of task identifiers associated with second physical object 606. Second visual element 624 can correspond to presentation of the one or more task identifiers 150 transmitted from presentation module 118 to display device 120 in FIG. 1 for second physical object 606. Second visual element 624 can include task identifier buttons, icons, or text labels such as “Turn on,” “Turn off,” or “Dim” for a light switch. Second visual element 624 can be positioned at coordinates offset from second physical object 606 such as 15 centimeters to the right, calculated as (x: 2.0 m+ 0.15 m, y: 0.0 m, z: 3.0 m) =(x: 2.15 m, y: 0.0 m, z: 3.0 m). Second visual element 624 can be positioned at the same depth as second physical object 606 at 3.0 meters from camera viewpoint 602. Second visual element 624 can transmit visual elements 672 to augmented reality rendering module 628.

Third visual element 626 can receive third visual element 670 from visual element generation module 620. Third visual element 626 can include a visual representation of task identifiers associated with third physical object 608. Third visual element 626 can correspond to presentation of the one or more task identifiers 150 transmitted from presentation module 118 to display device 120 in FIG. 1 for third physical object 608. Third visual element 626 can include task identifier buttons, icons, or text labels such as “Increase temp,” “Decrease temp,” or “Set to 70° F.” for a thermostat. Third visual element 626 can be positioned at coordinates offset from third physical object 608 such as 20 centimeters to the right, calculated as (x: 1.5 m+0.2 m, y: −0.2 m, z: 2.8 m) =(x: 1.7 m, y: −0.2 m, z: 2.8 m). Third visual element 626 can be positioned at the same depth as third physical object 608 at 2.8 meters from camera viewpoint 602. Third visual element 626 can transmit visual elements 672 to augmented reality rendering module 628.

Augmented reality rendering module 628 can receive visual elements 672 from first visual element 622, second visual element 624, and third visual element 626. Augmented reality rendering module 628 can cause rendering of the one or more visual elements in an augmented reality display at a depth matching the object. Augmented reality rendering module 628 can use the three-dimensional spatial position data to render each visual element at the same focal distance as its corresponding physical object. Augmented reality rendering module 628 can apply depth-matched rendering by calculating rendering parameters such as binocular disparity (horizontal offset between left-eye and right-eye images to create stereoscopic depth perception), vergence angle (angle at which eyes converge to focus on objects at specific depths), and accommodation distance (focal distance at which lenses may need to adjust for sharp focus). Augmented reality rendering module 628 can generate stereoscopic image pairs for left and right eyes with appropriate horizontal disparities calculated using the formula: disparity=(baseline×focal length)/depth, where baseline is the inter-pupillary distance (typically 63 mm), focal length is the display optical system focal length, and depth is the z-coordinate of the visual element. Augmented reality rendering module 628 can ensure that visual elements appear at the correct depth, reducing vergence-accommodation conflict (the mismatch between vergence distance and accommodation distance that causes visual discomfort in conventional displays). Augmented reality rendering module 628 can create seamless integration between physical objects and virtual task identifier indicators by matching depth cues. Augmented reality rendering module 628 can render visual elements with appropriate perspective by applying perspective projection transformations that scale visual elements based on their distance from camera viewpoint 602, making distant elements appear smaller. Augmented reality rendering module 628 can apply scaling based on their three-dimensional positions using the formula: apparent size=actual size/depth. Augmented reality rendering module 628 can handle occlusion by comparing depth values of visual elements with depth values of physical objects, rendering visual elements behind closer physical objects to maintain spatial consistency. Augmented reality rendering module 628 can transmit rendering at depth matching the object 674 to augmented reality display 630. In some embodiments, augmented reality rendering module 628 may apply occlusion handling to ensure that visual elements are occluded by physical objects that are closer to camera viewpoint 602 by performing depth testing where each pixel's depth is compared against the depth buffer containing physical object depths, and pixels of visual elements are only rendered if their depth is greater than (farther than) the corresponding physical object depth. In some embodiments, augmented reality rendering module 628 may render visual elements with semi-transparency (alpha values ranging from 0.5 to 0.9) to allow users to see physical objects behind the visual elements, using alpha blending operations that combine visual element colors with background colors according to the formula: final color=(alpha×element color)+((1−alpha)×background color). In some embodiments, augmented reality rendering module 628 may adjust visual element brightness or contrast based on background scene characteristics to ensure visibility by analyzing background luminance values and increasing visual element brightness when backgrounds are dark or decreasing brightness when backgrounds are bright, maintaining contrast ratios of at least 4.5:1 for readability.

Augmented reality display 630 can receive rendering at depth matching the object 674 from augmented reality rendering module 628. Augmented reality display 630 can correspond to display device 120 from FIG. 1 when display device 120 includes augmented reality display capabilities. Augmented reality display 630 can include a head-mounted display, smart glasses, or other augmented reality display device that combines real-world views with computer-generated imagery. Augmented reality display 630 can include optical systems such as waveguides, holographic optical elements, or beam splitters that overlay virtual content onto real-world views. Augmented reality display 630 can present a composite view showing physical objects from the real world overlaid with virtual visual elements. Augmented reality display 630 can display first visual element 622 at the same focal distance as first physical object 604, ensuring that when a user focuses on the ceiling fan, the task identifier buttons appear sharp and at the correct depth without requiring eye refocusing. Augmented reality display 630 can display second visual element 624 at the same focal distance as second physical object 606. Augmented reality display 630 can display third visual element 626 at the same focal distance as third physical object 608. Augmented reality display 630 can enable users to perceive visual elements as spatially anchored to physical objects in the environment, creating the illusion that task identifier indicators exist as physical objects in three-dimensional space. In some embodiments, augmented reality display 630 may provide depth cues through stereoscopic rendering, where slightly different images are presented to each eye to create depth perception through binocular disparity, with horizontal offsets between left-eye and right-eye images calculated based on object depths and inter-pupillary distance. In some embodiments, augmented reality display 630 may use varifocal or multifocal display technology to present visual elements at correct focal distances matching their depth positions by dynamically adjusting optical element positions or using multiple focal planes at different depths (such as 0.5 m, 1.0 m, 2.0 m, and infinity), selecting the focal plane closest to each visual element's depth for rendering. In some embodiments, augmented reality display 630 may provide motion parallax cues as the user moves, where visual elements maintain their spatial positions relative to physical objects by updating visual element screen positions based on camera viewpoint 602 movement, creating the perception that visual elements are fixed in three-dimensional space as the user's head moves.

Display device 120 from FIG. 1 can perform the process flow in FIGS. 6A and 6B as follows. Camera viewpoint 602 can transmit camera pose data 650 to spatial position determination module 612. Depth sensor 610 can capture depth information and can transmit depth data 652 to spatial position determination module 612. Spatial position determination module 612 can use camera pose data 650 to establish the reference frame and can calculate three-dimensional coordinates and can transmit three-dimensional spatial position of first object 654 to three-dimensional spatial position of first object 614, three-dimensional spatial position of second object 656 to three-dimensional spatial position of second object 616, and three-dimensional spatial position of third object 658 to three-dimensional spatial position of third object 618. Three-dimensional spatial position of first object 614 can transmit three-dimensional spatial position of first object 660 to visual element generation module 620. Three-dimensional spatial position of second object 616 can transmit three-dimensional spatial position of second object 662 to visual element generation module 620. Three-dimensional spatial position of third object 618 can transmit three-dimensional spatial position of third object 664 to visual element generation module 620. Visual element generation module 620 can calculate visual element positions with offsets and can transmit first visual element 666 to first visual element 622, second visual element 668 to second visual element 624, and third visual element 670 to third visual element 626. First visual element 622, second visual element 624, and third visual element 626 can transmit visual elements 672 to augmented reality rendering module 628. Augmented reality rendering module 628 can perform depth-matched rendering with stereoscopic projection and can transmit rendering at depth matching the object 674 to augmented reality display 630. Augmented reality display 630 can present the composite view with depth-matched visual elements overlaid on physical objects.

The process 600 can address the technical problem of visual search time and vergence-accommodation conflict in conventional screen-based interfaces by positioning task identifier indicators directly adjacent to physical objects at matching depths. Conventional interfaces require users to shift attention between physical objects in the environment and separate control displays (such as smartphone screens or wall-mounted tablets), imposing visual search costs and requiring eye refocusing between different depths. The depth-matched rendering in process 600 can reduce these costs by ensuring that task identifier indicators appear at the same depth as their associated objects, allowing users to view objects and controls simultaneously without refocusing. The spatial anchoring can create intuitive associations between objects and controls, reducing cognitive load compared to conventional interfaces where users may need to remember which screen elements correspond to which physical objects.

FIGS. 1-6B illustrate a system for attention-driven task generation using vision-language models. FIG. 1 shows the overall system architecture that can reduce predetermined navigation hierarchies through direct visual scene understanding and attention-based task identifier generation. FIG. 2 details the attention signal encoding mechanism that can enable vision-language models to identify attended objects without requiring specialized training. FIG. 3 illustrates the contextual ranking system that can prioritize task identifiers based on environmental conditions, user history, urgency, and efficiency. FIG. 4 shows the event-driven presentation system that can balance urgency assessment with focus preservation. FIG. 5 demonstrates the input-adaptive presentation system that can adjust task identifier count and interaction methods based on user input capabilities, enabling users with severely limited input modalities (binary, scalar, or gaze-based control) to achieve efficient task completion. FIGS. 6A and 6B illustrate the augmented reality spatial positioning system that can create seamless integration between physical objects and virtual task identifier indicators through depth-matched rendering.

The disclosed system can overcome the limitations of conventional assistive interfaces by, for example: (1) eliminating multi-step navigation sequences through direct attention-based task identifier generation, (2) providing contextual awareness that filters task identifiers based on environmental conditions and user preferences, (3) adapting presentation and interaction methods to user input capabilities, (4) learning user preferences over time to improve task identifier prediction accuracy, (5) balancing proactive event notifications with focus preservation, (6) leveraging visual understanding to identify controllable objects without predetermined mappings, (7) enabling coordinated multi-device control through semantic understanding of functional relationships, and (8) creating intuitive spatial interfaces through depth-matched augmented reality rendering. The system can employ vision-language models for visual scene understanding, language models for task identifier generation and reasoning, contextual information aggregation for intelligent ranking, user history analysis for personalization, and input-capability-aware presentation for accessibility, providing a comprehensive solution to the challenges faced by users with severe motor impairments in interacting with computing devices and smart environments.

### Inference and Training Logic

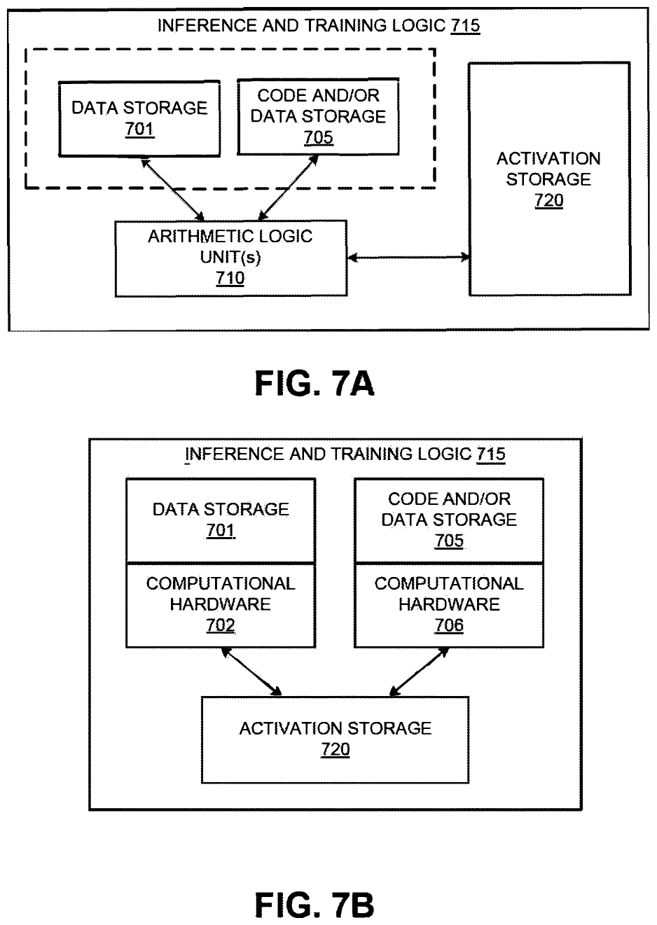

FIG. 7A illustrates inference and/or training logic 715 used to perform inferencing and/or training operations associated with one or more embodiments. In some embodiments, the inference operations are performed, for example, by vision-language model 110 and/or language model 112 from FIG. 1. In some embodiments, training operations may be performed on vision-language models, language models, or other artificial intelligence or machine learning models used for attention-driven task generation, visual scene understanding, object identification, task ranking, or other operations described herein with respect to FIGS. 1-6B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating-point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and/or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may be used in conjunction with vision-language model 110, language model 112, task ranking module 116, or other components from FIG. 1 to perform hardware-accelerated visual scene understanding, object identification, task generation, contextual ranking, and other operations described herein with respect to FIGS. 1-6B. In some embodiments, training operations may be performed on vision-language models, language models, or other machine learning models using image data, attention signal data, contextual information, user history data, and/or other data types described herein with respect to FIGS. 1-6B. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

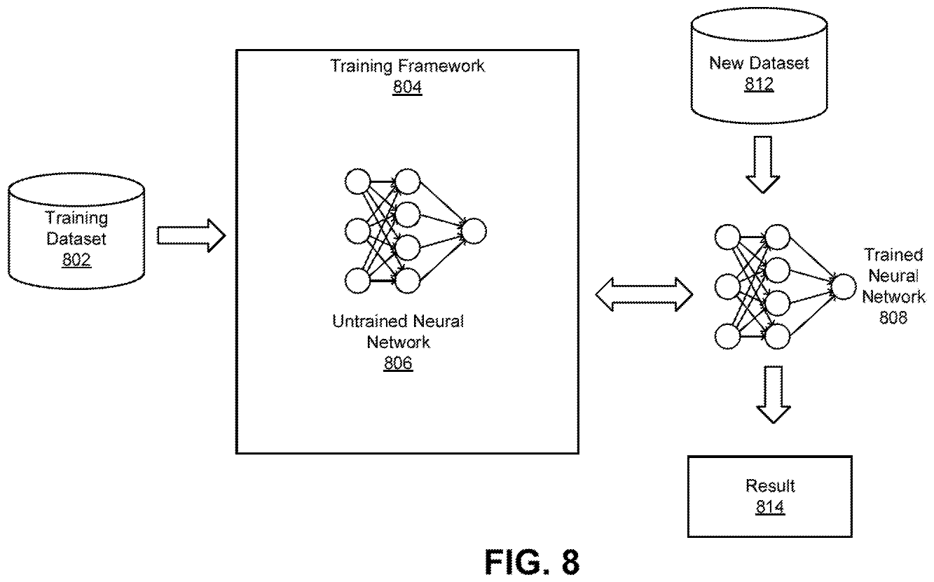

FIG. 8 illustrates training and deployment of a deep neural network, according to at least one embodiment. In at least one embodiment, the training framework 804 and neural network training process illustrated in FIG. 8 may be applied to train or retrain vision-language model 110, language model 112, or other machine learning models used for attention-driven task generation as described herein with respect to FIGS. 1-6B. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations including visual scene understanding, object identification at attention locations, task generation based on identified objects and contextual information, or other operations described herein with respect to FIGS. 1-6B.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

### Processing and Inferencing Pipeline Deployment

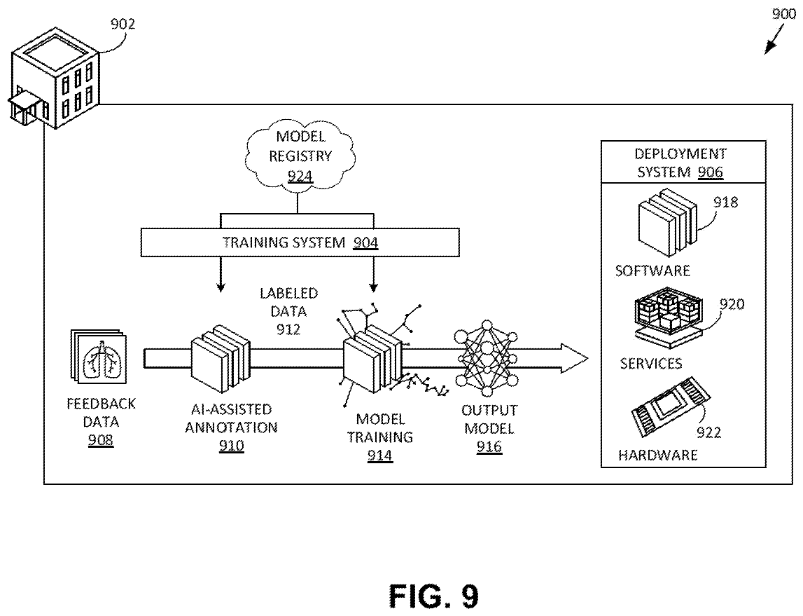

With reference to FIG. 9, FIG. 9 is an example data flow diagram for a process 900 of generating and deploying a processing and inferencing pipeline, according to at least one embodiment. In at least one embodiment, the process 900 may be deployed to implement the attention-driven task generation system 100 from FIG. 1, including vision-language model 110, language model 112, task ranking module 116, presentation module 118, and/or other components for visual scene understanding, contextual task generation, and adaptive presentation at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in processing and inferencing pipelines may use machine learning models or other AI to perform one or more processing steps. In at least one embodiment, machine learning models may be trained at facility 902 using feedback data 908 (such as image data from image capture devices, attention signal data from eye tracking systems, environmental sensor data, user interaction data, or other data types described herein with respect to FIGS. 1-6B) stored at facility 902 or feedback data 908 from another facility or facilities, or a combination thereof. In at least one embodiment, training system 904 may be used to provide applications, services, and/or other resources for generating working, deployable machine learning models for deployment system 906.

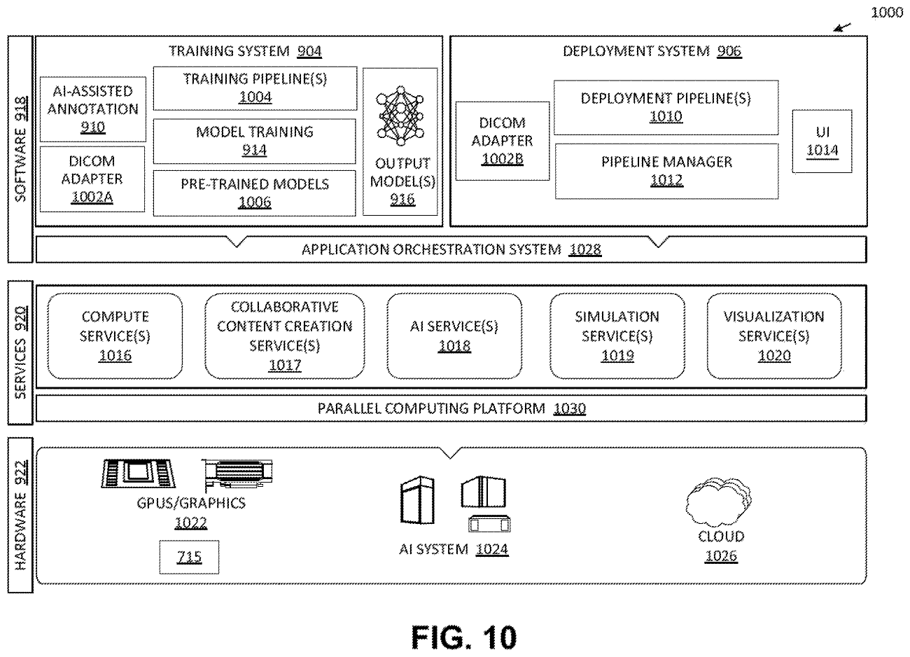

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model or has an existing machine learning model that needs to be optimized or updated. In at least one embodiment, feedback data 908 may be received from various channels, such as user interaction logs from assistive technology systems, image capture devices, attention signal generators, environmental sensors, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., identifying objects in visual scenes, marking attention locations, categorizing user tasks) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on image data, attention signal data, contextual information, or other data types described herein with respect to FIGS. 1-6B. In at least one embodiment, machine learning models in model registry 924 may have been trained on image data, attention signal data, environmental sensor data, user interaction data, or other feedback data 908 from different facilities than facility 902 (e.g., facilities that are remotely located). In at least one embodiment, machine learning models may have been trained on image data, attention signal data, or other feedback data 908 from one location, two locations, or any number of locations. In at least one embodiment, when being trained on image data, attention signal data, or other forms of feedback data 908, from a specific location, training may take place at that location, or at least in a manner that protects confidentiality of image data, attention signal data, user interaction data or restricts such data from being transferred off-premises (e.g., to comply with privacy regulations for assistive technology users, data protection requirements, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in user populations, device types, environmental conditions, interaction patterns, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in a processing and inferencing pipeline (e.g., visual scene understanding, object identification, attention signal processing, task generation, contextual ranking, adaptive presentation, etc.). In at least one embodiment, for each type of computing device there may be any number of containers that may perform a data processing task with respect to feedback data 908 (or other data types, such as those described herein). In at least one embodiment, a processing and inferencing pipeline may be defined based on selections of different containers that are desired or required for processing feedback data 908, in addition to containers that receive and configure image data, attention signal data, environmental sensor data, or other input data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of a data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request or as presentation of task identifiers via display device 120 from FIG. 1). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., architecture 1000 of FIG. 10). In at least one embodiment, once validated by architecture 1000 (e.g., for accuracy, etc.), an application may be available in a container registry for selection and/or embodiment by a user (e.g., an assistive technology provider, healthcare facility, research institution, etc.) to perform one or more processing tasks with respect to data at a facility (e.g., a second facility) of a user.

In at least one embodiment, developers may then share applications or containers through a network for access and use by users of a system (e.g., architecture 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for presentation via display device 120, for storage in user history storage 124, for transmission to device control interface 122 as commands, or for other uses described herein with respect to FIGS. 1-6B).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing object detection, visual scene understanding, task generation, or contextual ranking tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for object identification at attention locations, task generation based on contextual information, or adaptive presentation based on input modality may be executed by calling upon (e.g., as an API call) an inference service (e.g., an inference server) to execute machine learning model(s), or processing thereof, as part of application execution. In at least one embodiment, where another application includes one or more machine learning models for visual scene understanding, attention signal encoding, or contextual ranking tasks, an application may call upon an inference service to execute machine learning models for performing one or more of processing operations associated with such tasks. In at least one embodiment, software 918 implementing processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of visual scene understanding, object identification, task generation, and adaptive presentation operations.

In at least one embodiment, software 918 and/or services 920 may be optimized for GPU processing with respect to deep learning, machine learning, and/or high-performance computing, visual scene analysis, attention signal processing, and visual computing, as non-limiting examples. In at least one embodiment, at least some of the computing environment of deployment system 906 and/or training system 904 may be executed in a datacenter or one or more supercomputers or high-performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

### Deployment Pipeline Architecture

FIG. 10 is a system diagram for an example architecture 1000 for generating and deploying a deployment pipeline, according to at least one embodiment. In at least one embodiment, architecture 1000 may be used to implement process 900 of FIG. 9 and/or other processes including processing and inferencing pipelines. In at least one embodiment, architecture 1000 may include training system 904 and deployment system 906. In at least one embodiment, training system 904 and deployment system 906 may be implemented using software 918, services 920, and/or hardware 922, as described herein. In at least one embodiment, the architecture 1000 may be used to deploy the attention-driven task generation system 100 from FIG. 1, including training system 904 for vision-language model 110, language model 112, and/or other machine learning models, and deployment system 906 for executing the visual scene understanding, task generation, contextual ranking, and adaptive presentation pipeline described herein with respect to FIGS. 1-6B.

In at least one embodiment, architecture 1000 (e.g., training system 904 and/or deployment system 906) may be implemented in a cloud computing environment (e.g., using cloud 1026). In at least one embodiment, architecture 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of architecture 1000, may be restricted to a set of public internet service providers (ISPs) that have been vetted or authorized for interaction.

In at least one embodiment, various components of architecture 1000 may communicate between and among one another using any of a variety of different network types, including but not limited to local area networks (LANs) and/or wide area networks (WANs) via wired and/or wireless communication protocols. In at least one embodiment, communication between facilities and components of architecture 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model such as vision-language model 110, training pipeline 1004, similar to a second example described with respect to FIG. 9, may be used for a second machine learning model such as language model 112, and training pipeline 1004, similar to a third example described with respect to FIG. 9, may be used for a third machine learning model such as a model for contextual ranking or pattern identification in user history data. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904 and may be implemented by deployment system 906.

In at least one embodiment, output model(s) 916 and/or pre-trained model(s) 1006 may include any types of machine learning models depending on embodiment. In at least one embodiment, and without limitation, machine learning models used by architecture 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, transformer architectures, vision transformers, multimodal transformers, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, architecture 1000 may include a multi-layer platform that may include a software layer (e.g., software 918) of assistive technology applications, task generation applications, or other application types that may perform one or more visual scene understanding, object identification, task generation, contextual ranking, or adaptive presentation functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common visual processing operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and interact with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904. In at least one embodiment, training system 904 and deployment system 906 may include DICOM adapters 1002A and 1002B or other data adapters suitable for processing image data, attention signal data, environmental sensor data, or user interaction data as described herein with respect to FIGS. 1-6B.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., an object identification application, a task generation application, a contextual ranking application, an adaptive presentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application for visual scene understanding and a second user or developer may develop, modify, and deploy a second application for task generation separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing for time-critical assistive technology tasks or event-driven task presentation), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute service(s) 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application such as image processing, attention signal encoding, visual scene understanding, task generation, and adaptive presentation or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as vision transformers, multimodal transformers, CNNs) for object identification, visual scene understanding, task generation, contextual ranking, pattern identification, and/or other inferencing tasks. In at least one embodiment, applications of deployment pipeline(s) 1010 may use one or more of output models 916 from training system 904 and/or other models of applications to perform inference on image data, attention signal data, environmental sensor data, user interaction data, or other data types described herein. In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests for time-critical assistive technology tasks, event-driven task presentation with high urgency scores, or real-time adaptive presentation requirements. In at least one embodiment, a second category may include a standard priority path that may be used for requests that may be non-urgent or where analysis may be performed at a later time such as pattern identification in user history data or model retraining tasks. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within architecture 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., an image from image capture device 102 showing a visual scene), or may require inference on hundreds of images (e.g., a sequence of images for continuous attention tracking or temporal pattern analysis). In at least one embodiment, an application may summarize results before completing, which may include, without limitation, generating task identifiers, calculating priority scores, determining input-adaptive presentation parameters, identifying functional relationships between devices, or generating coordinated control sequences. In at least one embodiment, different models or applications may be assigned different priorities. For example, some models may have a real-time (turnaround time less than one minute) priority for high-urgency event-driven task presentation while others may have lower priority (e.g., turnaround less than 10 minutes) for pattern identification in user history data or model retraining. In at least one embodiment, model execution times may be measured from requesting facility or assistive technology system and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D rendering of task identifiers, 3D spatial positioning of visual elements in augmented reality displays, depth-matched rendering at object focal distances, virtual reality displays, augmented reality displays, etc. In at least one embodiment, virtualized environments may be used to generate a virtual interactive display or environment (e.g., a virtual environment) for interaction by users of a system (e.g., users with severe motor impairments, assistive technology specialists, caregivers, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA® and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on image data, attention signal data, environmental sensor data (or other data types used by machine learning models), post-processing on outputs of machine learning models, and/or to perform inferencing (e.g., to execute machine learning models). In at least one embodiment, cloud 1026, AI system 1024, and/or other components of architecture 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of architecture 1000.

In at least one embodiment, cloud 1026 may include a GPU-accelerated infrastructure (e.g., NVIDIA's NGC™) that may provide a GPU-optimized platform for executing processing tasks of architecture 1000. In at least one embodiment, cloud 1026 may include an AI system(s) 1024 for performing one or more of AI-based tasks of architecture 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of architecture 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality visualizations for augmented reality displays, depth-matched rendering, or other visualization types described herein with respect to FIGS. 1-6B), and/or may provide other functionality for architecture 1000.

In at least one embodiment, in an effort to preserve user confidentiality (e.g., where user data including image data, attention signal data, interaction history, or other personal information are to be used off-premises), cloud 1026 may include a registry, such as a deep learning container registry. In at least one embodiment, a registry may store containers for instantiations of applications that may perform pre-processing, post-processing, or other processing tasks on user data. In at least one embodiment, cloud 1026 may receive data that includes user data as well as sensor data in containers, perform requested processing for just sensor data in those containers, and then forward a resultant output and/or visualizations to appropriate parties and/or devices (e.g., on-premises assistive technology devices, display devices 120, augmented reality displays used for visualization or task presentation), all without having to extract, store, or otherwise access user data. In at least one embodiment, confidentiality of user data is preserved in compliance with privacy regulations for assistive technology users, data protection requirements, and/or other data regulations.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented within the system 100 from FIG. 1 to process visual scenes with encoded attention signals, generate task identifiers based on object identifiers and contextual information, determine functional relationships between devices, or perform other language understanding and generation tasks described herein with respect to FIGS. 1-6B. These models, such as vision-language model 110 and language model 112 from FIG. 1, may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/embodiment. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/embodiment.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to device control capabilities or smart home device states, the model may access one or more device control or smart home plug-ins (e.g., via one or more APIs) to retrieve the relevant information. As another example, where at least part of a response requires a mathematical computation such as calculating priority scores, determining urgency scores, or computing contextual relevance values, the model may access one or more math plug-ins or APIs for help in solving the problem(s) and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g., updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material may need to be included in a curated dataset, for example and without limitation.

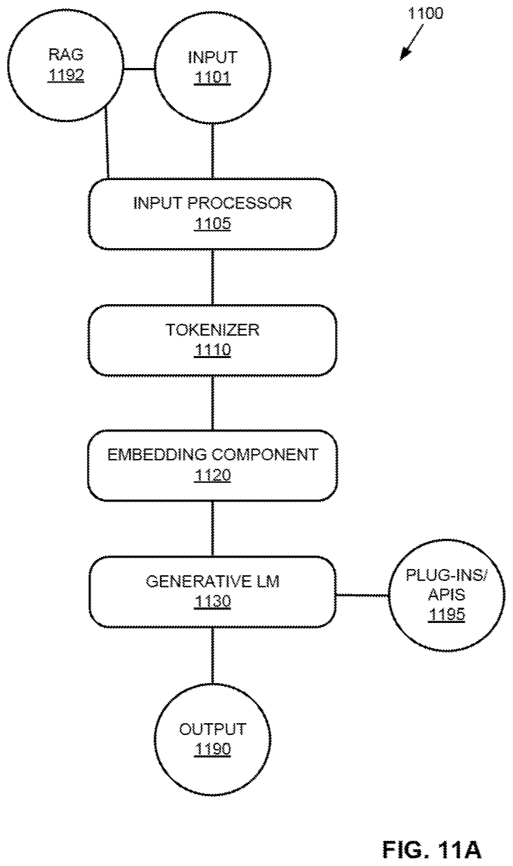

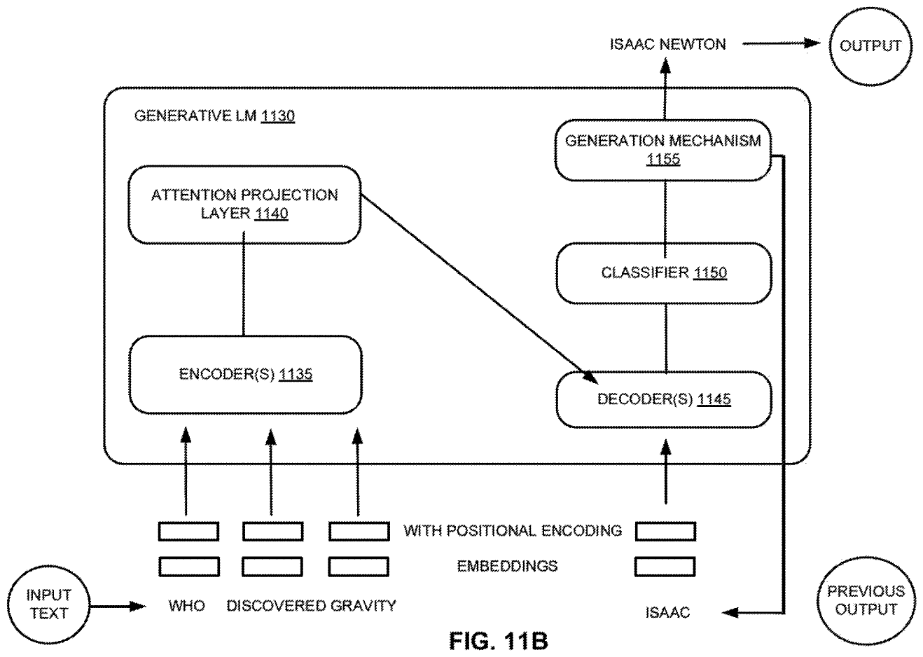

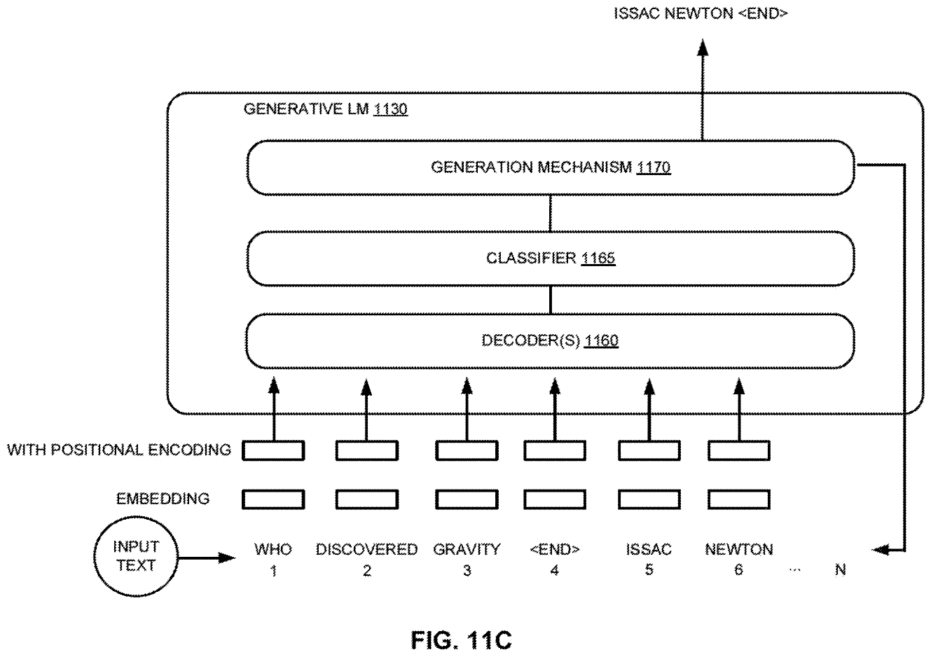

FIG. 11A is a block diagram of an example generative language model system 1100 suitable for use in implementing at least some embodiments of the present disclosure. In the example illustrated in FIG. 11A, the generative language model system 1100 includes a retrieval augmented generation (RAG) component 1192, an input processor 1105, a tokenizer 1110, an embedding component 1120, plug-ins/APIs 1195, and a generative language model (LM) 1130 (which may include an LLM, a SLM, a VLM, a multi-modal LM, etc.). In at least one embodiment, the generative language model system 1100 illustrated in FIG. 11A may be integrated with the system 100 from FIG. 1 to process visual scenes with encoded attention signals (via vision-language model 110), generate task identifiers based on object identifiers and contextual information (via language model 112), determine functional relationships between devices for coordinated control, or perform other language understanding and generation tasks described herein with respect to FIGS. 1-6B.

At a high level, the input processor 1105 may receive an input 1101 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 1130 (e.g., LLM/SLM/VLM/MMLM/etc.). In some embodiments, the input 1101 includes plain text in the form of one or more sentences, paragraphs, and/or documents. Additionally or alternatively, the input 1101 may include numerical sequences, precomputed embeddings (e.g., word or sentence embeddings), and/or structured data (e.g., in tabular formats, JSON, or XML). In some embodiments in which the generative LM 1130 is capable of processing multi-modal inputs, the input 1101 may combine text (or may omit text) with image data, audio data, video data, design data, USD data, and/or other types of input data, such as but not limited to those described herein. Taking raw input text as an example, the input processor 1105 may prepare raw input text in various ways. For example, the input processor 1105 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1105 may remove stopwords to reduce noise and focus the generative LM 1130 on more meaningful content. The input processor 1105 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1192 (which may include one or more RAG models, and/or may be performed using the generative LM 1130 itself) may be used to retrieve additional information to be used as part of the input 1101 or prompt. RAG may be used to enhance the input to the LLM/SLM/VLM/MMLM/etc. with external knowledge, so that answers to specific questions or queries or requests are more relevant—such as in a case where specific knowledge is required. The RAG component 1192 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 1101 may be generated using the query or input to the model (e.g., a question, a request, etc.) in addition to data retrieved using the RAG component 1192. In some embodiments, the input processor 1105 may analyze the input 1101 and communicate with the RAG component 1192 (or the RAG component 1192 may be part of the input processor 1105, in embodiments) in order to identify relevant text and/or other data to provide to the generative LM 1130 as additional context or sources of information from which to identify the response, answer, or output 1190, generally. For example, where the input indicates that the user is directing attention toward a ceiling fan and contextual information indicates high outdoor temperature, the RAG component 1192 may retrieve—using a RAG model performing a vector search in an embedding space, for example—device control information, user preference patterns, or contextual task suggestions from a digital (embedded) version of user history storage 124 or device control interface 122 from FIG. 1. Similarly, where a user has previously interacted with the system for similar tasks, the RAG component 1192 may retrieve a prior stored interaction history—or at least a summary thereof—and include the prior interaction data along with the current object identifier and contextual information as part of the input 1101 to the generative LM 1130.

The RAG component 1192 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1192 and the embeddings of the chunks along with the embeddings of the query may be compared to identify the most similar/related embeddings to the query, which may be supplied to the generative LM 1130 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1192 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embedding models.

The tokenizer 1110 may segment the (e.g., processed) text data into smaller units (tokens) for subsequent analysis and processing. The tokens may represent individual words, subwords, characters, portions of audio/video/image/etc., depending on the embodiment. Word-based tokenization divides the text into individual words, treating each word as a separate token. Subword tokenization breaks down words into smaller meaningful units (e.g., prefixes, suffixes, stems), enabling the generative LM 1130 to understand morphological variations and handle out-of-vocabulary words more effectively. Character-based tokenization represents each character as a separate token, enabling the generative LM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format according to a tokenization schema being implemented in the particular embodiment.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some embodiments in which the input 1101 includes image data/video data/etc., the input processor 1101 may resize the data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some embodiments in which the input 1101 includes audio data, the input processor 1101 may resample an audio file to a consistent sampling rate for uniform processing, and the embedding component 1120 may use any known technique to extract and encode audio features—such as in the form of a spectrogram (e.g., a mel-spectrogram). In some embodiments in which the input 1101 includes video data, the input processor 1101 may extract frames or apply resizing to extracted frames, and the embedding component 1120 may extract features such as optical flow embeddings or video embeddings and/or may encode temporal information or sequences of frames. In some embodiments in which the input 1101 includes multi-modal data, the embedding component 1120 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1130 and/or other components of the generative LM system 1100 may use different types of neural network architectures depending on the embodiment. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the embodiment and architecture, the embedding component 1120 may apply an encoded representation of the input 1101 to the generative LM 1130, and the generative LM 1130 may process the encoded representation of the input 1101 to generate an output 1190, which may include responsive text and/or other types of data.

As described herein, in some embodiments, the generative LM 1130 may be configured to access or use- or capable of accessing or using—plug-ins/APIs 1195 (which may include one or more plug-ins, application programming interfaces (APIs), databases, data stores, repositories, etc.). For example, for certain tasks or operations that the generative LM 1130 is not ideally suited for, the model may have instructions (e.g., as a result of training, and/or based on instructions in a given prompt, such as those retrieved using the RAG component 1192) to access one or more plug-ins/APIs 1195 (e.g., 3rd party plugins) for help in processing the current input. In such an example, where at least part of a prompt is related to device control capabilities or environmental conditions, the model may access one or more smart home device control or environmental sensor plug-ins (e.g., via one or more APIs), send at least a portion of the prompt related to the particular plug-in/API 1195 to the plug-in/API 1195, the plug-in/API 1195 may process the information and return an answer to the generative LM 1130, and the generative LM 1130 may use the response to generate the output 1190. This process may be repeated—e.g., recursively—for any number of iterations and using any number of plug-ins/APIs 1195 until an output 1190 that addresses each ask/question/request/process/operation/etc. from the input 1101 can be generated. As such, the model(s) may not only rely on its own knowledge from training on a large dataset(s) and/or from data retrieved using the RAG component 1192, but also on the expertise or optimized nature of one or more external resources-such as the plug-ins/APIs 1195.

FIG. 11B is a block diagram of an example embodiment in which the generative LM 1130 includes a transformer encoder-decoder. In at least one embodiment, the transformer encoder-decoder architecture illustrated in FIG. 11B may be implemented within vision-language model 110 and/or language model 112 from FIG. 1 to perform attention-based visual scene understanding, object identification at attention locations, task generation based on contextual information, or other operations described herein with respect to FIGS. 1-6B. For example, assume input text such as “ceiling fan currently at medium speed with outdoor temperature 89° F.” is tokenized (e.g., by the tokenizer 1110 of FIG. 11A) into tokens such as words, and each token is encoded (e.g., by the embedding component 1120 of FIG. 11A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1135 of the generative LM 1130.

In an example embodiment, the encoder(s) 1135 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1140 may convert the context vector into attention vectors (keys and values) for the decoder(s) 1145.

In an example embodiment, the decoder(s) 1145 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1135, in an example transformer architecture, each token (e.g., word) flows through a separate path in the decoder(s) 1145. During a first pass, the decoder(s) 1145, a classifier 1150, and a generation mechanism 1155 may generate a first token, and the generation mechanism 1155 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1145 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example embodiment, the encoder-decoder attention layer operates similarly to the (e.g., multi-headed) self-attention in the encoder(s) 1135, except that it creates its queries from the layer below it and takes the keys and values (e.g., matrix) from the output of the encoder(s) 1135.

As such, the decoder(s) 1145 may output some decoded (e.g., vector) representation of the input being applied during a particular pass. The classifier 1150 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1155 may select or sample a word or token based on a corresponding predicted probability (e.g., select the word with the highest predicted probability) and append it to the output from a previous pass, generating each word or token sequentially. The generation mechanism 1155 may repeat the process, triggering successive decoder inputs and corresponding predictions until selecting or sampling a symbol or token that represents the end of the response, at which point, the generation mechanism 1155 may output the generated response.

FIG. 11C is a block diagram of an example embodiment in which the generative LM 1130 includes a decoder-only transformer architecture. In at least one embodiment, the decoder-only transformer architecture illustrated in FIG. 11C may be utilized in language model 112 from FIG. 1 for generating task identifiers, determining functional relationships between devices, or processing contextual information to produce task suggestions as described herein with respect to FIGS. 1-6B. For example, the decoder(s) 1160 of FIG. 11C may operate similarly as the decoder(s) 1145 of FIG. 11B except each of the decoder(s) 1160 of FIG. 11C omits the encoder-decoder self-attention layer (since there is no encoder in this embodiment). As such, the decoder(s) 1160 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1160. As with the decoder(s) 1145 of FIG. 11B, each token (e.g., word) may flow through a separate path in the decoder(s) 1160, and the decoder(s) 1160, a classifier 1165, and a generation mechanism 1170 may use auto-regression to sequentially generate one token at a time until predicting a symbol or token that represents the end of the response. The classifier 1165 and the generation mechanism 1170 may operate similarly as the classifier 1150 and the generation mechanism 1155 of FIG. 11B, with the generation mechanism 1170 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

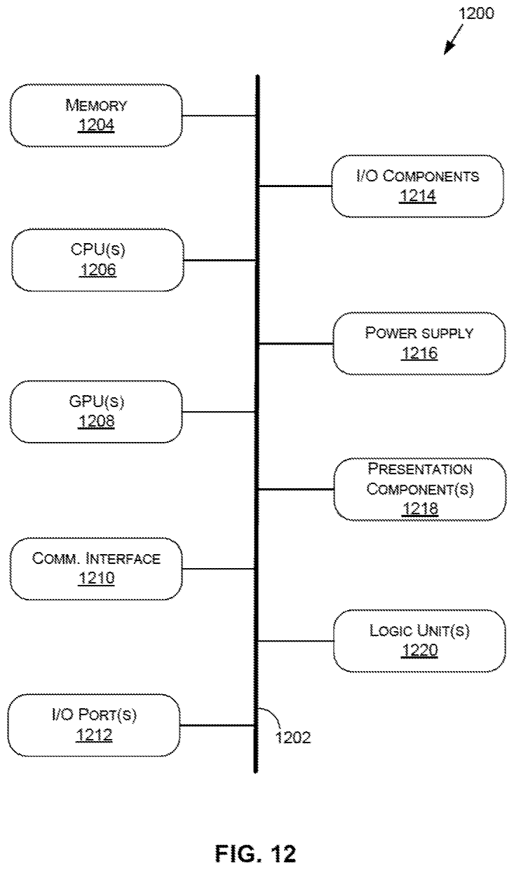

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof. In at least one embodiment, the computing device 1200 may serve as the hardware platform for executing the attention-driven task generation system 100 from FIG. 1, including image capture device 102, attention signal generator 104, environmental sensors 106, image processor 108, vision-language model 110, language model 112, contextual information module 114, task ranking module 116, presentation module 118, display device 120, device control interface 122, user history storage 124, and/or other components described herein with respect to FIGS. 1-6B.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). As such, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” “assistive technology device,” “head-mounted display,” “augmented reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics for augmented reality displays, depth-matched rendering, or other visualization described herein with respect to FIGS. 1-6B) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that allow the computing device 1200 to communicate with other computing devices via an electronic communication network, included wired and/or wireless communications. The communication interface 1210 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may allow the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that allow detection of motion. In some examples, the output of the accelerometers or gyroscopes may be used by the computing device 1200 to render immersive augmented reality or virtual reality such as depth-matched augmented reality rendering described herein with respect to FIGS. 6A and 6B.

The power supply 1216 may include a hard-wired power supply, a battery power supply, or a combination thereof. The power supply 1216 may provide power to the computing device 1200 to allow the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.). In at least one embodiment, presentation component(s) 1218 may include display device 120 from FIG. 1 for presenting task identifiers to users, augmented reality display 630 from FIG. 6B for depth-matched rendering of visual elements, or other display types described herein with respect to FIGS. 1-6B.

### Example Data Center

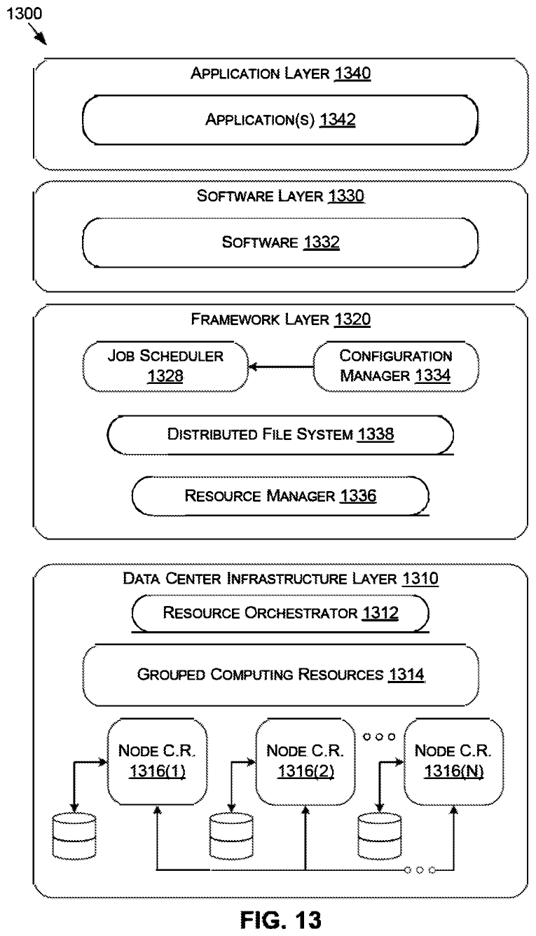

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340. In at least one embodiment, the data center 1300 may provide the computational infrastructure for training and/or deploying vision-language model 110, language model 112, or other machine learning models used for attention-driven task generation, visual scene understanding, object identification, task ranking, adaptive presentation, or other operations described herein with respect to FIGS. 1-6B.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-1316(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may use distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software including software for processing image data, attention signal data, environmental sensor data, user interaction data, or other data types described herein with respect to FIGS. 1-6B.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments such as applications for visual scene understanding, object identification at attention locations, task generation based on contextual information, contextual ranking, adaptive presentation based on input modality, or other applications described herein with respect to FIGS. 1-6B.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein including training techniques for vision-language models, language models, contextual ranking models, pattern identification models, or other models described herein with respect to FIGS. 1-6B.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services including visual scene understanding, object identification, task generation, contextual ranking, adaptive presentation, or other services described herein with respect to FIGS. 1-6B.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, an assistive technology device, a head-mounted display, an augmented reality device, a brain-computer interface device, an eye tracking device, any combination of these delineated devices, or any other suitable device.

The disclosure may be described in the general context of computer code or machine-usable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

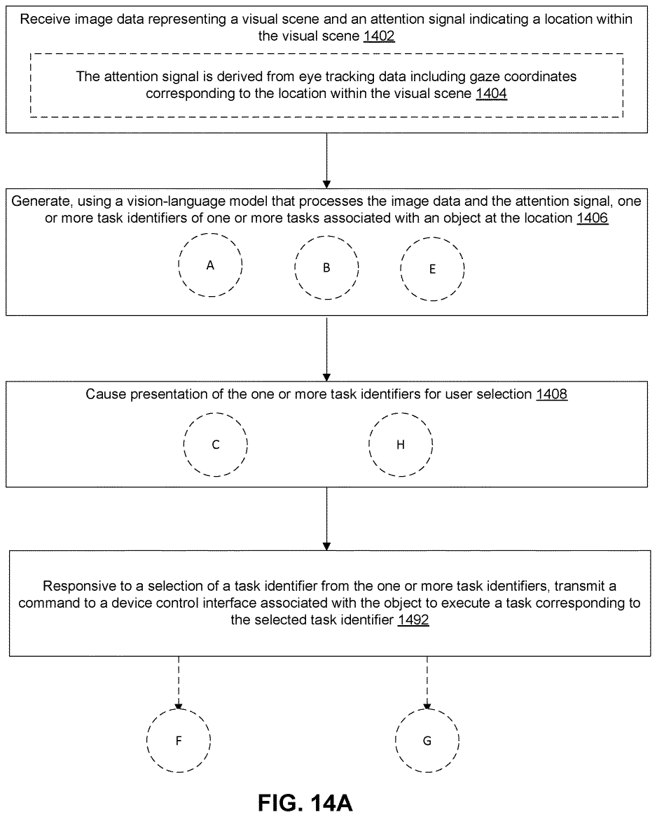

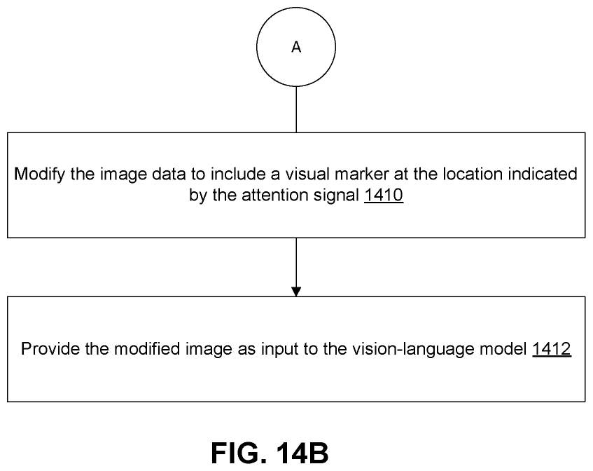

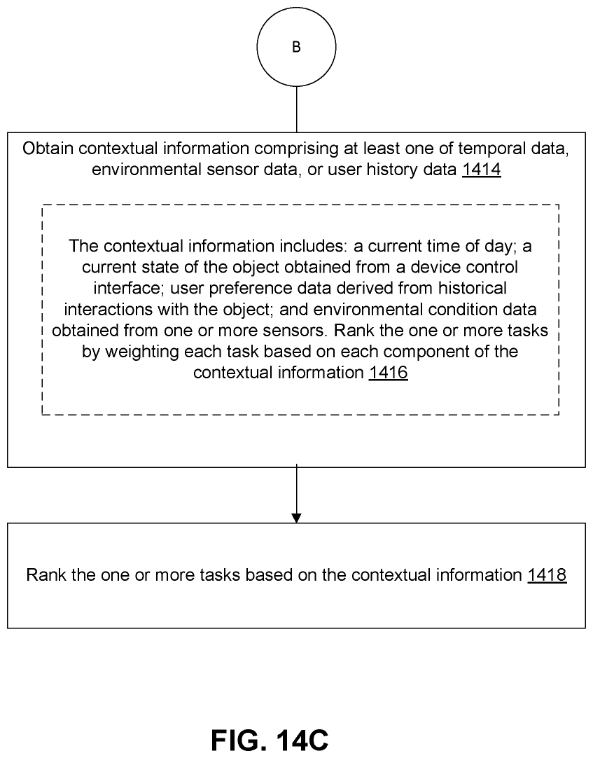

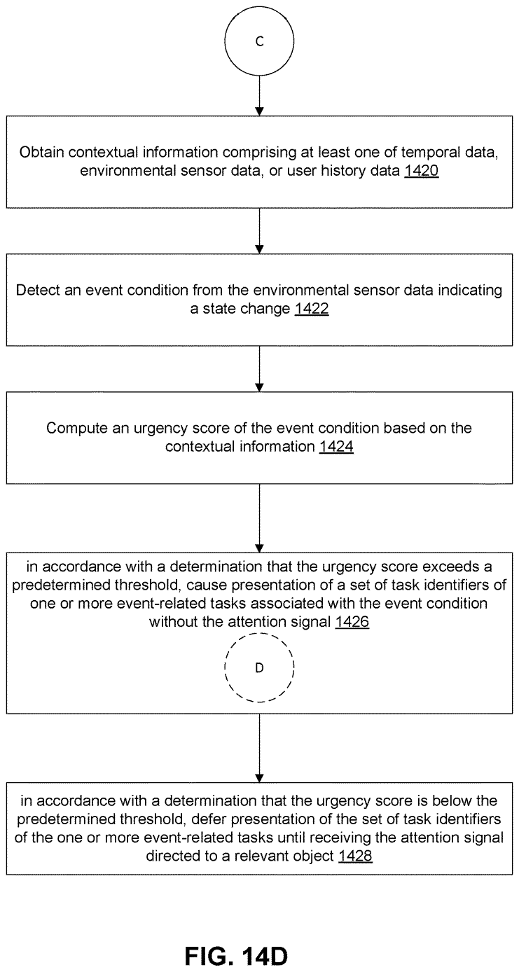

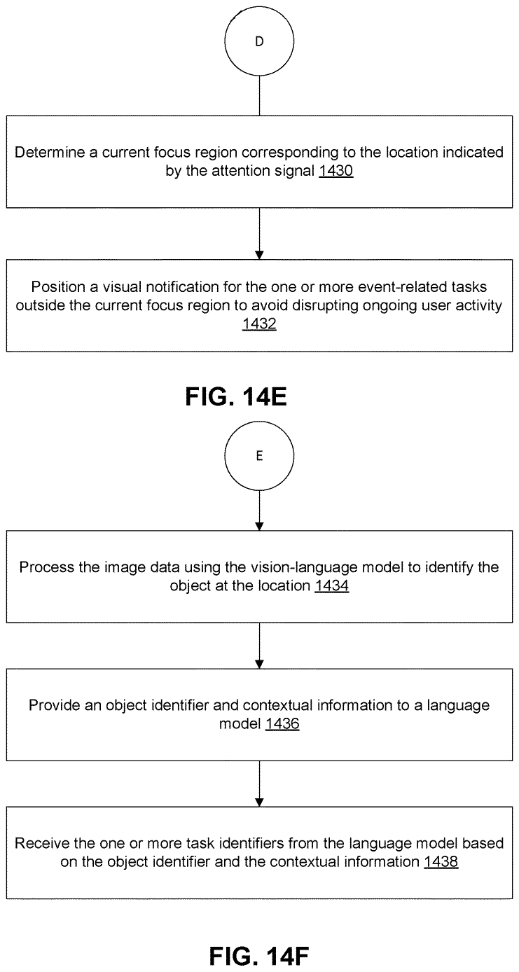

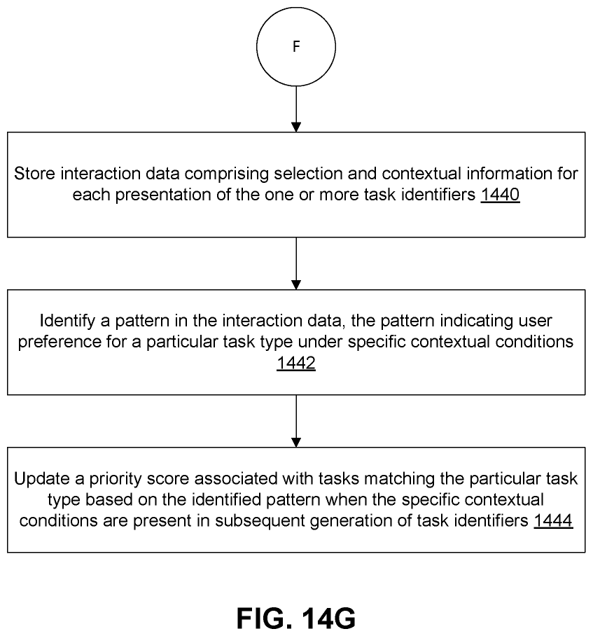

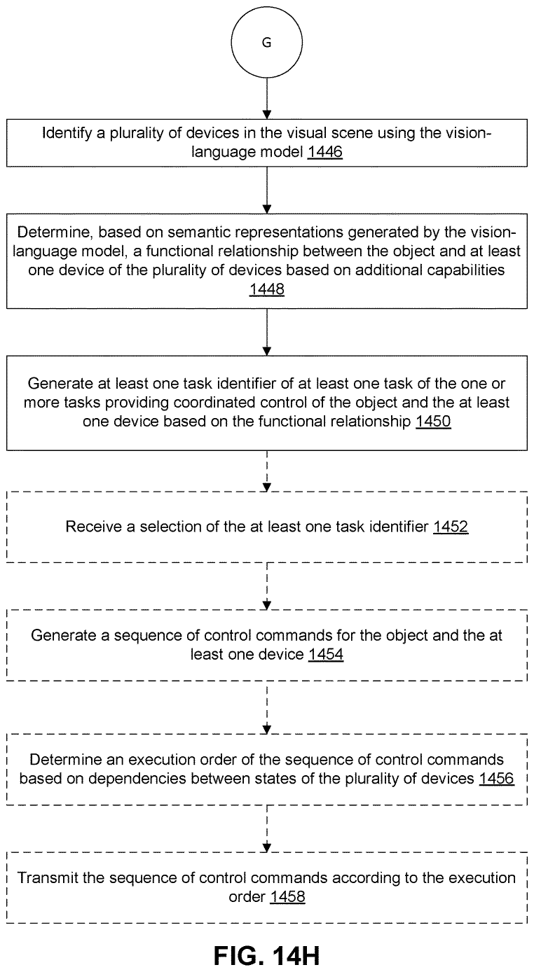

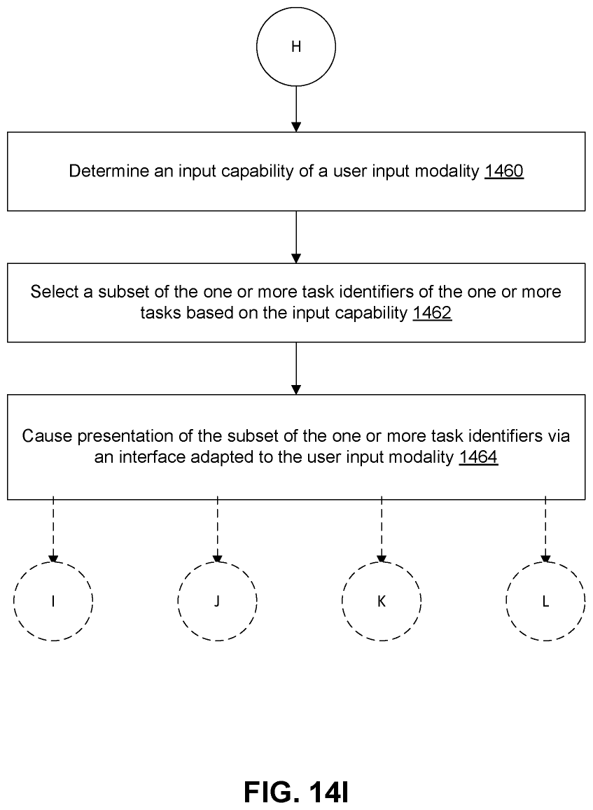

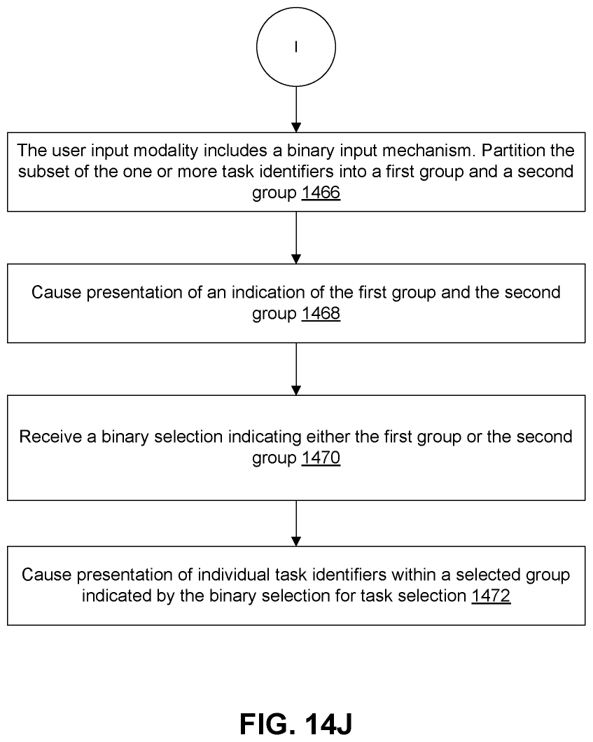

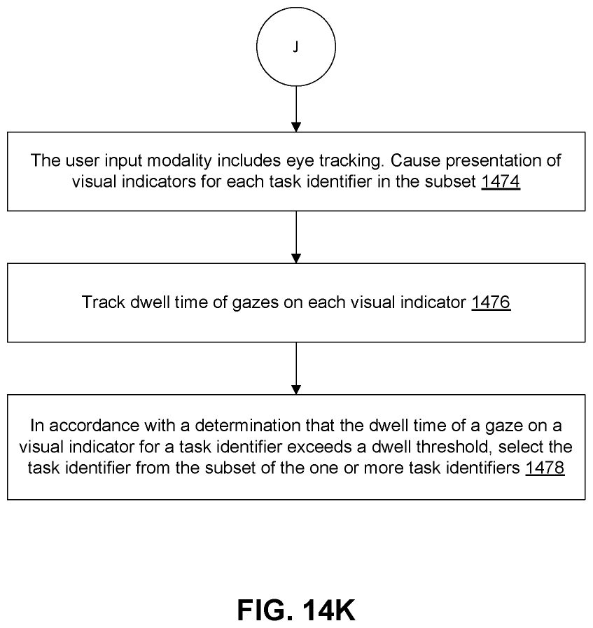

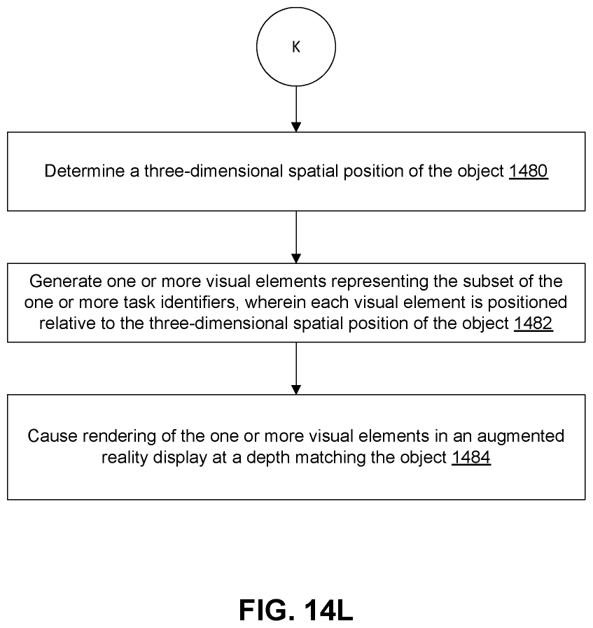

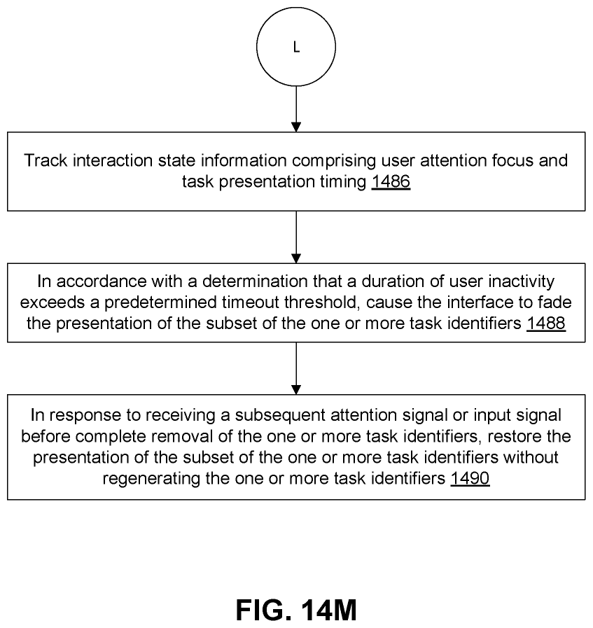

FIGS. 14A-14M show a flow diagram of an example method 1400 for attention-driven task generation and adaptive presentation using vision-language models, according to at least one embodiment. The method 1400 can be performed by processing logic that can include hardware (e.g., circuitry, dedicated logic, etc.), computer-readable instructions such as software or firmware (e.g., run on a general-purpose computing system or a dedicated machine), or a combination thereof. For instance, an example system can include a memory and a processing device coupled to the memory device to perform operations comprising the blocks of method 1400. The method 1400 can also be associated with a set of instructions stored on a non-transitory computer-readable medium (e.g., magnetic or optical disk, etc.). The instructions, when executed by a processing device, can cause the processing device to perform operations comprising the blocks of method 1400. In at least one embodiment, the method 1400 can be performed by processing logic that includes hardware and software components of system 100, particularly vision-language model 110, language model 112, and related components from FIG. 1. In at least one embodiment, method 1400 can be performed by the system 100 of FIG. 1, or components thereof. In at least one embodiment, the method 1400 can be performed by image processor 108, vision-language model 110, language model 112, contextual information module 114, task ranking module 116, presentation module 118, and/or other components illustrated in FIG. 1. In some embodiments, blocks depicted in FIGS. 14A-14M could be performed simultaneously or in a different order than depicted. Various embodiments can include additional blocks not depicted in FIGS. 14A-14M or a subset of blocks depicted in FIGS. 14A-14M.

Referring to FIG. 14A, at block 1402, image processor 108 can receive image data representing a visual scene and an attention signal indicating a location within the visual scene from image capture device 102 and attention signal generator 104, respectively. The image data can capture the current state of a physical environment containing controllable objects such as ceiling fans, light switches, thermostats, or other smart home devices. The attention signal can indicate where a user is directing attention within the visual scene, enabling the system to identify which object the user intends to interact with.

In some embodiments, at block 1404, attention signal generator 104 can derive the attention signal from eye tracking data comprising gaze coordinates corresponding to the location within the visual scene. Attention signal generator 104 can process eye tracking data from infrared cameras that monitor eye position and gaze direction, calculating gaze vectors in three-dimensional space and mapping them to two-dimensional image coordinates. The eye tracking system can provide gaze coordinates at update rates of 60-120 Hz, enabling precise identification of attended objects within the visual scene captured by image capture device 102.

In some augmented reality (AR) or mixed reality (MR) embodiments, the attention signal takes the form of a composite spatial targeting vector. The system can generate this composite vector by dynamically fusing optical head-tracking or ocular gaze data with concurrent depth sensor data (such as data retrieved from a time-of-flight camera, LiDAR, or structured light sensor). Rather than relying solely on a two-dimensional image coordinate, the composite vector mathematically projects a three-dimensional line of sight from the user into the physical environment. The system can calculate an intersection point between this composite vector and a spatial depth map of the physical environment to derive a precise three-dimensional spatial bounding coordinate (e.g., x, y, z parameters). The system can subsequently pass this three-dimensional spatial bounding coordinate to the vision-language model alongside the captured image data. By providing the composite vector data, the vision-language model is architecturally constrained to focus its semantic analysis exclusively on the physical object occupying that specific volumetric coordinate in three-dimensional space, thereby significantly improving object disambiguation in crowded visual scenes.

At block 1406, vision-language model 110 and/or language model 112 can generate, using a vision-language model, one or more task identifiers of one or more tasks associated with an object at the location based on the image data and the attention signal. Vision-language model 110 can process the image data to identify the object at the attention location, generating semantic descriptions such as “ceiling fan, currently powered on, speed setting appears to be medium based on blade rotation rate.” Language model 112 can receive the object identifier and contextual information from contextual information module 114, query device control interface 122 to obtain precise state information and available control actions, and generate task identifiers with executable task specifications including specific application programming interface endpoints and parameters.

At block 1408, presentation module 118 can cause presentation of the one or more task identifiers for user selection via display device 120. Presentation module 118 can generate presentation data adapted to the user input modality by modifying visual presentation, interaction timing, or interaction methods based on input capability constraints. Display device 120 can render visual elements such as buttons, icons, text labels, or graphical indicators representing each task identifier in a subset selected based on user input capabilities.

At block 1492, presentation module 118 may, responsive to a selection of a task identifier from the one or more task identifiers, generate a structured command corresponding to the selected task identifier and transmit the structured command to device control interface 122 to execute a task associated with the selected task identifier. The structured command may include, for example, a device identifier, an action type, and one or more parameters formatted according to an application programming interface (API) specification associated with the device control interface. In some embodiments, presentation module 118 may retrieve command templates associated with the selected task identifier and populate parameter fields using current state data obtained from device control interface 122. For example, selection of a task identifier “Increase speed to high” for a ceiling fan may result in generation of a command such as “living_room_fan.set_speed(high)” including device identifier “living_room_fan,” action “set_speed,” and parameter value “high.” In some embodiments, prior to transmission, presentation module 118 may validate the structured command by verifying device availability, confirming that the requested action is supported by the device capability descriptors, and ensuring that the requested state transition does not violate dependency constraints stored in a device capability graph. Device control interface 122 may translate the structured command into device-specific communication protocols such as Wi-Fi, Zigbee, Z-Wave, Bluetooth, Thread, or Ethernet communication formats, and may transmit the command to the target device. In some embodiments, device control interface 122 may return execution status data indicating success, failure, or partial completion. Presentation module 118 may receive the execution status data and may cause presentation of confirmation information via display device 120, including visual indicators, auditory indicators, or haptic feedback corresponding to successful task execution. By generating structured device-specific commands based on task identifier selection and transmitting the commands through standardized device control interfaces, the system can reduce manual navigation sequences and reduces intermediate interface state transitions required by conventional hierarchical control architectures.

Referring to FIG. 14B, in some embodiments, at block 1410, image processor 108 may modify the image data to include a visual marker at the location indicated by the attention signal. Image processor 108 can apply visual markers including colored dots, crosshairs, highlighting, or bounding box overlays that encode attention information directly into the image data. The visual marker can include a red dot with radius of 5-15 pixels positioned at the gaze coordinates, crosshairs with line thickness of 2-5 pixels and length of 20-40 pixels centered on the attention location, a bounding box with line thickness of 2-5 pixels surrounding the attended object with padding of 5-10 pixels, or highlighting with semi-transparent color overlay covering the attended object region, as illustrated in FIG. 2.

At block 1412, image processor 108 may provide the modified image as input to the vision-language model 110. The visual marker encoding approach can enable vision-language models to identify attended objects without requiring architectural modification of the underlying multimodal model structure, as the visual marker creates a salient visual feature naturally drawing the model's visual attention mechanism to the indicated location, similar to how colored indicators draw human visual attention.

Referring to FIG. 14C, in some embodiments, at block 1414, contextual information module 114 may obtain contextual information comprising at least one of temporal data, environmental sensor data, or user history data. Contextual information module 114 can receive environmental sensor data from environmental sensors 106 including temperature measurements, humidity measurements, light level measurements, or audio level measurements. Contextual information module 114 can obtain temporal data indicating current time of day, day of week, or season from system clocks or network time protocols. Contextual information module 114 can receive user history data from user history storage 124 including identified patterns, frequency counts, confidence scores, and user preference information derived from historical interaction data.

In some embodiments, at block 1416, task ranking module 116 may determine that the contextual information includes: a current time of day; a current state of the object obtained from a device control interface; user preference data derived from historical interactions with the object; and environmental condition data obtained from one or more sensors, and may rank the one or more tasks by weighting each task based on each component of the contextual information. Task ranking module 116 can apply weighting factors including 40% weight to contextual relevance (how well current environmental conditions match conditions where a task is typically appropriate), 35% weight to user history patterns (how frequently the user has selected the task under similar conditions), 15% weight to urgency scores (how time-sensitive or safety-critical the task is), and 10% weight to interaction efficiency (how many steps the task requires for completion), as illustrated in FIG. 3. For example, when a user directs attention toward a ceiling fan at 2:30 PM on a day when outdoor temperature is 89° F. with the fan currently running at medium speed, and user history indicates the user has selected “Increase to high speed” 15 out of 15 times when temperature exceeded 85° F., task ranking module 116 can assign a priority score of 0.92 to “Increase to high speed” based on high contextual relevance due to hot temperature, high user history score due to consistent past behavior, moderate urgency, and high efficiency.

At block 1418, task ranking module 116 may rank the one or more tasks based on the contextual information. Task ranking module 116 can calculate a priority score for each task identifier using the formula: priority score=(0.40×contextual relevance score)+(0.35×user history score)+(0.15×urgency score)+(0.10×efficiency score), where each component score ranges from 0.0 to 1.0. Task ranking module 116 can sort task identifiers by priority score in descending order and transmit ranked task identifiers to presentation module 118.

Referring to FIG. 14D, in some embodiments, at block 1420, contextual information module 114 may obtain contextual information comprising at least one of temporal data, environmental sensor data, or user history data. At block 1422, contextual information module 114 may detect an event condition from the environmental sensor data indicating a state change. Contextual information module 114 can detect event conditions such as smoke detector activation, doorbell activation, or pet vocalizations by applying audio pattern recognition, threshold detection, or anomaly detection algorithms to sensor data from environmental sensors 106. For example, a microphone integrated into the system may detect audio matching a dog barking pattern with 87% confidence, with the barking persisting continuously for 28 seconds, as illustrated in FIG. 4.

At block 1424, contextual information module 114 may determine an urgency score of the event condition based on the contextual information. Contextual information module 114 can calculate an urgency score ranging from 0.0 (no urgency) to 1.0 (maximum urgency) using weighted combinations of factors including event type severity, time of day appropriateness, user activity disruption cost, and event persistence. For example, contextual information module 114 can retrieve contextual information indicating that the user typically feeds the dog at 9:00 AM ±15 minutes based on 45 recorded feeding interactions over the past 60 days, determine that current time (9:03 AM) falls within the typical feeding window, and calculate an urgency score of 0.62 on a 0-1 scale (moderate urgency: not life-threatening but time-sensitive, animal welfare concern, aligns with established routine).

At block 1426, presentation module 118 may, in accordance with a determination that the urgency score exceeds a predetermined threshold, cause presentation of a set of task identifiers of one or more event-related tasks associated with the event condition without the attention signal. Presentation module 118 can compare the urgency score to a predetermined threshold ranging from 0.6 to 0.8, with typical values of 0.75. For high-urgency events such as smoke detector activation (urgency score 0.95), presentation module 118 can immediately present task identifiers such as “Call fire department” or “Activate sprinklers” without waiting for user attention to shift, ensuring rapid response to safety-critical situations.

At block 1428, presentation module 118 may, in accordance with a determination that the urgency score is below the predetermined threshold, defer presentation of the set of task identifiers of the one or more event-related tasks until receiving the attention signal directed to a relevant object (e.g., an object associated with the event condition). For low-urgency events such as dog barking for food (urgency score 0.62, below threshold 0.75), presentation module 118 can defer presentation until the user naturally shifts attention toward the pet feeding area, avoiding disruption of ongoing activities such as email composition while ensuring timely response to the animal welfare concern.

Referring to FIG. 14E, in some embodiments, at block 1430, presentation module 118 may determine a current focus region corresponding to the location indicated by the attention signal. Presentation module 118 can calculate a current focus region as a circular or rectangular area centered on the attention signal location with radius or dimensions determined by typical object sizes and visual attention spans. The current focus region can have a radius of 20-40 centimeters for objects at typical viewing distances of 1-3 meters.

At block 1432, presentation module 118 may position a visual notification for the one or more event-related tasks outside the current focus region to avoid disrupting ongoing user activity. Presentation module 118 can position visual notifications 30-50 centimeters away from the current focus region center, placing the notification in peripheral vision areas above, below, or to the side of the current focus region depending on available space and scene layout. This approach enables users to maintain focus on current tasks while remaining aware of events requiring potential attention, as illustrated in FIG. 4.

At block 1434, vision-language model 110 may process the image data using the vision-language model to identify the object at the location. Vision-language model 110 can apply convolutional neural network layers or vision transformer layers to extract visual features from the modified image, identify the visual marker within the image, determine which object in the scene corresponds to the marker location, and generate a semantic description of the identified object. Vision-language model 110 can recognize objects such as ceiling fans, light switches, thermostats, or other devices based on visual features including shape, color, texture, and spatial context.

At block 1436, language model 112 may provide an object identifier and contextual information to a language model. The two-stage architecture can separate visual scene understanding (vision-language model 110 responsibility) from task generation and application programming interface mapping (language model 112 responsibility). Vision-language model 110 can generate semantic descriptions without requiring knowledge of smart home control protocols, while language model 112 can receive the semantic description, query device control interfaces to obtain precise state information and available control actions, and generate task identifiers with executable task specifications.

Referring to FIG. 14F, at block 1438, language model 112 may receive the one or more task identifiers from the language model based on the object identifier and the contextual information. Language model 112 can generate natural language task descriptions that specify actionable operations such as “Increase speed to high,” “Turn off fan,” “Set to low speed,” or “Set 30-minute timer” for a ceiling fan, along with priority scores calculated by task ranking module 116.

Referring to FIG. 14G, in some embodiments, at block 1440, user history storage 124 may store interaction data comprising selection and contextual information for each presentation of the one or more task identifiers. User history storage 124 can maintain records including timestamps, identified objects, presented task identifier lists, selected task identifiers, contextual information at time of interaction (temporal data, environmental sensor data, device states), and task execution outcomes (success, failure, error details) in structured database formats such as relational databases, document databases, or time-series databases.

At block 1442, user history storage 124 may identify a pattern in the interaction data, the pattern indicating selection frequency of a particular task type under specific contextual conditions. User history storage 124 can analyze the stored interaction data to identify patterns through frequency analysis (counting how often specific task identifiers are selected under specific conditions), temporal analysis (identifying time-of-day or day-of-week patterns), or sequential analysis (identifying task identifier sequences that frequently occur together). User history storage 124 can apply statistical methods, machine learning algorithms, or rule-based pattern matching to extract patterns from historical data and calculate confidence scores for identified patterns based on sample size, consistency of behavior, and recency of observations.

At block 1444, task ranking module 116 may update a priority score associated with tasks matching the particular task type based on the identified pattern when the specific contextual conditions are present in subsequent generation of task identifiers. Task ranking module 116 can receive user history data from user history storage 124 including identified patterns with confidence scores, frequency counts for task identifier selections under various contextual conditions, and user preference profiles. Task ranking module 116 can apply priority increases proportional to pattern confidence levels, with strongly-established patterns (high frequency, high consistency) receiving larger priority boosts than weakly-established patterns, improving task prediction accuracy from initial 40-50% (context-only ranking) to 75-90% (context plus learned preferences) over 2-4 weeks of system use.

Referring to FIG. 14H, in some embodiments, at block 1446, vision-language model 110 may identify a plurality of devices in the visual scene using the vision-language model. Vision-language model 110 can process the visual scene to identify multiple devices such as a television, window coverings, ceiling lights, and table lamps visible in a living room environment.

At block 1448, language model 112 may determine a functional relationship between the object and at least one device of the plurality of devices based on additional capabilities associated with the plurality of devices, the additional capabilities including complementary capabilities, environmental interaction capabilities, state dependency capabilities, or temporal sequencing capabilities. In some embodiments, language model 112 may retrieve device capability descriptors from device control interface 122 for each device identified in the visual scene. The device capability descriptors may include supported operations, controllable parameters, state variables, environmental effect attributes, and dependency indicators. Language model 112 may construct a capability vector for each device, wherein the capability vector encodes operational attributes and environmental interaction properties in a structured representation. Language model 112 may determine the functional relationship by comparing capability vectors across devices to identify overlapping environmental influence domains, reinforcing or inverse operational effects, prerequisite state-transition dependencies, or shared resource constraints. In some embodiments, the system may construct a device capability graph in which nodes represent devices and edges represent inferred relationships derived from similarity measures, rule-based mappings, or dependency analysis of the capability vectors. Additional capabilities may include complementary capabilities (e.g., luminance reduction of lighting devices enhancing display contrast of a television), prerequisite capabilities (e.g., window covering closure required before projector activation), environmental interaction capabilities (e.g., acoustic output affecting microphone input), or state-transition dependencies (e.g., ventilation activation prior to cooking appliance ignition). By determining functional relationships based on structured analysis of additional capabilities rather than predetermined static rule mappings, the system enables dynamic generation of coordinated control tasks across heterogeneous device ecosystems.

At block 1450, language model 112 may generate at least one task identifier of at least one task of the one or more tasks providing coordinated control of the object and the at least one device based on the functional relationship. Language model 112 can generate coordinated control tasks such as “Start movie mode” that includes television power-on, ceiling lights dimmed to 15%, table lamps dimmed to 20%, and window coverings closed, enabling users to accomplish multi-device state changes through a single task identifier selection rather than separate navigation to multiple device controls.

At block 1452, presentation module 118 may receive a selection of the at least one task identifier from display device 120. Display device 120 can detect user input selecting the “Start movie mode” task identifier through eye tracking, brain-computer interface signals, voice commands, touch input, or gesture recognition.

At block 1454, presentation module 118 may generate a sequence of control commands for the object and the at least one device. Presentation module 118 can generate control commands including “living_room_blinds.close( ),” “ceiling_lights.set_brightness(15),” “table_lamps.set_brightness(20),” and “living_room_tv.power_on( )” for executing the coordinated task.

At block 1456, presentation module 118 may determine an execution order of the sequence of control commands based on dependencies between states of the plurality of devices. Presentation module 118 can employ dependency graph analysis, constraint satisfaction solving, or heuristic ordering rules to determine that window coverings may need to close first (longest mechanical operation time, 8-12 seconds), lights may need to dim second (fast electronic operation, 0.5-1.0 seconds, but should complete before television powers on), and television should power on last (to avoid displaying bright startup screen before lights are dimmed).

At block 1458, presentation module 118 may transmit the sequence of control commands according to the execution order via device control interface 122. Presentation module 118 can transmit the blind closing command at t=0, send light dimming commands at t=0.5 (allowing blinds to begin closing), and send television power-on command at t=2.0 (allowing lights to complete dimming). The coordinated execution can create a smooth transition to movie viewing conditions over 10 seconds, compared to conventional systems requiring separate navigation to blind controls, light controls, and television controls.

Referring to FIG. 14I, in some embodiments, at block 1460, presentation module 118 may determine an input capability of a user input modality. Presentation module 118 can assess control dimensionality (binary, scalar, two-dimensional, three-dimensional), control bandwidth (bits per second of information transfer), control latency (delay between user intent and system detection), and control reliability (error rate or signal-to-noise ratio). Control dimensionality can quantify how many independent parameters a user can control simultaneously, where binary input provides zero-dimensional control (single yes/no decision), monotonic scalar input provides 0.5-dimensional control (magnitude adjustment in one direction only), one-dimensional input provides bidirectional control along a single axis, and two-dimensional input provides control in a plane.

At block 1462, presentation module 118 may select a subset of the one or more task identifiers of the one or more tasks based on the input capability. Presentation module 118 can limit the number of task identifiers in the subset based on control dimensionality, where the number of task identifiers decreases as control dimensionality decreases. Task identifier count limits can follow an inverse relationship with control dimensionality: binary input may be limited to 2-4 task identifiers (enabling 1-2 levels of binary partitioning), scalar input may be limited to 3-5 task identifiers (enabling magnitude-based selection), one-dimensional input may be limited to 5-10 task identifiers (enabling list navigation), and two-dimensional input may support 10-20 task identifiers (enabling grid layouts), as illustrated in FIG. 5.

At block 1464, presentation module 118 may cause presentation of the subset of the one or more task identifiers via an interface adapted to the user input modality. Presentation module 118 can modify visual presentation (larger targets for lower-precision input, simplified layouts for lower-bandwidth input), interaction timing (longer dwell times for higher-latency input), or interaction methods (binary partitioning for binary input, magnitude adjustment for scalar input) based on the determined input capability.

Referring to FIG. 14J, in some embodiments, at block 1466, presentation module 118 may, when the user input modality includes a binary input mechanism, partition the subset of the one or more task identifiers into a first group and a second group. Presentation module 118 can implement binary partitioning that recursively divides the task identifier set approximately in half, applying balanced partitioning to minimize the number of binary decisions required. For N task identifiers, binary partitioning can require ceiling(log₂(N)) binary decisions to reach a specific task identifier, as illustrated in FIG. 5.

At block 1468, presentation module 118 may cause presentation of an indication of the first group and the second group via display device 120. Display device 120 can present visual labels such as “Task identifiers 1-3” for a first group and “Task identifiers 4-5” for a second group, or auditory descriptions, or haptic patterns indicating the two groups.

At block 1470, presentation module 118 may receive a binary selection indicating either the first group or the second group from a user through a brain-computer interface signal, a single-button press, or other binary input mechanism. The binary selection can indicate either “Group 1” or “Group 2.”

At block 1472, presentation module 118 may cause presentation of individual task identifiers within a selected group indicated by the binary selection for task selection. Presentation module 118 can repeat the partitioning process recursively until a single task identifier is selected. For example, a user with binary input capability can select from 5 task identifiers through 3 binary decisions (first decision: “Task identifiers 1-3” vs “Task identifiers 4-5,” second decision: “Task identifier 1” vs “Task identifiers 2-3,” third decision: “Task identifier 2” vs “Task identifier 3”), requiring 3 binary selections instead of 5 sequential evaluations.

Referring to FIG. 14K, in some embodiments, at block 1474, presentation module 118 may, when the user input modality includes eye tracking, cause presentation of visual indicators for each task identifier in the subset via display device 120. Display device 120 can present visual indicators including buttons, icons, text labels, or graphical elements with distinct visual boundaries for each task identifier in the subset, arranged in layouts optimized for eye tracking such as circular arrangements, grid layouts, or linear arrangements with adequate spacing between indicators, as illustrated in FIG. 5.

At block 1476, presentation module 118 may track dwell time of gazes on each visual indicator. Presentation module 118 can measure continuous gaze duration within each visual indicator's boundary region, resetting the dwell time measurement when gaze moves outside the boundary of a visual indicator. Presentation module 118 can provide visual feedback during dwell time accumulation through progress indicators such as filling circles, expanding rings, or color transitions that show users how much additional dwell time is required for selection.

At block 1478, presentation module 118 may, in accordance with a determination that the dwell time of a gaze on a visual indicator for a task identifier exceeds a dwell threshold, select the task identifier from the subset of the one or more task identifiers. The dwell threshold can range from 0.5 seconds (fast interaction, higher accidental selection risk) to 3.0 seconds (slow interaction, lower accidental selection risk), with typical values of 1.0-2.0 seconds balancing speed and accuracy. The dwell threshold can be configured based on user preferences, input reliability, or adaptive learning from user performance.

Referring to FIG. 14L, in some embodiments, at block 1480, display device 120 may determine a three-dimensional spatial position of the object using depth sensor capabilities and spatial position determination as illustrated in FIG. 6A. Display device 120 can employ depth sensors including time-of-flight cameras, structured light sensors, or stereo cameras to measure distances from a camera viewpoint to physical objects in the scene. Spatial position determination can calculate (x, y, z) coordinates for each object relative to the camera viewpoint, where x represents horizontal position, y represents vertical position, and z represents depth.

At block 1482, display device 120 may generate one or more visual elements representing the subset of the one or more task identifiers, wherein each visual element is positioned relative to the three-dimensional spatial position of the object. Display device 120 can calculate positions for visual elements by applying offsets to the object positions using vector addition: visual element position=object position+offset vector. Display device 120 can apply horizontal offsets of 10-30 centimeters to position visual elements adjacent to physical objects without occluding the objects, selecting offset magnitudes based on object size and scene density, as illustrated in FIGS. 6A and 6B.

At block 1484, display device 120 may cause rendering of the one or more visual elements in an augmented reality display at a depth matching the object. Display device 120 can apply depth-matched rendering by calculating rendering parameters such as binocular disparity (horizontal offset between left-eye and right-eye images to create stereoscopic depth perception), vergence angle (angle at which eyes converge to focus on objects at specific depths), and accommodation distance (focal distance at which lenses may need to adjust for sharp focus). Display device 120 can generate stereoscopic image pairs for left and right eyes with appropriate horizontal disparities calculated using the formula: disparity=(baseline×focal length)/depth, where baseline is the inter-pupillary distance (typically 63 mm), focal length is the display optical system focal length, and depth is the z-coordinate of the visual element. This depth-matched rendering can ensure that visual elements appear at the correct depth, reducing vergence-accommodation conflict and creating seamless integration between physical objects and virtual task identifier indicators, as illustrated in FIG. 6B.

Referring to FIG. 14M, in some embodiments, at block 1486, presentation module 118 may track interaction state information comprising user attention focus and task presentation timing. Presentation module 118 can monitor which object the user is currently attending to via attention signals from attention signal generator 104 and record when task identifiers were presented via display device 120.

At block 1488, presentation module 118 may, in accordance with a determination that a duration of user inactivity exceeds a predetermined timeout threshold, cause the interface to fade the presentation of the subset of the one or more task identifiers. Presentation module 118 can measure a duration of user inactivity by determining elapsed time since a last attention signal or input signal was received. Timeout thresholds can range from 3 seconds (aggressive cleanup, frequent regeneration) to 30 seconds (persistent display, infrequent regeneration), with typical values of 5-15 seconds balancing interface clutter reduction with regeneration overhead. Presentation module 118 can employ gradual opacity reduction over 1-3 seconds via display device 120, providing visual continuity and allowing users to notice and prevent removal if desired.

At block 1490, presentation module 118 may, in response to receiving a subsequent attention signal or input signal before complete removal of the one or more task identifiers, restore the presentation of the subset of the one or more task identifiers without regenerating the one or more task identifiers. Presentation module 118 can immediately increase opacity of previously-generated task identifiers via display device 120, avoiding computational cost and latency of re-running vision-language model 110 and language model 112. This restoration without regeneration can enable immediate task list reappearance when users return attention to previously-attended objects, reducing processing overhead while maintaining responsive user interaction.

Example embodiments of systems, methods, apparatuses, and non-transitory computer-readable media for attention-driven task suggestion, contextual task generation, input-adaptive interaction, and device control orchestration are described herein. In one aspect, referring to FIG. 1, image processor 108 may receive image data representing a visual scene from image capture device 102 and spatial telemetry data (e.g., data encoding a spatial position or direction of user attention within a coordinate system associated with the visual scene) including a gaze coordinate indicating a location within the visual scene from attention signal generator 104. The spatial telemetry data may include, for example, eye tracking gaze coordinates, brain-computer interface directional signals, or head orientation vectors that encode a spatial relationship between the user and a location within the captured visual scene. Vision-language model 110 may generate, using the image data and the spatial telemetry data, one or more task identifiers of one or more tasks associated with an object at the location. In some embodiments, each task identifier comprises (e.g., includes) (i) a human-perceptible label presented to the user (e.g., a natural language phrase such as “Increase speed to high”), and (ii) a machine-executable control payload (e.g., an API command string, API endpoint identifier with parameters, or a structured object including an action and parameter values) associated with the label. Presentation module 118 may cause presentation of the one or more task identifiers via display device 120. Responsive to a selection of a task identifier from the one or more task identifiers (e.g., via gaze dwell, brain-computer interface magnitude signal, or binary input selection received through display device 120), presentation module 118 may transmit a command to device control interface 122 associated with the object to execute a task corresponding to the selected task identifier. In some embodiments, the selection comprises an input event mapped to a specific presented task identifier (e.g., a dwell-time trigger on a visual indicator corresponding to the label, a thresholded magnitude value from a brain-computer interface signal indicating “select,” or a binary “yes” selection received while the task identifier is highlighted). For example, responsive to selection of a task identifier “Increase speed to high” for a ceiling fan, presentation module 118 may transmit a command “living_room_fan.set_speed(high)” to device control interface 122, which may execute the command by communicating with the ceiling fan through a smart home platform or direct device application programming interface. In some embodiments, device control interface 122 may execute the command by translating the command into a protocol-specific message (e.g., a Zigbee, Z-Wave, Thread, Bluetooth, or Wi-Fi message) and transmitting the protocol-specific message to the ceiling fan.

In some embodiments, to generate the one or more task identifiers, vision-language model 110 may process the image data to identify the object at the location indicated by the spatial telemetry data. In some embodiments, the location comprises pixel coordinates in an image coordinate system (e.g., (u, v) coordinates in a captured frame), and vision-language model 110 may identify the object by selecting a region of interest (e.g., a bounding box or crop window centered on the pixel coordinates, or a segmentation mask including pixels within a threshold radius of the pixel coordinates) and extracting visual features from the region of interest. Vision-language model 110 may generate an object identifier (e.g., a semantic description of the identified object including object type, visual attributes, and inferred operating state, such as “ceiling fan with four wooden blades, currently rotating at moderate speed”) based on visual features extracted from the image data at the location. Vision-language model 110 may provide the object identifier and contextual information module 114 may provide contextual information (e.g., temporal data from system clocks, environmental sensor data from environmental sensors 106, current device state from device control interface 122, and user history data from user history storage 124) to language model 112. Language model 112 may receive the object identifier and the contextual information and may generate the one or more task identifiers based on the object identifier and the contextual information. For example, language model 112 may receive an object identifier “ceiling fan, currently powered on, speed setting appears to be medium” and contextual information including outdoor temperature of 89° F., time of 2:30 PM, and user history indicating 15 consecutive selections of “increase fan speed to high” when temperature exceeded 85° F., and may generate task identifiers “Increase speed to high,” “Set 30-minute timer,” “Turn off fan,” and “Set to low speed,” each associated with a corresponding API command executable through device control interface 122.

In some embodiments, system 100 may further include a binary input mechanism (e.g., a hardware input device physically connected to or communicating with the system that provides zero-dimensional control through a single yes/no signal, such as a brain-computer interface stent providing a single activation signal, a single-button switch, a sip-and-puff controller, or a blink-detection sensor). To cause presentation of the one or more task identifiers, presentation module 118 may select a subset of the one or more task identifiers based on a control dimensionality (e.g., the number of independent control parameters that the binary input mechanism may simultaneously provide, which for a binary input mechanism is zero-dimensional, indicating that the mechanism may capture only a single binary yes/no decision per interaction cycle) of the binary input mechanism. In some embodiments, presentation module 118 may select the subset by enforcing a maximum branching factor equal to the number of discrete selections supported by the binary input mechanism per interaction cycle (e.g., two branches corresponding to “yes” and “no”). Presentation module 118 may partition the subset of the one or more task identifiers into a first group (e.g., a first portion of the task identifiers in the subset, such as task identifiers 1-3 from a subset of 5 task identifiers) and a second group (e.g., a second portion of the task identifiers in the subset, such as task identifiers 4-5 from a subset of 5 task identifiers). Presentation module 118 may cause presentation of an indication of the first group and the second group (e.g., visual labels such as “Group 1: Tasks 1-3” and “Group 2: Tasks 4-5” displayed on display device 120, auditory descriptions such as spoken prompts identifying each group, or haptic patterns distinguishing the two groups) via display device 120. Presentation module 118 may receive a binary selection (e.g., a single yes/no signal generated by the user through the binary input mechanism) indicating either the first group or the second group. Presentation module 118 may cause presentation of individual task identifiers within a selected group indicated by the binary selection for task selection (e.g., displaying the individual task identifiers belonging to the selected group, and recursively partitioning the selected group into further sub-groups if the selected group contains more than one task identifier, until a single task identifier is reached). For example, when the subset contains 5 task identifiers and the user generates a binary selection indicating the first group (task identifiers 1-3), presentation module 118 may present a further partition of the first group into sub-group A (task identifier 1) and sub-group B (task identifiers 2-3), receive a second binary selection, and continue recursive partitioning until a single task identifier is selected, requiring ceiling(log₂(5))=3 binary decisions.

In some embodiments, to cause presentation of the subset of the one or more task identifiers selected based on the control dimensionality of the binary input mechanism, spatial position determination module 612 may determine a three-dimensional spatial position of the object (e.g., calculate (x, y, z) coordinates of the object relative to camera viewpoint 602 using depth data from depth sensor 610 and camera pose data from camera viewpoint 602, as described with respect to FIGS. 6A and 6B). Visual element generation module 620 may generate one or more visual elements (e.g., graphical representations such as buttons, icons, or text labels rendered as virtual objects in three-dimensional space) representing the subset of the one or more task identifiers, wherein each visual element is positioned relative to the three-dimensional spatial position of the object (e.g., offset by 10-30 centimeters horizontally or vertically from the object's three-dimensional coordinates, calculated using vector addition: visual element position=object position+offset vector). Augmented reality rendering module 628 may cause rendering of the one or more visual elements in augmented reality display 630 (e.g., a head-mounted display, smart glasses, or other augmented reality device that overlays virtual content onto real-world views) at a depth matching the object (e.g., at the same focal distance as the physical object, such that the visual elements and the physical object appear at the same depth to the user, reducing vergence-accommodation conflict). In some embodiments, augmented reality rendering module 628 may set a depth value (e.g., a z-depth or focal-plane distance parameter provided to the rendering pipeline) for each visual element equal to the computed z-coordinate of the object within a tolerance (e.g., +0.1 m to −0.1 m) such that the visual element is rendered at the object depth. For example, when the object is a ceiling fan at three-dimensional spatial position (x: 1.2 m, y: 0.3 m, z: 2.5 m), visual element generation module 620 may generate visual elements representing the first group and the second group of the binary partition, position the visual elements at (x: 1.4 m, y: 0.3 m, z: 2.5 m) offset 20 centimeters to the right of the ceiling fan, and augmented reality rendering module 628 may cause rendering of the visual elements in augmented reality display 630 at depth 2.5 meters matching the ceiling fan's depth, such that the binary group indicators appear to float in space adjacent to the physical ceiling fan.

In some embodiments, attention signal generator 104 may generate spatial telemetry data (e.g., data encoding a spatial position or direction of user attention within a coordinate system associated with the visual scene) including a gaze coordinate indicating a location within the visual scene. The spatial telemetry data may include, for example, eye tracking gaze coordinates, brain-computer interface directional signals, or head orientation vectors that encode a spatial relationship between the user and a location within the captured visual scene. Vision-language model 110 may process the image data and the spatial telemetry data to generate one or more task identifiers of one or more tasks associated with an object at the location. In some embodiments, each task identifier comprises (e.g., includes) (i) a human-perceptible label presented to the user and (ii) a machine-executable control payload associated with the label. Presentation module 118 may cause presentation of the one or more task identifiers via display device 120. Responsive to a selection of a task identifier from the one or more task identifiers (e.g., via gaze dwell, brain-computer interface magnitude signal, or binary input selection received through display device 120), presentation module 118 may transmit a command to device control interface 122 associated with the object to execute a task corresponding to the selected task identifier. In some embodiments, the selection comprises an input event mapped to a specific presented task identifier. For example, responsive to selection of a task identifier “Increase speed to high” for a ceiling fan, presentation module 118 may transmit a command “living_room_fan.set_speed(high)” to device control interface 122, which may execute the command by communicating with the ceiling fan through a smart home platform or direct device application programming interface. In some embodiments, device control interface 122 may execute the command by translating the command into a protocol-specific message and transmitting the protocol-specific message to the ceiling fan.

In some embodiments, image processor 108 may modify the image data to include a visual marker at the location indicated by the spatial telemetry data (e.g., at pixel coordinates corresponding to the gaze coordinate within the image coordinate system). Image processor 108 may provide the modified image as input to vision-language model 110. The visual marker may encode the spatial telemetry data directly into the image data, enabling vision-language model 110 to identify the object at the location indicated by the spatial telemetry data without requiring a separate spatial telemetry data input channel. In some embodiments, vision-language model 110 may identify the object by detecting the visual marker pixels (e.g., by color thresholding or by recognizing a marker shape) and selecting a region of interest adjacent to the detected marker pixels for object identification.

In some embodiments, vision-language model 110 may generate semantic representations (e.g., structured textual descriptions of object types, states, and attributes) of the object and at least one device of the plurality of devices identified in the visual scene. Language model 112 may determine, based on the semantic representations generated by vision-language model 110, a functional relationship between the object and the at least one device based on additional capabilities (e.g., device capabilities beyond the primary function of the object, including capabilities of other devices that interact with, complement, or depend on the object). In some embodiments, the functional relationship comprises a structured representation (e.g., a tuple, record, or graph edge) identifying (i) a first device identifier, (ii) a second device identifier, and (iii) a relationship type selected from a predefined set (e.g., “complementary,” “prerequisite,” “environmental interaction,” or “state-transition dependency”). Additional capabilities may include complementary capabilities (e.g., a lighting device providing luminance reduction that enhances display contrast of a television), prerequisite capabilities (e.g., window covering closure required before projector activation to reduce ambient light), environmental interaction capabilities (e.g., a ventilation device affecting air quality that interacts with a cooking appliance), or state-transition dependencies (e.g., a ventilation device requiring activation prior to a cooking appliance ignition). Language model 112 may generate at least one task identifier of at least one task of the one or more tasks providing coordinated control of the object and the at least one device based on the functional relationship.

In some embodiments, attention signal generator 104 may receive physiological telemetry data (e.g., data derived from physiological signals of a user, such as eye movement signals captured by infrared eye tracking cameras, neural signals captured by brain-computer interface electrodes, or head movement signals captured by inertial measurement units) including one or more spatial gaze coordinates directed toward a target object (e.g., a physical object within the visual scene that the user is attending to, such as a ceiling fan, light switch, thermostat, or other controllable device) within a physical environment. Vision-language model 110 may process image data of the physical environment using at least the vision-language model, based at least on the one or more spatial gaze coordinates, to generate an initial set of executable tasks (e.g., the one or more task identifiers generated by language model 112 prior to subset selection by presentation module 118) associated with the target object. Presentation module 118 may determine a physical control dimensionality constraint (e.g., a measured or configured limit on the number of independent control parameters that a connected user input device may simultaneously provide, such as zero-dimensional for binary input devices, 0.5-dimensional for scalar input devices, one-dimensional for single-axis input devices, or two-dimensional for planar input devices) of a connected user input device (e.g., a brain-computer interface, eye tracking system, single-button switch, or other input device physically connected to or communicating with the system). In some embodiments, presentation module 118 may assign the physical control dimensionality constraint by mapping a device capability descriptor to a discrete dimensionality value (e.g., binary to 0D; monotonic scalar magnitude-only to 0.5D; bidirectional scalar on one axis to 1D; two independent axes to 2D). Presentation module 118 may dynamically partition (e.g., select and structure in real time based on the determined physical control dimensionality constraint) the initial set of executable tasks into a constrained interaction subset (e.g., a subset of the one or more task identifiers that is structurally organized to be navigable within the limits imposed by the physical control dimensionality constraint) structurally bounded by the determined physical control dimensionality constraint (e.g., containing no more task identifiers than may be effectively navigated given the control dimensionality, such as 2-4 task identifiers for binary input or 3-5 task identifiers for scalar input). Presentation module 118 may cause presentation of the constrained interaction subset via display device 120.

In some embodiments, presentation module 118 may determine the physical control dimensionality constraint by detecting that the connected user input device is physically restricted (e.g., limited by the hardware design of the input device itself) to capturing one of a zero-dimensional binary input (e.g., a brain-computer interface stent providing only a single yes/no signal, or a single-button switch providing only on/off activation), or a one-dimensional scalar input (e.g., a brain-computer interface providing magnitude adjustment in one direction without ability to decrease magnitude or control direction). The physical restriction may be detected by querying device capability descriptors of the connected user input device, reading device configuration registers, or receiving device type information from an operating system device enumeration interface. In some embodiments, the one-dimensional scalar input referenced herein may correspond to a bidirectional scalar input providing magnitude adjustment along a single axis.

In some embodiments, when the determined physical control dimensionality constraint is the zero-dimensional binary input, presentation module 118 may dynamically partition the initial set of executable tasks by structuring the constrained interaction subset as a hierarchical binary search tree (e.g., a tree data structure in which each node partitions remaining task identifiers into two groups, and each binary input selection eliminates one group, recursively subdividing until a single task identifier is reached). The hierarchical binary search tree may mathematically reduce (e.g., reduce according to the mathematical relationship ceiling(log₂(N))) a number of sequential input interactions required to select an executable task from the initial set, where N is the number of task identifiers in the constrained interaction subset. In some embodiments, presentation module 118 may compute ceiling(log₂(N)) as a maximum number of binary selections required to reach a leaf node and may configure a number of hierarchical partition levels based on the computed maximum. For example, for N=8 task identifiers, the hierarchical binary search tree requires ceiling(log₂(8))=3 binary decisions, compared to 8 sequential evaluations in a linear scanning approach.

In some embodiments, vision-language model 110 may process the image data of the physical environment to generate a natural language semantic description (e.g., a textual string in natural language describing the target object's type, appearance, and inferred operating state, such as “ceiling fan with four wooden blades, currently rotating at moderate speed, mounted on white ceiling approximately 2.5 meters from camera”) of a current operating state of the target object. Vision-language model 110 may transmit the natural language semantic description to a secondary language model (e.g., language model 112, which is a separate model from vision-language model 110 and receives the semantic description as text input rather than image input) configured to automatically map (e.g., programmatically translate without manual intervention, by querying device control interface 122 to obtain available control actions and generating corresponding API commands) the current operating state to one or more actionable application programming interface (API) control commands. For example, language model 112 may receive the semantic description “ceiling fan, currently powered on, speed setting appears to be medium” and query device control interface 122 to determine available actions “set_speed(low|medium|high)”, “power_off()”, and “set_timer(minutes)”, and may generate task identifiers each associated with a corresponding API control command. In some embodiments, language model 112 may output each task identifier in a structured format (e.g., {“label”: “. . . ”, “command”: “. . . ”} or {“label”: “. . . ”, “endpoint”: “. . . ”, “parameters”: {. . . }}) that presentation module 118 may parse to render the label and may transmit the associated command.

In some embodiments, image processor 108 may modify the image data by rendering an artificial visual marker (e.g., a computer-generated graphical element that does not exist in the physical scene, such as a colored dot, crosshairs, bounding box, or highlighting overlay) directly into pixel data of the image data (e.g., by modifying RGB pixel values in the image array at positions corresponding to the visual marker geometry) at a location corresponding to the one or more spatial gaze coordinates, prior to processing the image data using vision-language model 110. The artificial visual marker may be rendered using pixel value modification, alpha blending, or geometric shape rendering operations applied to the image data array.

In some embodiments, contextual information module 114 may receive environmental sensor data (e.g., temperature measurements, humidity measurements, light level measurements, or audio level measurements from environmental sensors 106) representing a physical condition of the physical environment distinct from the image data. Task ranking module 116 can, prior to presentation module 118 dynamically partitioning the initial set, filter (e.g., rank and select a subset of) the initial set of executable tasks based at least on a weighted correlation (e.g., a numerical score computed by applying predefined weighting factors to measure correspondence) between the environmental sensor data and historically logged task execution patterns (e.g., records stored in user history storage 124 including timestamps, selected task identifiers, and contextual conditions at time of selection, representing patterns of which tasks the user has previously selected under similar environmental conditions) associated with the target object. In some embodiments, task ranking module 116 may compute the numerical score as Score=w₁·S_env+w₂·S_history+w₃·S_state, where S_env is derived from the environmental sensor data, S_history is derived from the historically logged task execution patterns, S_state is derived from current device state, and w₁, w₂, and w₃ are predefined weights. For example, task ranking module 116 may compute a weighted correlation by applying 40% weight to contextual relevance derived from the environmental sensor data and 35% weight to user history score derived from the historically logged task execution patterns, and may filter the initial set by selecting task identifiers with weighted correlation scores exceeding a selection threshold.

In some embodiments, presentation module 118 may track a continuous ocular dwell time (e.g., an uninterrupted duration measured in seconds during which the user's gaze, as indicated by the one or more spatial gaze coordinates from attention signal generator 104, remains within a boundary region of a visual indicator displayed on display device 120) of the one or more spatial gaze coordinates on a visual indicator corresponding to a specific executable task within the presented constrained interaction subset. Presentation module 118 may automatically transmit (e.g., transmit without requiring additional user confirmation beyond the dwell time satisfaction) an API command (e.g., a command formatted according to an application programming interface specification of device control interface 122, such as “living_room_fan.set_speed(high)”) to execute the specific executable task upon detecting that the continuous ocular dwell time satisfies (e.g., reaches or exceeds) a predefined temporal threshold (e.g., a dwell threshold value ranging from 0.5 seconds to 3.0 seconds, with typical values of 1.0-2.0 seconds, stored in a configuration parameter of presentation module 118).

In some embodiments, vision-language model 110 may be dynamically prompted (e.g., provided with a prompt that includes instructions specifying task generation constraints, where the prompt is constructed at runtime based on current system configuration and device capabilities) to exclude tasks from the initial set of executable tasks that require human manipulation (e.g., physical interaction by a human with the target object, such as manually turning a knob, pressing a physical button on the device, or physically repositioning the object) of the target object, and include only tasks capable of remote automated execution via a wireless network protocol (e.g., tasks that may be executed by transmitting commands through Wi-Fi, Zigbee, Z-Wave, Bluetooth, Thread, or other wireless communication protocols supported by device control interface 122, without requiring physical contact with the target object). For example, the prompt provided to vision-language model 110 may include an instruction such as “Generate only tasks that may be executed remotely through a device control interface. Exclude tasks requiring physical manipulation of the object.” In some embodiments, vision-language model 110 (or language model 112) may generate candidate tasks and presentation module 118 may filter the candidate tasks by discarding any candidate task whose associated command is not executable via device control interface 122 (e.g., tasks lacking an API endpoint in a capability schema for the object). In some embodiments, the prompt may additionally or alternatively specify that tasks capable of remote automated execution via a wired network protocol (e.g., Ethernet, serial connection) are also included.

In some embodiments, attention signal generator 104 may generate targeting data (e.g., data indicating a direction or location of user attention within the physical environment) including a spatial targeting vector (e.g., a vector in two-dimensional or three-dimensional space representing the direction and magnitude of user attention, derived from gaze coordinates, head orientation, or a combination thereof) directed toward a physical object within an environment. Vision-language model 110 may process an image of the environment using the vision-language model, based at least in part on the spatial targeting vector, to generate a superset of candidate tasks (e.g., a complete set of task identifiers generated by language model 112 before any filtering or subset selection based on input capability constraints) associated with the physical object. Presentation module 118 may access a stored user interaction profile (e.g., a software-defined configuration file, operating system accessibility setting, or user preference record stored in user history storage 124 or in a local configuration store, that specifies interaction parameters independently of the physical capabilities of any currently connected hardware input device). The stored user interaction profile may define a predefined graphical interaction constraint (e.g., a constraint on how task identifiers are visually presented and interacted with, such as a maximum number of concurrently displayed task identifiers, a required interaction method such as binary partitioning or dwell-time selection, or a minimum visual element size) independent of any currently connected hardware input device (e.g., the constraint applies regardless of whether the connected device is a mouse, touchscreen, eye tracker, or brain-computer interface). Presentation module 118 may filter the superset of candidate tasks into a structurally limited task hierarchy (e.g., a hierarchical arrangement of task identifiers organized to satisfy the predefined graphical interaction constraint, such as a binary search tree when the constraint specifies binary interaction, or a paginated list when the constraint specifies a maximum number of concurrent elements) configured to satisfy the predefined graphical interaction constraint of the stored user interaction profile. Presentation module 118 may cause presentation of the structurally limited task hierarchy to a user via display device 120.

In some embodiments, the predefined graphical interaction constraint of the stored user interaction profile may specify a maximum threshold of concurrently selectable visual elements (e.g., a numerical limit such as 2, 3, or 4, specifying the maximum number of task identifier visual elements that may be simultaneously displayed and selectable at any given time). Presentation module 118 may filter the superset of candidate tasks into the structurally limited task hierarchy by recursively partitioning the superset of candidate tasks into a plurality of nested binary groups (e.g., groups arranged in a tree structure where each parent group is divided into two child groups, and each child group may be further divided into two sub-groups) such that no individual presentation state (e.g., a single screen or display configuration presented to the user at any one point during the interaction sequence) of the structurally limited task hierarchy displays more selectable visual elements than the maximum threshold, thereby converting a linear task selection process into a binary search traversal. For example, when the maximum threshold is 2 and the superset contains 8 candidate tasks, presentation module 118 may recursively partition the 8 tasks into nested binary groups requiring 3 levels of binary selection (8 to 4 or 4 to 2 or 2 to 1) to reach a specific task identifier.

In some embodiments, the spatial targeting vector may be a composite vector (e.g., a vector computed by mathematically combining data from two or more sensor modalities into a single spatial representation) generated by fusing optical head-tracking data (e.g., head position and orientation data captured by optical tracking cameras, infrared marker systems, or inside-out tracking systems integrated into a head-mounted display) with augmented-reality depth sensor data (e.g., depth measurements captured by a depth sensor such as a time-of-flight camera, structured light sensor, stereo camera system, or LiDAR sensor integrated into or co-located with an augmented reality display device). Vision-language model 110 may process the image of the environment by receiving a three-dimensional spatial bounding coordinate (e.g., a set of (x, y, z) coordinate values specifying a volumetric location in three-dimensional space where the composite vector intersects with a physical object, derived by computing an intersection between the composite vector and a spatial depth map of the physical environment) derived from the composite vector alongside the image of the environment. The three-dimensional spatial bounding coordinate may constrain vision-language model 110 to focus semantic analysis on the physical object occupying the specified volumetric coordinate in three-dimensional space.

In some embodiments, the predefined graphical interaction constraint of the stored user interaction profile may specify an ocular dwell-time execution mode (e.g., an interaction mode in which task identifier selection is triggered by sustained gaze fixation on a visual indicator for a duration exceeding a dwell threshold, rather than by click, tap, or other discrete input events). Presentation module 118 may cause presentation of the structurally limited task hierarchy by rendering a visual progress indicator (e.g., a filling circle, expanding ring, color transition bar, or other graphical element that changes appearance over time) adjacent to a specific candidate task within the structurally limited task hierarchy. Presentation module 118 may detect a sustained intersection (e.g., a continuous temporal overlap, measured in seconds, between the spatial targeting vector and a boundary region of the visual indicator corresponding to the specific candidate task, where the spatial targeting vector remains within the boundary region without interruption) between the spatial targeting vector and the specific candidate task. In some embodiments, presentation module 118 may determine the sustained intersection by projecting the spatial targeting vector into display coordinates (e.g., screen pixel coordinates) and testing whether the projected coordinates remain within a bounding region of the visual indicator for at least the dwell threshold duration. Presentation module 118 may dynamically alter (e.g., progressively update in real time) a visual state (e.g., an appearance property such as fill level, color, opacity, size, or animation frame) of the visual progress indicator proportional to a duration of the sustained intersection until a predetermined dwell-time threshold (e.g., a dwell threshold value ranging from 0.5 seconds to 3.0 seconds stored in the user interaction profile or in a configuration parameter of presentation module 118) is satisfied.

In some embodiments, contextual information module 114 may detect an asynchronous environmental event (e.g., an environmental state change detected by environmental sensors 106 that occurs independently of and concurrently with the user's current interaction, such as a smoke detector activation, doorbell ring, pet vocalization, or appliance alarm) distinct from the spatial targeting vector. Contextual information module 114 may determine an urgency score (e.g., a numerical value ranging from 0.0 to 1.0 computed by urgency determination module 410 based on weighted combinations of event type severity, time of day, user activity state, and event persistence) for the asynchronous environmental event. Presentation module 118 can, in accordance with a determination that the urgency score falls below a predetermined urgency threshold defined in the stored user interaction profile (e.g., a threshold value such as 0.75 stored as a parameter within the user interaction profile that specifies the urgency level above which immediate interruption is permitted and below which presentation is deferred), mathematically determine (e.g., compute using geometric calculations based on the spatial targeting vector coordinates and a predefined radius or dimension parameter) a current visual focus region (e.g., a circular or rectangular area centered on the location indicated by the spatial targeting vector, with radius or dimensions determined by object sizes and viewing distances, such as a circular region with 20-40 centimeter radius) based on the spatial targeting vector. In some embodiments, presentation module 118 may define an exclusion zone equal to the current visual focus region and may select a notification placement coordinate that is not within the exclusion zone (e.g., a placement coordinate whose Euclidean distance from the center exceeds a radius threshold). Presentation module 118 may intentionally render (e.g., position and display according to a computed placement that is outside the current visual focus region, as opposed to rendering at a default or arbitrary screen location) a notification regarding the asynchronous environmental event exclusively outside the current visual focus region (e.g., at a position 30-50 centimeters from the center of the current visual focus region, in a peripheral vision area above, below, or to the side of the focus region).

In some embodiments, prior to presentation module 118 filtering the superset of candidate tasks, device control interface 122 may query a local network (e.g., a local area network, Wi-Fi network, Zigbee mesh network, Z-Wave network, or other network connecting controllable devices within the physical environment) to identify a plurality of active connected devices (e.g., devices that are currently powered on, communicating on the network, and registered with device control interface 122, such as smart lights, smart fans, smart thermostats, motorized window coverings, smart televisions, or smart appliances). Language model 112 may generate an interconnected capability graph (e.g., a graph data structure in which nodes represent the plurality of active connected devices and edges represent functional relationships between devices, where edges are derived from analysis of device capability descriptors including supported operations, state variables, environmental effect attributes, and dependency indicators retrieved from device control interface 122) mapping available application programming interfaces (APIs) across the plurality of active connected devices. The structurally limited task hierarchy may include at least one composite task identifier (e.g., a single task identifier that, when selected, triggers execution of a coordinated sequence of commands across multiple devices rather than a single device command) representing a coordinated, multi-device state transition (e.g., a simultaneous or sequentially-ordered set of device state changes across two or more devices, such as “Start movie mode” including television power-on, ceiling lights dimmed to 15%, table lamps dimmed to 20%, and window coverings closed) generated by the vision-language model based on the interconnected capability graph. In some embodiments, the composite task identifier is associated with a plurality of API control payloads and an execution order (e.g., a list of (command, device) tuples with an ordering index). For example, language model 112 may analyze the interconnected capability graph to identify that a television, ceiling lights, table lamps, and window coverings have complementary capabilities for a movie viewing scenario, and may generate a composite task identifier “Start movie mode” that, when selected, triggers presentation module 118 to generate and transmit a dependency-ordered sequence of API commands to device control interface 122.

In some embodiments, image capture device 102 may receive an image frame (e.g., a single captured image or a frame extracted from a continuous video stream) representing a controllable device (e.g., a device within the physical scene that is registered with device control interface 122 and capable of receiving commands through an application programming interface, such as a smart ceiling fan, smart light switch, smart thermostat, motorized window covering, or smart appliance) within a physical scene. Vision-language model 110 may process the image frame using at least the vision-language model to generate a natural language semantic description (e.g., a textual string in natural language describing the controllable device's type, visual appearance, and inferred operating characteristics, such as “ceiling fan with four wooden blades, currently rotating at moderate speed, mounted on white ceiling approximately 2.5 meters from camera”) identifying the controllable device and a current observed operating state (e.g., an operating condition of the controllable device as inferred from visual features in the image frame, such as blade rotation speed indicating power status and speed setting, LED indicator color indicating mode, or physical position of mechanical components indicating open/closed state) of the controllable device. Contextual information module 114 may retrieve external contextual data (e.g., data describing conditions or parameters associated with the physical scene that are obtained from sources other than the image frame, such as temperature measurements from environmental sensors 106, time-of-day data from system clocks, user history data from user history storage 124, or device state data from device control interface 122) associated with the physical scene, the external contextual data distinct from the image frame. Language model 112 may receive the natural language semantic description and the external contextual data from contextual information module 114. Language model 112 may be configured to synthesize (e.g., jointly process and reason over) the current observed operating state and the external contextual data to determine an appropriate control action. Language model 112 may generate an actionable application programming interface (API) control payload (e.g., a structured data object formatted according to the API specification of device control interface 122, including a device identifier, an action type, and one or more parameter values, such as {“device_id”: “living_room_fan”, “action”: “set_speed”, “parameters”: {“speed”: “high”}}) specifically formatted for the controllable device. Presentation module 118 may transmit the actionable API control payload over a network (e.g., a local area network, Wi-Fi network, Zigbee mesh network, Z-Wave network, Bluetooth connection, Thread network, Ethernet connection, or other wired or wireless network connecting the system to the controllable device via device control interface 122) to alter the current observed operating state of the controllable device. For example, when vision-language model 110 generates a natural language semantic description indicating “ceiling fan currently rotating at moderate speed” and contextual information module 114 retrieves external contextual data indicating outdoor temperature of 89° F. and user history showing 15 consecutive selections of “increase fan speed to high” when temperature exceeded 85° F., language model 112 may synthesize these inputs and generate an actionable API control payload “living_room_fan. set_speed(high)” that presentation module 118 transmits over the network to device control interface 122 to alter the fan's operating state from medium speed to high speed.

In some embodiments, device control interface 122 may maintain a localized device management registry (e.g., a locally stored database, configuration file, or data structure maintained by device control interface 122 that catalogs controllable devices registered on the local network, including device identifiers, device types, communication protocols, and references to capability schemas). Language model 112 may query the localized device management registry using the natural language semantic description (e.g., by extracting the device type from the semantic description, such as “ceiling fan,” and using the device type as a query key to retrieve matching device entries from the registry) to dynamically retrieve (e.g., retrieve at runtime based on the identified device rather than using a static, pre-configured mapping) a structured capability schema (e.g., a machine-readable data structure such as a JSON schema, XML schema, or protocol buffer definition that enumerates the controllable device's supported API endpoints, accepted parameter types, parameter value ranges, and state variables) associated with the controllable device. Language model 112 may generate the actionable API control payload by mathematically mapping (e.g., computing a correspondence between contextual data values and API parameter values using numerical comparison, threshold evaluation, or weighted scoring functions) the external contextual data to available endpoint parameters (e.g., the specific API parameters defined within the structured capability schema, such as speed values “low|medium|high” for a fan speed endpoint, temperature values “60-85” for a thermostat setpoint endpoint, or brightness values “0-100” for a light dimming endpoint) defined within the dynamically retrieved structured capability schema. For example, language model 112 may query the localized device management registry with device type “ceiling fan” to retrieve a structured capability schema specifying endpoints {“set_speed”: {“values”: [“low”, “medium”, “high”]}, “power_off”: {}, “set_timer”: {“minutes”: “1-120”}}, and may mathematically map the external contextual data (outdoor temperature 89° F. exceeding a threshold of 85° F., user history indicating preference for “high” speed under similar conditions) to the available endpoint parameter “high” of the “set_speed” endpoint.

In some embodiments, vision-language model 110 may identify a second controllable device (e.g., a second device visible in the image frame that is distinct from the first controllable device and is also registered with device control interface 122, such as a smart light identified in the same scene as a smart television) within the physical scene. Language model 112 may evaluate a functional dependency (e.g., a relationship in which the operating state of one device affects, constrains, or should precede the operating state of another device, such as a prerequisite dependency where lights should be dimmed before a television is powered on to avoid a bright flash in a darkened room, or a timing dependency where window coverings should begin closing before lights are dimmed to maintain ambient light during the mechanical closing operation) between the controllable device and the second controllable device. Language model 112 may generate a sequenced execution order (e.g., a temporally ordered list specifying which API control payloads should be transmitted first, second, third, and so on, based on the evaluated functional dependencies) of multiple API control payloads to avoid state-transition conflicts (e.g., undesirable device states that occur when commands are executed in an incorrect order, such as a television displaying a bright startup screen in a fully darkened room because the television power-on command was transmitted before the light dimming command completed, or a cooking appliance igniting before a ventilation device has activated) between the devices. For example, language model 112 may evaluate a functional dependency between a television (controllable device) and ceiling lights (second controllable device) and determine that the ceiling lights should be dimmed before the television is powered on, and may generate a sequenced execution order specifying: (1) transmit “ceiling_lights.set_brightness(15)” at t=0, (2) transmit “living_room_tv.power_on( )” at t=2.0 seconds, to avoid the state-transition conflict of a bright television startup screen appearing before the room is dimmed.

In some embodiments, attention signal generator 104 may receive an asynchronous spatial signal (e.g., a spatial attention indication that arrives independently of and potentially at a different time than the image frame capture, such as a gaze coordinate from an eye tracking system, a directional signal from a brain-computer interface, or a head orientation vector from a head tracking system) indicating a targeted region of interest (e.g., a specific area within the physical scene corresponding to the location of the controllable device, defined by pixel coordinates, angular coordinates, or three-dimensional spatial coordinates) within the physical scene. Image processor 108 may modify the image frame by injecting (e.g., inserting by modifying pixel values in the image data array through pixel value replacement, alpha blending, or geometric shape rendering operations) a non-naturally occurring visual marker (e.g., a computer-generated graphical element that does not exist in the physical scene and would not appear in an unmodified image frame, such as a colored dot, crosshairs, bounding box, or highlighting overlay) directly into the image frame at the targeted region of interest, prior to processing the image frame via vision-language model 110. The non-naturally occurring visual marker may architecturally constrain (e.g., direct the attention mechanism of the vision-language model's neural network architecture to focus processing on the spatial region containing the visual marker, thereby limiting the scope of the generated output) the generated natural language semantic description to exclusively describe (e.g., generate a semantic description that identifies and characterizes only the controllable device at the marker location, rather than describing all objects visible in the image frame) the controllable device at the targeted region of interest. For example, in an image frame containing a ceiling fan, a light switch, and a thermostat, image processor 108 may inject a red dot visual marker at the pixel coordinates corresponding to the ceiling fan, and vision-language model 110 may generate a natural language semantic description “ceiling fan with four wooden blades, currently rotating at moderate speed” that exclusively describes the ceiling fan rather than the light switch or thermostat.

In some embodiments, the external contextual data may include historically logged user preference data (e.g., records stored in user history storage 124 including timestamps, selected task identifiers, contextual conditions at time of selection, and task execution outcomes, representing patterns of user preferences accumulated over multiple interactions) and environmental condition data (e.g., current temperature, humidity, light level, time of day, or other environmental measurements obtained from environmental sensors 106). Language model 112 may generate and presentation module 118 may transmit the actionable API control payload autonomously in the absence of an explicit user command (e.g., without requiring the user to select a task identifier, provide a gaze dwell confirmation, generate a brain-computer interface signal, or perform any other affirmative input action) by predicting a probabilistically desired operating state (e.g., an operating state that language model 112 determines has a probability exceeding a predefined confidence threshold of being the state the user would select if presented with task identifiers, based on analysis of historical patterns and current conditions) based on a correlation (e.g., a computed correspondence or pattern match between current conditions and historically observed conditions under which the user previously selected a specific task) between the current observed operating state and the external contextual data. In some embodiments, language model 112 may compute a confidence value (e.g., a probability value in) for a predicted operating state based on the correlation, and may compare the confidence value to the predefined confidence threshold. In some embodiments, presentation module 118 may transmit the actionable API control payload autonomously when the confidence value satisfies the predefined confidence threshold. For example, when vision-language model 110 observes that a ceiling fan is currently at medium speed (current observed operating state), and the external contextual data indicates outdoor temperature of 91° F. (environmental condition data) and that the user has selected “increase fan speed to high” in 15 out of 15 previous interactions when outdoor temperature exceeded 85° F. (historically logged user preference data), language model 112 may predict that “high speed” is the probabilistically desired operating state with confidence exceeding a threshold (e.g., 0.95), and may generate and transmit the actionable API control payload “living_room_fan.set_speed(high)” autonomously without waiting for explicit user selection. In some embodiments, the predefined confidence threshold for autonomous execution may be configurable (e.g., ranging from 0.80 to 0.99) and may be stored in a user interaction profile or system configuration parameter.

In some embodiments, transmitting the natural language semantic description and the external contextual data to language model 112 may include injecting (e.g., inserting as formatted text fields within a predefined template) the natural language semantic description into a structured generative prompt (e.g., a prompt template including system instructions, contextual data fields, reasoning instructions, and output format specifications, organized in a predefined structure that directs the language model's generation behavior) configured to force (e.g., instruct through explicit prompt directives such as “First, explain your reasoning step by step before generating the final command”) the language model to execute a chain-of-thought reasoning process (e.g., a sequential reasoning approach in which the language model generates intermediate reasoning steps in natural language text before producing a final output, where each reasoning step builds on previous steps to arrive at a conclusion). The chain-of-thought reasoning process may cause language model 112 to output an intermediate textual evaluation (e.g., a natural language text passage generated by the language model that explicitly describes how specific elements of the external contextual data affect the controllable device, produced before the final actionable API control payload, such as “The outdoor temperature is 89° F., which is above the user's historical threshold of 85° F. for increasing fan speed. The fan is currently at medium speed. The user has consistently selected high speed under these conditions. Therefore, increasing fan speed to high is the recommended action.”) of how the external contextual data impacts the controllable device prior to generating the actionable API control payload. For example, the structured generative prompt may include: “System: You are a device control assistant. Given the following device description and contextual data, first explain step by step how the contextual data affects the recommended device action, then generate the API command. Device: [natural language semantic description]. Context: [external contextual data]. Step-by-step reasoning:” Language model 112 may generate the intermediate textual evaluation followed by the actionable API control payload. In some embodiments, the structured generative prompt may specify an output schema requiring (i) an “evaluation” field containing the intermediate textual evaluation and (ii) a “command” field containing the actionable API control payload, and presentation module 118 may parse the “evaluation” field for display and may parse the “command” field for transmission. In some embodiments, the intermediate textual evaluation may be logged in user history storage 124 for auditing, debugging, or user review purposes. In some embodiments, the intermediate textual evaluation may be presented to the user via display device 120 alongside the generated task identifiers to provide transparency into the reasoning behind the suggested tasks.

In another aspect, referring to FIG. 1, image processor 108 may receive image data representing a visual scene from image capture device 102 and attention signal 134 from attention signal generator 104 indicating a location within the visual scene. Vision-language model 110 may generate, using the image data and the attention signal, one or more task identifiers of one or more tasks associated with an object at the location. Presentation module 118 may cause presentation of the one or more task identifiers via display device 120. Responsive to a selection of a task identifier from the one or more task identifiers (e.g., via gaze dwell, binary input, scalar magnitude selection, or other input mechanism as described with respect to FIG. 5), presentation module 118 may transmit command 154 to device control interface 122 associated with the object to execute a task corresponding to the selected task identifier.

In some embodiments, to generate the one or more task identifiers, image processor 108 may modify the image data to include a visual marker at the location indicated by the attention signal, as described above with respect to FIG. 2. The visual marker may include a colored dot, crosshairs, or bounding box overlay rendered at pixel coordinates corresponding to the attention signal. Image processor 108 may provide the modified image as input to vision-language model 110, and vision-language model 110 may identify the object at the marked location based on visual features extracted from a region of interest surrounding the visual marker.

In some embodiments, attention signal generator 104 may derive the attention signal from eye tracking data including gaze coordinates corresponding to the location within the visual scene. Attention signal generator 104 may compute gaze vectors from infrared eye tracking cameras and map the gaze vectors into image-space coordinates corresponding to the captured image data, as described above with respect to FIG. 2.

In some embodiments, contextual information module 114 may obtain contextual information including at least one of temporal data, environmental sensor data, or user history data, as described above with respect to FIG. 3. Task ranking module 116 may rank the one or more tasks based on the contextual information by assigning a priority score (e.g., a numerical value between 0.0 and 1.0 representing contextual relevance) to each task identifier.

In some embodiments, the contextual information obtained by contextual information module 114 may include a current time of day (e.g., retrieved from a system clock), a current state of the object obtained from device control interface 122 (e.g., power state or configuration parameter), user preference data derived from historical interactions stored in user history storage 124, and environmental condition data obtained from environmental sensors 106 (e.g., temperature or light level). Task ranking module 116 may rank the one or more tasks by weighting each task based on each of the current time of day, the current state, the user preference data, and the environmental condition data, as described above with respect to FIG. 3.

In some embodiments, contextual information module 114 may detect an event condition from environmental sensor data indicating a state change (e.g., smoke detector activation or doorbell ring), and may compute an urgency score of the event condition based on the contextual information, as described above with respect to FIG. 4. In accordance with a determination that the urgency score exceeds a predetermined threshold (e.g., a stored value between 0.6 and 0.8), presentation module 118 may cause presentation of a set of task identifiers of one or more event-related tasks associated with the event condition without the attention signal. In accordance with a determination that the urgency score is below the predetermined threshold, presentation module 118 may defer presentation of the set of task identifiers until receiving the attention signal directed to an object associated with the event condition.

In some embodiments, presentation module 118 may determine a current focus region corresponding to the location indicated by the attention signal (e.g., a circular or rectangular region centered on the gaze coordinate with a predefined radius corresponding to a visual attention span), as described above with respect to FIG. 4. Presentation module 118 may position a visual notification for the one or more event-related tasks outside the current focus region to avoid disrupting ongoing user activity (e.g., by rendering the notification at coordinates outside an exclusion zone defined by the focus region).

In some embodiments, vision-language model 110 may process the image data to identify the object at the location and may provide an object identifier to language model 112. Contextual information module 114 may provide contextual information to language model 112. Language model 112 may generate the one or more task identifiers based on the object identifier and the contextual information, as described above with respect to FIG. 3.

In some embodiments, presentation module 118 may cause presentation of confirmation information indicating successful execution of the corresponding task. Presentation module 118 may receive execution status information from device control interface 122 and may cause display device 120 to present confirmation information (e.g., a visual checkmark, color transition, or audible signal).

In some embodiments, presentation module 118 may store interaction data including selection and contextual information for each presentation of the one or more task identifiers in user history storage 124. User history storage 124 may identify a pattern in the interaction data indicating selection frequency of a particular task type under specific contextual conditions (e.g., repeated selection of a task when temperature exceeds a threshold). Task ranking module 116 may update a priority score associated with tasks matching the particular task type when the specific contextual conditions are present in subsequent generation of task identifiers.

In some embodiments, vision-language model 110 may identify a plurality of devices in the visual scene using visual feature extraction and object recognition, as described above with respect to FIG. 1. Language model 112 may determine, based on semantic representations generated by vision-language model 110, a functional relationship between the object and at least one device of the plurality of devices based on additional capabilities (e.g., complementary or prerequisite relationships). Language model 112 may generate at least one task identifier providing coordinated control of the object and the at least one device based on the functional relationship.

In some embodiments, responsive to selection of the at least one task identifier, presentation module 118 may generate a sequence of control commands for the object and the at least one device, determine an execution order of the sequence of control commands based on dependencies between states of the plurality of devices (e.g., prerequisite state transitions or timing constraints), and transmit the sequence of control commands according to the execution order via device control interface 122.

In some embodiments, presentation module 118 may determine an input capability of a user input modality (e.g., binary input, scalar input, or eye tracking input), as described above with respect to FIG. 5, select a subset of the one or more task identifiers based on the input capability, and cause presentation of the subset via an interface adapted to the user input modality.

In some embodiments, presentation module 118 may determine a control dimensionality of the user input modality (e.g., zero-dimensional for binary input, one-dimensional for bidirectional scalar input), and may limit a number of task identifiers in the subset based on the control dimensionality, wherein the number of task identifiers decreases as the control dimensionality decreases, as described above with respect to FIG. 5.

In some embodiments, when the user input modality includes a binary input mechanism, presentation module 118 may partition the subset of the one or more task identifiers into a first group and a second group, cause presentation of an indication of the first group and the second group, receive a binary selection indicating either the first group or the second group, and cause presentation of individual task identifiers within a selected group indicated by the binary selection for task selection, as described above with respect to FIG. 5.

In some embodiments, when the user input modality includes eye tracking, presentation module 118 may cause presentation of visual indicators for each task identifier in the subset, track dwell time of gazes on each visual indicator, and, in accordance with a determination that the dwell time of a gaze on a visual indicator exceeds a dwell threshold (e.g., a stored temporal threshold between 0.5 and 3.0 seconds), select the task identifier from the subset, as described above with respect to FIG. 5.

In some embodiments, spatial position determination module 612 may determine a three-dimensional spatial position of the object, visual element generation module 620 may generate one or more visual elements representing the subset of the one or more task identifiers positioned relative to the three-dimensional spatial position of the object, and augmented reality rendering module 628 may cause rendering of the one or more visual elements in augmented reality display 630 at a depth matching the object, as described above with respect to FIGS. 6A and 6B.

In some embodiments, presentation module 118 may track interaction state information including user attention focus and task presentation timing, determine that a duration of user inactivity exceeds a predetermined timeout threshold (e.g., a stored value between 5 and 15 seconds), cause display device 120 to fade the presentation of the subset of the one or more task identifiers, and, in response to receiving a subsequent attention signal or input signal before complete removal of the one or more task identifiers, restore the presentation of the subset without regenerating the one or more task identifiers.

In some embodiments, a method may include image processor 108 receiving image data representing a visual scene and attention signal generator 104 providing an attention signal indicating a location within the visual scene, vision-language model 110 generating one or more task identifiers of one or more tasks associated with an object at the location, presentation module 118 causing presentation of the one or more task identifiers, and presentation module 118 transmitting a command to device control interface 122 responsive to selection of a task identifier to execute a task corresponding to the selected task identifier.

In some embodiments, a non-transitory computer-readable storage medium may include instructions that, when executed by components of system 100 (including image processor 108, vision-language model 110, language model 112, contextual information module 114, task ranking module 116, and presentation module 118), cause the system to perform operations including receiving image data and an attention signal, generating one or more task identifiers associated with an object at the location, causing presentation of the one or more task identifiers, and transmitting a command to device control interface 122 responsive to selection of a task identifier.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items but may be more when so indicated either explicitly or by context. Further, unless stated otherwise or otherwise clear from context, phrase “based on” means “based at least in part on” and not “based solely on.”

Operations of processes described herein may be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data may be accomplished in a variety of ways such as by receiving data as a parameter of a function call or a call to an application programming interface. In some embodiments, process of obtaining, acquiring, receiving, or inputting analog or digital data may be accomplished by transferring data via a serial or parallel interface. In another embodiment, process of obtaining, acquiring, receiving, or inputting analog or digital data may be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data may be accomplished by transferring data as an input or output parameter of a function call, a parameter of an application programming interface or inter-process communication mechanism.

Although discussion above sets forth example embodiments of described techniques, other architectures may be used to implement described functionality and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising one or more processors to:
receive image data representing a visual scene and spatial telemetry data comprising a gaze coordinate indicating a location within the visual scene;
generate, using a vision-language model that processes the image data and the spatial telemetry data, one or more task identifiers of one or more tasks associated with an object at the location;
cause presentation of the one or more task identifiers; and
responsive to a selection of a task identifier from the one or more task identifiers, transmit a command to a device control interface associated with the object to execute a task corresponding to the selected task identifier.

2. The system of claim 1, wherein to generate the one or more task identifiers, the one or more processors are further to:
process the image data using the vision-language model to identify the object at the location;
provide an object identifier and contextual information to a language model; and
receive the one or more task identifiers from the language model based on the object identifier and the contextual information.

3. The system of claim 1, wherein the system further comprises a binary input mechanism, and wherein to cause presentation of the one or more task identifiers, the one or more processors are further to:
select a subset of the one or more task identifiers based on a control dimensionality of the binary input mechanism;
partition the subset of the one or more task identifiers into a first group and a second group;
cause presentation of an indication of the first group and the second group;
receive a binary selection indicating either the first group or the second group; and
cause presentation of individual task identifiers within a selected group indicated by the binary selection for task selection.

4. The system of claim 3, wherein to cause presentation of the subset of the one or more task identifiers, the one or more processors are further to:
determine a three-dimensional spatial position of the object;
generate one or more visual elements representing the subset of the one or more task identifiers, wherein each visual element is positioned relative to the three-dimensional spatial position of the object; and
cause rendering of the one or more visual elements in an augmented reality display at a depth matching the object.

5. The system of claim 1, wherein to generate the one or more task identifiers, the one or more processors are further to:
modify the image data to include a visual marker at the location indicated by the spatial telemetry data; and
provide the modified image as input to the vision-language model.

6. The system of claim 1, wherein the one or more processors are further to:
identify a plurality of devices in the visual scene using the vision-language model;
determine, based on semantic representations generated by the vision-language model, a functional relationship between the object and at least one device of the plurality of devices based on additional capabilities; and
generate at least one task identifier of at least one task of the one or more tasks providing coordinated control of the object and the at least one device based on the functional relationship.

7. A computer-implemented method for dynamic, input-adaptive task generation, the method comprising:
receiving physiological telemetry data comprising one or more spatial gaze coordinates directed toward a target object within a physical environment;
processing image data of the physical environment using at least a vision-language model, based at least on the one or more spatial gaze coordinates, to generate an initial set of executable tasks associated with the target object;
determining a physical control dimensionality constraint of a connected user input device;
dynamically partitioning the initial set of executable tasks into a constrained interaction subset structurally bounded by the determined physical control dimensionality constraint; and
causing presentation of the constrained interaction subset.

8. The method of claim 7, wherein determining the physical control dimensionality constraint comprises detecting that the connected user input device is physically restricted to capturing one of a zero-dimensional binary input, or a one-dimensional scalar input.

9. The method of claim 8, wherein the determined physical control dimensionality constraint is the zero-dimensional binary input, and wherein dynamically partitioning the initial set of executable tasks comprises structuring the constrained interaction subset as a hierarchical binary search tree, thereby reducing a number of sequential input interactions required to select an executable task from the initial set.

10. The method of claim 7, wherein processing the image data of the physical environment using at least the vision-language model comprises:
generating a natural language semantic description of a current operating state of the target object; and
transmitting the natural language semantic description to a secondary language model configured to automatically map the current operating state to one or more actionable application programming interface (API) control commands.

11. The method of claim 7, further comprising modifying the image data by rendering an artificial visual marker directly into pixel data of the image data at a location corresponding to the one or more spatial gaze coordinates, prior to processing the image data using the vision-language model.

12. The method of claim 7, further comprising:
receiving environmental sensor data representing a physical condition of the physical environment distinct from the image data; and
prior to dynamically partitioning the initial set, filtering the initial set of executable tasks based at least on a weighted correlation between the environmental sensor data and historically logged task execution patterns associated with the target object.

13. The method of claim 7, further comprising:
tracking a continuous ocular dwell time of the one or more spatial gaze coordinates on a visual indicator corresponding to a specific executable task within the presented constrained interaction subset; and
automatically transmitting an API command to execute the specific executable task upon detecting that the continuous ocular dwell time satisfies a predefined temporal threshold.

14. The method of claim 7, wherein the vision-language model is dynamically prompted to exclude tasks from the initial set of executable tasks that require human manipulation of the target object, and include only tasks capable of remote automated execution via a wireless network protocol.

15. A computer-implemented method for adaptive augmented interaction, the method comprising:
receiving targeting data comprising a spatial targeting vector directed toward a physical object within an environment;
processing an image of the environment using a vision-language model, based at least in part on the spatial targeting vector, to generate a superset of candidate tasks associated with the physical object;
accessing a stored user interaction profile, the user interaction profile defining a predefined graphical interaction constraint independent of any currently connected hardware input device;
filtering the superset of candidate tasks into a structurally limited task hierarchy configured to satisfy the predefined graphical interaction constraint of the stored user interaction profile; and
causing presentation of the structurally limited task hierarchy to a user.

16. The method of claim 15, wherein the predefined graphical interaction constraint specifies a maximum threshold of concurrently selectable visual elements; and
wherein filtering the superset of candidate tasks into the structurally limited task hierarchy comprises:
recursively partitioning the superset of candidate tasks into a plurality of nested binary groups such that no individual presentation state of the structurally limited task hierarchy displays more selectable visual elements than the maximum threshold, thereby converting a linear task selection process into a binary search traversal.

17. The method of claim 15, wherein the spatial targeting vector is a composite vector generated by fusing optical head-tracking data with augmented-reality depth sensor data; and
wherein processing the image of the environment using the vision-language model comprises passing a three-dimensional spatial bounding coordinate derived from the composite vector to the vision-language model alongside the image of the environment.

18. The method of claim 15, wherein the predefined graphical interaction constraint specifies an ocular dwell-time execution mode; and
wherein causing presentation of the structurally limited task hierarchy comprises:
rendering a visual progress indicator adjacent to a specific candidate task within the structurally limited task hierarchy;
detecting a sustained intersection between the spatial targeting vector and the specific candidate task; and
dynamically altering a visual state of the visual progress indicator proportional to a duration of the sustained intersection until a predetermined dwell-time threshold is satisfied.

19. The method of claim 15, further comprising:
detecting an asynchronous environmental event distinct from the spatial targeting vector;
determining an urgency score for the asynchronous environmental event; and
in accordance with a determination that the urgency score falls below a predetermined urgency threshold defined in the stored user interaction profile, determining a current visual focus region based on the spatial targeting vector and intentionally rendering a notification regarding the asynchronous environmental event exclusively outside the current visual focus region.

20. The method of claim 15, further comprising:
prior to filtering the superset of candidate tasks, querying a local network to identify a plurality of active connected devices;
generating an interconnected capability graph mapping available application programming interfaces (APIs) across the plurality of active connected devices; and
wherein the structurally limited task hierarchy includes at least one composite task identifier representing a coordinated, multi-device state transition generated by the vision-language model based on the interconnected capability graph.
